(19) United States
(12) Patent Application Publication
(10) Pub. No.: US 2007/0232778 A1
(43) Pub. Date: Oct. 4, 2007

(54) Certain polyester compositions which comprise cyclobutanediol, cyclohexanedimethanol, and high trans-cyclohexanedicarboxylic acid

(76) Inventors: Leslie Shane Moody, Johnson City, TN (US); Emmett Dudley Crawford, Kingsport, TN (US); Jeremy R. Lizotte, Gray, TN (US)

Correspondence Address: BETTY JOY BOSHEARS;EASTMAN CHEMICAL COMPANY, P.O. BOX 511, KINGSPORT, TN, 37662, US

(21) Appl. No.: 11/706,476

(22) Filed: Feb. 14, 2007

Related U.S. Application Data
(60) Provisional application No. 60/786,572, filed on Mar. 28, 2006.
(60) Provisional application No. 60/786,596, filed on Mar. 28, 2006.
(60) Provisional application No. 60/786,547, filed on Mar. 28, 2006.
(60) Provisional application No. 60/786,571, filed on Mar. 28, 2006.
(60) Provisional application No. 60/786,598, filed on Mar. 28, 2006.

(51) Int. Cl. C08G 63/02

(52) U.S. Cl. 528/272

(57) ABSTRACT

Described as one aspect of the invention are polyester compositions comprising at least one polyester which comprises:

(A) a dicarboxylic acid component comprising:
i) 70 to 100 mole % of cyclohexanedicarboxylic acid residues or an ester thereof comprising:
   (a) 70 to 98 mole % trans-cyclohexanedicarboxylic acid residues or an ester thereof; and
   (b) 2 to 30 mole % cis-cyclohexanedicarboxylic acid residues or an ester thereof;
ii) 0 to 30 mole % of aliphatic dicarboxylic acid residues, other than cyclohexanedicarboxylic acid residues, having up to 16 carbon atoms or esters thereof, other than cyclohexanedicarboxylic acid residues,; and
iii) 0 to 10 mole % of aromatic dicarboxylic acid residues having up to 20 carbon atoms; and

(B) a glycol component comprising:
i) 1 to 99 mole % of 2,2,4,4-tetramethyl-1,3-cyclobutanediol residues; and
ii) 1 to 99 mole % of 1,4-cyclohexanedimethanol residues, 1,3-cyclohexanedimethanol residues, 1,2-cyclohexanedimethanol residues or esters thereof or mixtures thereof,
   wherein the total mole % of said dicarboxylic acid component is equal to 100 mole %;
   the total mole % of said glycol component is equal to 100 mole %;
   wherein the inherent viscosity of said polyester is from 0.35 to 1.2 dL/g as determined in 60/40 (wt/wt) phenol/tetrachloroethane at a concentration of 0.5 g/100 ml at 25° C.; and wherein said polyester has a Tg of from 60 to 155° C. The polyesters may be manufactured into articles.

### CROSS-REFERENCES TO RELATED APPLICATIONS

This application claims the benefit of: U.S. application Ser. No. 60/786,572 filed Mar. 28, 2006; U.S. application Ser. No. 60/786,596 filed Mar. 28, 2006; U.S. application Ser. No. 60/786,547 filed Mar. 28, 2006; U.S. application Ser. No. 60/786,571 filed Mar. 28, 2006; U.S. application Ser. No. 60/786,598 filed Mar. 28, 2006; this application is a continuation in part application of and claims the benefit of; U.S. application Ser. No. 11/390,672 filed on Mar. 28, 2006; U.S. application Ser. No. 11/390,752 filed on Mar. 28, 2006; U.S. application Ser. No. 11/390,794 filed on Mar. 28, 2006; U.S. application Ser. No. 11/391,565 filed on Mar. 28, 2006; U.S. application Ser. No. 11/390,671 filed on Mar. 28, 2006; U.S. application Ser. No. 11/390,853 filed on Mar. 28, 2006; U.S. application Ser. No. 11/390,631 filed on Mar. 28, 2006; and U.S. application Ser. No. 11/390,655 filed on Mar. 28, 2006; U.S. application Ser. No. 11/391,125 filed on Mar. 28, 2006; U.S. application Ser. No. 11/390,751 filed Mar. 28, 2006; U.S. application Ser. No. 11/390,955 filed Mar. 28, 2006; U.S. application Ser. No. 11/390,827 filed Mar. 28, 2006; U.S. application Ser. No. 11/390,883 filed Mar. 28, 2006; U.S. application Ser. No. 11/390, 846 filed Mar. 28, 2006; U.S. application Ser. No. 11/390,809 filed Mar. 28,2006; U.S. application Ser. No. 11/390,812 filed Mar. 28, 2006; U.S. application Ser. No. 11/391,124 filed Mar. 28, 2006; U.S. application Ser. No. 11/390,908 filed Mar. 28, 2006; U.S. application Ser. No. 11/390,793 filed Mar. 28, 2006; U.S. application Ser. No. 11/391,642 filed Mar. 28, 2006; U.S. application Ser. No. 11/390,826 filed Mar. 28, 2006; U.S. application Ser. No. 11/390,563 filed Mar. 28, 2006; U.S. application Ser. No. 11/390,847 filed Mar. 28, 2006; U.S. application Ser. No. 11/391,156 filed Mar. 28, 2006; U.S. application Ser. No. 11/390,630 filed Mar. 28, 2006; U.S. application Ser. No. 11/391,495 filed Mar. 28, 2006; U.S. application Ser. No. 11/391,576 filed Mar. 28, 2006; U.S. application Ser. No. 11/390,858 filed Mar. 28, 2006; U.S. application Ser. No. 11/390,629 filed Mar. 28, 2006; U.S. application Ser. No. 11/391,485 filed Mar. 28, 2006; U.S. application Ser. No. 11/390,811 filed Mar. 28, 2006; U.S. application Ser. No. 11/390,750 filed Mar. 28, 2006; U.S. application Ser. No. 11/390,773 filed Mar. 28, 2006; U.S. application Ser. No. 11/390,865 filed Mar. 28, 2006; U.S. application Ser. No. 11/390,654 filed Mar. 28, 2006; U.S. application Ser. No. 11/390,882 filed Mar. 28, 2006; U.S. application Ser. No. 11/390,836 filed Mar. 28, 2006; U.S. application Ser. No. 11/391,063 filed Mar. 28, 2006; U.S. application Ser. No. 11/390,814 filed Mar. 28, 2006; U.S. application Ser. No. 11/390,722 filed Mar. 28, 2006; U.S. application Ser. No. 11/391,659 filed Mar. 28, 2006; U.S. application Ser. No. 11/391,137 filed Mar. 28, 2006; U.S. application Ser. No. 11/391,505 filed Mar. 28, 2006; U.S. application Ser. No. 11/390,864 filed Mar. 28, 2006; U.S. application Ser. No. 11/391,571 filed Mar. 28, 2006, U.S. application Ser. No. 11/588,524 filed Oct. 27, 2006, U.S. application Ser. No. 11/588,458 filed Oct. 27, 2006, U.S. application Ser. No. 11/588,907 filed Oct. 27, 2006, U.S. application Ser. No. 11/588,527 filed Oct. 27, 2006, U.S. application Ser. No. 11/588,906 filed Oct. 27, 2006, U.S. application Ser. No. 11/588,893 filed Oct. 27, 2006, U.S. application Ser. No. 11/588,554 filed Oct. 27, 2006, U.S. application Ser. No. 11/635,433 filed Dec. 7, 2006, U.S. application Ser. No. 11/635,434 filed Dec. 7, 2006; and this application is a continuation in part application of and claims the benefit of U.S. application ser. No. 11/588,883 filed Oct. 27, 2006, U.S. application Ser. No. 11/439,062 filed May 23, 2006, and U.S. application Ser. No. 11/439,340 filed May 23, 2006; PCT/US06/41917 filed on Oct. 27, 2006; PCT/US06/42069 filed on Oct. 27, 2006; PCT/US06/42291 filed on Oct. 27, 2006; PCT/US/06/42292 filed on Oct. 27, 2006; and PCT/US/06/42293 filed on Oct. 27, 2006.

### FIELD OF THE INVENTION

The present invention generally relates to polyester compositions made from made from cyclohexanedicarboxylic acid (CHDA) or an ester thereof, 2,2,4,4-tetramethyl-1,3-cyclobutanediol (TMCD) or an ester thereof, and cyclohexanedimethanol (CHDM) or an ester thereof, and mixtures thereof, have certain combinations of two or more of high notched Izod impact strength, certain glass transition temperature (T_{g}), certain inherent viscosities, certain densities, flexural modulus, weatherability, low absorption of ultraviolet radiation, and chemical resistance.

### BACKGROUND OF THE INVENTION

Polyesters comprising significant amounts of aromatic monomers, such as terephthalic acid (TPA) or isophthalic acid (IPA) absorb significant amounts of ultraviolet (UV) radiation due to terephthalate and/or isophthalate moieties. Over time, this can lead to degradation of physical properties, discoloration, and haze. Addition of competitive UV absorbers (UVAs) helps to stabilize against these deleterious effects of UV radiation, however, significant amounts of the UVAs must be used to adequately protect the aromatic polyester. Typically, aliphatic polyesters do not absorb significant amounts of ultraviolet (UV) radiation but many exhibit low glass transition temperatures (T_{g}).

Although somewhat higher than the T_{g}s of many other aliphatic polyesters from straight- or branched-chain monomers, poly(1,4-cyclohexanedimethylene-1,4-cyclohexanedicarboxylate) also exhibits a relatively low (about 66° C.) glass transition temperature. This has practical importance, since T_{g} often sets an upper temperature limit for the use of an amorphous thermoplastic polymer. Additionally, poly(1,4-cyclohexanedimethylene-1,4-cyclohexanedicarboxylate) crystallizes relatively rapidly, making it difficult to form amorphous articles, especially in thick parts.

### SUMMARY OF THE INVENTION

The T_{g} range of the polyesters of the present invention can be from greater than about 66° up to about 155° C. Uses for these higher T_{g} amorphous and essentially aliphatic copolyesters of the present invention include but are not limited to: protective cap-layers for higher T_{g} resins, such as available aromatic copolyesters, whose T_{g}s are in the range of about 70°-130° C., but are less easily or more expensively stabilized than the polyesters of the present invention. In one embodiment, it is desirable to approximately match the T_{g} of the cap-layer with that of the substrate that is to be protected. A high concentration of UV absorber in a very thin cap-layer would be much less expensive than bulk-stabilization of the underlying substrate. The polyesters of the present invention are also useful for weatherable injection molding applications, where it would be expensive to bulk-stabilize an aromatic resin. These copolyesters can also be used in many applications where a tough, weatherable polymer is required.

Some of the copolyesters of this invention have also been shown to possess greatly improved chemical resistance when exposed to lipids and isopropanol compared to certain aromatic polyesters with similar T_{g}s. Also, the invention includes a process where the compositions of the present invention can be produced in a timely fashion on standard equipment. Bulky, secondary diols, such as TMCD, are generally less reactive towards transesterification or polycondensation than some of the more commonly used primary diols, such as ethylene glycol or CHDM, and require longer reaction times to achieve similar conversions. In certain processes of this invention, the total reaction time has been shortened such that the compositions of the present invention can be produced on a time scale more similar to that of other polyesters known in the art using typical production equipment known in the art.

It is believed that certain polyester compositions containing cyclohexanedicarboxylic acid, 2,2,4,4-tetramethyl-1,3-cyclobutanediol, cyclohexanedimethanol, or their chemical equivalents, and alternatively, other modifying diols and dicarboxylic acids or their chemical equivalents, with certain monomer compositions and inherent viscosities are believed to be unexpectedly superior to copolyesters known in the art with respect to their T_{g}, notched Izod impact strength and low absorption of ultraviolet radiation. In one aspect of the invention, the materials of the invention are particularly useful for weathering/weatherable end-use applications and/or outdoor end-use applications.

In certain embodiments of the invention, certain polyesters and/or polyester compositions of the invention are superior to certain commercial polymers with respect to a combination of two or more of high notched Izod impact strength, certain glass transition temperature (T_{g}), certain inherent viscosities, certain densities, flexural modulus, weatherabiliy, low absorption of ultraviolet radiation, and chemical resistance.

In some embodiments of the invention, certain polyesters and/or polyester compositions of the invention are superior to certain commercial polymers with respect to three or more of high notched Izod impact strength, certain glass transition temperature (T_{g}), certain inherent viscosities, certain densities, flexural modulus, weatherability, low absorption of ultraviolet. radiation, and chemical resistance.

In certain embodiments of the invention, certain polyesters and/or polyester compositions of the invention are superior to certain commercial polymers with respect to a combination of four or more of high notched Izod impact strength, certain glass transition temperature (T_{g}), certain inherent viscosities, certain densities, flexural modulus, weatherability, low absorption of ultraviolet radiation, and chemical resistance.

In other embodiments of the invention, certain polyesters and/or polyester compositions of the invention are superior to certain commercial polymers with respect to a combination of all of the following properties: high notched Izod impact strength, certain glass transition temperature (T_{g}), certain inherent viscosities, certain densities, flexural modulus, weatherability, low absorption of ultraviolet radiation, and chemical resistance.

In one aspect, the processes of making the polyesters useful in the invention can comprise a batch or continuous process.

In one aspect, the processes of making the polyesters useful in the invention comprise a continuous process.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % frans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 155° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2to 30 mole % cis-cyclohexanedicarboxylic acid residues;
(ii) about 0 to about 30 mole % of aliphatic dicarboxylic acid residues, other than cyclohexanedicarboxylic acid residues, ther than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 20 to 40 mole % 2,2,4,4-tetramethyl-1,3-cyclobutanediol residues; and
(ii) 60 to 80 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 35 mole % 2,2,4,4-tetramethyl-1,3-cyclobutanediol residues; and
(ii) 65 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 20 to 40 mole % 2,2,4,4-tetramethyl-1,3-cyclobutanediol residues; and
(ii) 60 to 80 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 35 mole % 2,2,4,4-tetramethyl-1,3-cyclobutanediol residues; and
(ii) 65 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 90° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 5 to 35 mole % 2,2,4,4-tetramethyl-1,3-cyclobutanediol residues; and
(ii) 65 to 95 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.35 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 100° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 5 to 35 mole % 2,2,4,4-tetramethyl-1,3-cyclobutanediol residues; and
(ii) 65 to 95 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.5 to 1.2 dL/g as determined in 60/40 (wt/wt) phenol/tetrachloroethane at a concentration of 0.25 g/50 ml at 25° C.; and
   wherein the polyester has a glass transition temperature of from greater than 60° C. to 110° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.68 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, ther than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.68 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.68 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.68 to 0.85 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 1 to 99 mole % 2,2,4,4-tetramethyl-1,3-cyclobutanediol residues; and
(ii) 1 to 99 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, ther than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 50 to 90 mole % 2,2,4,4-tetramethyl-1,3-cyclobutanediol residues; and
(ii) 10 to 50 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 60 to 80 mole % 2,2,4,4-tetramethyl-1,3-cyclobutanediol residues; and
(ii) 20 to 40 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 65 to 75 mole % 2,2,4,4-tetramethyl-1,3-cyclobutanediol residues; and
(ii) 25 to 35 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 80° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 30 to 50 mole % 2,2,4,4-tetramethyl-1,3-cyclobutanediol residues; and
(ii) 50 to 70 mole % cyclohexanedimethanol residues;
   wherein the total mole % of the dicarboxylic acid component is equal to 100 mole %;
   wherein the total mole % of the glycol component is equal to 100 mole %;
   +herein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 40 mole % 2,2,4,4-tetramethyl-1,3-cyclobutanediol residues; and
(ii) 60 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 20 to 40 mole % 2,2,4,4-tetramethyl-1,3-cyclobutanediol residues; and
(ii) 60 to 80 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 35 mole % 2,2,4,4-tetramethyl-1,3-cyclobutanediol residues; and
(ii) 65 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 20 to 40 mole % 2,2,4,4-tetramethyl-1,3-cyclobutanediol residues; and
(ii) 60 to 80 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 25 to 35 mole % 2,2,4,4-tetramethyl-1,3-cyclobutanediol residues; and
(ii) 65 to 75 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 5 to 35 mole % 2,2,4,4-tetramethyl-1,3-cyclobutanediol residues; and
(ii) 65 to 95 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 66° C. to 120° C.

In one aspect, the invention relates to a polyester composition comprising at least one polyester which comprises:

(A) a dicarboxylic acid component comprising:
(i) about 70 to about 100 mole % of cyclohexanedicarboxylic acid residues;
   (a) 70 to 98 mole % trans-cyclohexanedicarboxylic acid residues;
   (b) 2 to 30 mole % cis-cyclohexanedicarboxylic acid residues;
(ii) about 0 to about 30 mole % of aliphatic dicarboxylic acid residues, other than cyclohexanedicarboxylic acid residues, having up to 20 carbon atoms; and
(iii) 0 to 10 mole % of aromatic dicarboxylic acid residues having up to 20 carbon atoms; and

(B) a glycol component comprising:
(i) 5 to 35 mole % 2,2,4,4-tetramethyl-1,3-cyclobutanediol residues; and
(ii) 65 to 95 mole % cyclohexanedimethanol residues;
   wherein the total mole % of the dicarboxylic acid component is equal to 100 mole %;
   wherein the total mole % of the glycol component is equal to 100 mole %;
   wherein the inherent viscosity of the polyester is from 0.72 to 0.85 dL/g as determined in 60/40 (wt/wt) phenol/tetrachloroethane at a concentration of 0.25 g/50 ml at 25° C.; and
   wherein the polyester has a glass transition temperature of from greater than 60° C. to 110° C.

This invention further relates to a thermoplastic article comprising:
a first layer comprising a polymeric material; and
a second layer comprising at least one of the polyesters of the invention;
optionally, at least one antioxidant as described herein, and
optionally, at least one ultraviolet light absorbing compound.

This invention further relates to a thermoplastic article comprising:
a first layer comprising a polymeric material; and
a second layer comprising at least one of the polyesters of the invention; and
at least one antioxidant as described herein; and
optionally, at least one ultraviolet light absorbing compound.

This invention further relates to a thermoplastic article comprising:
a first layer comprising a polymeric material; and
a second layer comprising at least one of the polyesters of the invention; and
optionally, at least one antioxidant as described herein, and
at least one ultraviolet light absorbing compound.

This invention further relates to a thermoplastic article comprising:
a first layer comprising a polymeric material; and
a second layer comprising at least one of the polyesters of the invention; and
at least one antioxidant as described herein, and
at least one ultraviolet light absorbing compound.

This invention further relates to a thermoplastic article comprising:
a first layer comprising a polymeric material; and
a protective layer comprising at least one of the polyesters of the invention;
optionally, at least one antioxidant as described herein, and
optionally, at least one ultraviolet light absorbing compound.

This invention further relates to a thermoplastic article comprising:
a first layer comprising a polymeric material; and
a protective layer comprising at least one of the polyesters of the invention; and
at least one antioxidant as described herein; and
optionally, at least one ultraviolet light absorbing compound.

This invention further relates to a thermoplastic article comprising:
a first layer comprising a polymeric material; and
a protective layer comprising at least one of the polyesters of the invention; and
optionally, at least one antioxidant as described herein, and
at least one ultraviolet light absorbing compound.

This invention further relates to a thermoplastic article comprising:
a first layer comprising a polymeric material; and
a protective layer comprising at least one of the polyesters of the invention; and
at least one antioxidant as described herein, and
at least one ultraviolet light absorbing compound.

This invention further relates to a thermoplastic article comprising:
a first layer comprising a polymeric material; and
a second layer comprising at least one of the polyesters of the invention;
optionally, at least one hindered amine light stabilizer as described herein, and
optionally, at least one ultraviolet light absorbing compound.

This invention further relates to a thermoplastic article comprising:
a first layer comprising a polymeric material; and
a second layer comprising at least one of the polyesters of the invention; and
at least one hindered amine light stabilizer as described herein; and
optionally, at least one ultraviolet light absorbing compound.

This invention further relates to a thermoplastic article comprising:
a first layer comprising a polymeric material; and
a second layer comprising at least one of the polyesters of the invention; and
optionally, at least one hindered amine light stabilizer as described herein, and
at least one ultraviolet light absorbing compound.

This invention further relates to a thermoplastic article comprising:
a first layer comprising a polymeric material; and
a second layer comprising at least one of the polyesters of the invention; and
at least one hindered amine light stabilizer as described herein, and
at least one ultraviolet light absorbing compound.

This invention further relates to a thermoplastic article comprising:
a first layer comprising a polymeric material; and
a protective layer comprising at least one of the polyesters of the invention;
optionally, at least one hindered amine light stabilizer as described herein, and
optionally, at least one ultraviolet light absorbing compound.

This invention further relates to a thermoplastic article comprising:
a first layer comprising a polymeric material; and
a protective layer comprising at least one of the polyesters of the invention; and
at least one hindered amine light stabilizer as described herein; and
optionally, at least one ultraviolet light absorbing compound.

This invention further relates to a thermoplastic article comprising:
a first layer comprising a polymeric material; and
a protective layer comprising at least one of the polyesters of the invention; and
optionally, at least one hindered amine light stabilizer as described herein, and
at least one ultraviolet light absorbing compound.

This invention further relates to a thermoplastic article comprising:
a first layer comprising a polymeric material; and
a protective layer comprising at least one of the polyesters of the invention; and
at least one hindered amine light stabilizer as described herein, and
at least one ultraviolet light absorbing compound.

In one aspect, the invention relates to a polyester composition comprising any of the polyesters described herein comprising from about 0.01 to about 30 mole % of aliphatic dicarboxylic acid residues, other than cyclohexanedicarboxylic acid residues, having up to 20 carbon atoms.

In one aspect, the invention relates to a polyester composition comprising any of the polyesters described herein comprising from about 0.01 to about 30 mole % of aliphatic dicarboxylic acid residues, other than cyclohexanedicarboxylic acid residues, chosen from malonic acid residues, succinic acid residues, glutaric acid residues, adipic acid residues, suberic acid residues, azelaic acid residues, sebacic acid residues, and the like.

In one aspect, the invention relates to a polyester composition comprising any of the polyesters described herein comprising from about 0.01 to about 30 mole % of aliphatic dicarboxylic acid residues, other than cyclohexanedicarboxylic acid residues, chosen from at least one of succinic acid residues and adipic acid residues.

In one embodiment, the polyester compositions of the invention can include at least one hindered amine light stabilizer compound.

In one embodiment, the polyester compositions of the invention can include at least one ultraviolet light absorbing compound.

In one embodiment, the polyester compositions of the invention can include at least one hindered amine light stabilizer compound and at least one ultraviolet light absorbing compound.

In one embodiment, the polyester compositions of the invention comprises no hindered amine light stabilizer compounds.

In one embodiment, the polyester compositions of the invention comprise no ultraviolet light absorbing compounds.

In one aspect, the invention includes thermoformed sheet(s) which can comprise any of the polyester compositions of the invention.

In one aspect, the polyesters useful in the invention can comprise at least one phosphate ester described herein which is present as a thermal stabilizer.

In one aspect, the polyesters useful in the invention can comprise at least one hindered phenol antioxidant described herein which is present as a thermal stabilizer.

In one aspect, the polyesters useful in the invention contain at least one branching agent.

In one aspect, certain polyesters useful in the invention may be amorphous or semicrystalline. In one aspect, certain polyesters useful in the invention can have a relatively low crystallinity. Certain polyesters useful in the invention can thus have a substantially amorphous morphology, meaning that the polyesters comprise substantially unordered regions of polymer.

In one aspect, any of the polyester(s), polyester compositions and/or processes of making the polyesters useful in the invention may comprise at least one tin compound.

In one aspect, any of the polyester(s), polyester compositions and/or processes of making the polyesters useful in the invention may comprise at least one phosphorus compound.

In one aspect, any of the polyester(s), polyester compositions and/or processes of making the polyesters useful in the invention may comprise at least one tin compound, and at least one phosphorus compound.

In one aspect, the amount of tin atoms in the polyesters useful in the invention can be from 0 to 600 ppm tin atoms based on the weight of the final polyester.

In one aspect, the amount of tin atoms in the polyesters useful in the invention can be from 50 to 600 ppm tin atoms based on the weight of the final polyester.

In one aspect, the amount of tin atoms in the polyesters useful in the invention can be from 50 to 400 ppm tin atoms based on the weight of the final polyester.

In one aspect, the amount of titanium atoms in the polyesters useful in the invention can be from 0 to 100 ppm titanium atoms based on the weight of the final polyester.

In one aspect, the amount of titanium atoms in the polyesters useful in the invention can be from 1 to 100 ppm titanium atoms based on the weight of the final polyester.

In one aspect, the polyester compositions are useful in articles of manufacture including, but not limited to, extruded, calendered, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, sheet, multi-layer sheet, and/or fibers.

In one aspect, the polyester compositions useful in the invention may be used in various types of film and/or sheet, including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting.

In one aspect, the invention is related to thermoformed film(s) and/or sheet(s) comprising the polyester(s) and/or polyester compositions of the invention.

In one aspect, the invention is related to articles of manufacture which incorporate the thermoformed film and/or sheet of the invention.

In one aspect, the polyesters useful in the invention can be amorphous or semicrystalline. In one aspect, certain polyesters useful in the invention can have a relatively low crystallinity. Certain polyesters useful in the invention can thus have a substantially amorphous morphology, meaning that the polyesters comprise substantially unordered regions of polymer.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that certain polyesters and/or polyester composition(s) of the invention formed from cyclohexanedicarboxylic acid or an ester thereof, cyclohexanedimethanol or an ester thereof, 2,2,4,4-tetramethyl-1,3-cyclobutanediol or an ester thereof, can have a unique combination of two or more of chosen from: high notched Izod impact strength, certain glass transition temperature (T_{g}), certain inherent viscosities, certain densities, flexural modulus, weatherability, low absorption of ultraviolet radiation, and chemical resistance.

In some embodiments of the invention, certain polyesters and/or polyester compositions of the invention can have a unique combination of three or more of high notched Izod impact strength, certain glass transition temperature (T_{g}), certain inherent viscosities, certain densities, flexural modulus, weatherability, low absorption of ultraviolet radiation, and chemical resistance.

In certain embodiments of the invention, certain polyesters and/or polyester compositions of the invention can have a unique combination of four or more of high notched Izod impact strength, certain glass transition temperature (T_{g}), certain inherent viscosities, certain densities, flexural modulus, weatherability, low absorption of ultraviolet radiation, and chemical resistance.

In other embodiments of the invention, certain polyesters and/or polyester compositions of the invention can have a unique combination of all of the following properties: high notched Izod impact strength, certain glass transition temperature (T_{g}), certain inherent viscosities, certain densities, flexural modulus, weatherability, low absorption of ultraviolet radiation, and chemical resistance.

While polyesters and/or polyester compositions containing some or all of the aforementioned properties are useful in many applications, these properties are particularly useful for building and construction materials, auto panels, and optical media applications.

In one embodiment, the processes of making the polyesters useful in the invention can comprise a batch or continuous process.

In one embodiment, the processes of making the polyesters useful in the invention comprise a continuous process.

When tin is added to to the polyesters and/or polyester compositions and/or process of making the polyesters of the invention, it is added to the process of making the polyester in the form of a tin compound. The amount of the tin compound added to the polyesters of the invention and/or polyester compositions of the invention and/or processes of the invention can be measured in the form of tin atoms present in the final polyester, for example, by weight measured in ppm.

When phosphorus is added to to the polyesters and/or polyester compositions and/or process of making the polyesters of the invention, it is added to the process of making the polyester in the form of a phosphorus compound. The amount of the phosphorus compound added to the polyesters of the invention and/or polyester compositions of the invention and/or processes of the invention can be measured in the form of phosphorus atoms present in the final polyester, for example, by weight measured in ppm.

When titanium is added to to the polyesters and/or polyester compositions and/or process of making the polyesters of the invention, it is added to the process of making the polyester in the form of a titanium compound. The amount of the titanium compound added to the polyesters of the invention and/or polyester compositions of the invention and/or processes of the invention can be measured in the form of titanium atoms present in the final polyester, for example, by weight measured in ppm.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid such as, for example, p-hydroxybutyric acid, and the difunctional hydroxyl compound may be an aliphatic nucleus bearing 2 hydroxyl substituents such as, for example, 1,3-cyclohexanediol or 1,4-cyclohexanediol. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester.

In one embodiment, cyclohexanedicarboxylic acid residues make up part or all of the dicarboxylic acid component used to make the polyesters useful in the present invention. In all embodiments, ranges of from 70 to 100 mole %; or 80 to 100 mole %; or90 to 100 mole %; or 99 to 100 mole %; or 100 mole % cyclohexanedicarboxylic acid residues and/or esters thereof and/or mixtures thereof may be used.

In one embodiment, 1,4-cyclohexanedicarboxylic acid esters make up part or all of the dicarboxylic acid component used to make the polyesters useful in the present invention. In all embodiments, ranges of from 70 to 100 mole %; or 80 to 100 mole %; or 90 to 100 mole %; or 99 to 100 mole %; or 100 mole % 1,4-cyclohexanedicarboxylic acid esters may be used.

In one embodiment, dimethyl-1,4-cyclohexanedicarboxylate (DMCD) makes up part or all of the dicarboxylic acid component used to make the polyesters useful in the present invention. In all embodiments, ranges of from 70 to 100 mole %; or 80 to 100 mole %; or 90 to 100 mole %; or 99 to 100 mole %; or 100 mole % dimethyl-1,4-cyclohexanedicarboxylate may be used.

As used herein, the term “cyclohexanedicarboxylic acid” is intended to include cyclohexanedicarboxylic acid itself and residues thereof as well as any derivative or isomer of cyclohexanedicarboxylic acid, including its associated esters, half-esters, salts, half-salts and/or mixtures thereof or equivalents thereof. Any of 1,1-, 1,2-, 1,3-, 1,4-isomers of cyclohexanedicarboxylic acids or esters thereof or mixtures thereof may be present in the aliphatic acid component of this invention. Cis and trans isomers do not exist for 1,1-cyclohexanedicarboxylic acid.

In certain embodiments, the cyclohexanedicarboxylic acid can be present in the polyesters of the invention in an amount of 70 to 99 mole % in the trans form and 1 to 30 mole % in the cis form. The cyclohexanedicarboxylic acid can be present in the polyesters of the invention in an amount of 70 to 98 mole % in the trans form and 2 to 30 mole % in the cis form. The cyclohexanedicarboxylic acid can be present in the polyesters of the invention in an amount of 70 to 90 mole % in the trans form and 10 to 30 mole % in the cis form. The cyclohexanedicarboxylic acid can be present in the polyesters of the invention in an amount of 80 to 98 mole % in the trans form and 2 to 20 mole % in the cis form. The cyclohexanedicarboxylic acid can be present in the polyesters of the invention in an amount of 90 to 98 mole % in the trans form and 2 to 10 mole % in the cis form. The cyclohexanedicarboxylic acid can be present in the polyesters of the invention in an amount of 90 to 98 mole % in the trans form and 2 to 10 mole % in the cis form. The cyclohexanedicarboxylic acid can be present in the polyesters of the invention in an amount of 92 to 98 mole % in the trans form and 2 to 8 mole % in the cis form. The cyclohexanedicarboxylic acid can be present in the polyesters of the invention in an amount of 95 to 98 mole % in the trans form and 2 to 5 mole % in the cis form. The cyclohexanedicarboxylic acid can be present in the polyesters of the invention in an amount of 78 to 87 mole % in the trans form and 13 to 22 mole % in the cis form. For all embodiments, the total mole percentages of cis- and trans-cyclohexanedicarboxylic acid residues for each isomer of cyclohexanedicarboxylic acid residues in the polyester is equal to 100 mole %.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % cyclohexanedicarboxylic acid, based on the total acid residues, means the polyester contains 10 mole % cyclohexanedicarboxylic acid residues out of a total of 100 mole % acid residues. Thus, there are 10 moles of cyclohexanedicarboxylic acid residues among every 100 moles of acid residues. In another example, a polyester containing 30 mole %. 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

In other aspects of the invention, the T_{g} of the polyesters useful in the polyester compositions of the invention can be at least one of the following ranges: 60 to 155° C.; 60 to 150° C.; 60 to 145° C.; 60 to 140° C.; 60 to 135° C.; 60 to 130° C.; 60 to 125° C.; 60 to 120° C.; 60 to 115° C.; 60 to 110° C.; 60 to 105° C.; 60 to 100° C.; 60 to 95° C.; 60 to 90° C.; 60 to 85° C.; 60 to 80° C.; 60 to 75° C.; 60 to 70° C.; 60 to 65° C.; 65 to 155° C.; 65 to 150° C.; 65 to 145° C.; 65 to 140° C.; 65 to 135° C.; 65 to 130° C.; 65 to 125° C.; 65 to 120° C.; 65 to 115° C.; 65 to 110° C.; 65 to 105° C.; 65 to 100° C.; 65 to 95° C.; 65 to 90° C.; 65 to 85° C.; 65 to 80° C.; 65 to 75° C.; 65 to 70° C.; 70 to 155° C.; 70 to 150° C.; 70 to 145° C.; 70 to 140° C.; 70 to 135° C.; 70 to 130° C.; 70 to 125° C.; 70 to 120° C.; 70 to 115° C.; 70 to 110° C.; 70 to 105° C.; 70 to 100° C.; 70 to 95° C.; 70 to 90° C.; 70 to 85° C.; 70 to 80° C.; 70 to 75° C.; 75 to 155° C.; 75 to 150° C.; 75 to 145° C.; 75 to 140° C.; 75 to 135° C.; 75 to 130° C.; 75 to 125° C.; 75 to 120° C.; 75 to 115° C.; 75 to 110° C.; 75 to 105° C.; 75 to 100° C.; 75 to 95° C.; 75 to 90° C.; 75 to 85° C.; 75 to 80° C.; 80 to 155° C.; 80 to 150° C.; 80 to 145° C.; 80 to 140° C.; 80 to 135° C.; 80 to 130° C.; 80 to 125° C.; 80 to 120° C.; 80 to 115° C.; 80 to 110° C.; 80 to 105° C.; 80 to 100° C.; 80 to 95° C.; 80 to 90° C.; 80 to 85° C.; 85 to 155° C.; 85 to 150° C.; 85 to 145° C.; 85 to 140° C.; 85 to 138° C.; 85 to 135° C.; 85 to 130° C.; 85 to 125° C.; 85 to 120° C.; 85 to 115° C.; 85 to 110° C.; 85 to 105° C.; 85 to 100° C.; 85 to 95° C.; 85 to 90° C.; 90 to 155° C.; 90 to 150° C.; 90 to 145° C.; 90 to 140° C.; 90 to 138° C.; 90 to 135° C.; 90 to 130° C.; 90 to 125° C.; 90 to 120° C.; 90 to 115° C.; 90 to 110° C.; 90 to 105° C.; 90 to 100° C.; 90 to 95° C.; 95 to 155° C.; 95 to 150° C.; 95 to 145° C.; 95 to 140° C.; 95 to 138° C.; 95 to 135° C.; 95 to 130° C.; 95 to 125° C.; 95 to 120° C.; 95 to 115° C.; 95 to 110° C.; 95 to 105° C.; 95 to 100° C.; 100 to 155° C.; 100 to 150° C.; 100 to 145° C.; 100 to 140° C.; 100 to 138° C.; 100 to 135° C.; 100 to 130° C.; 100 to 125° C.; 100 to 120° C.; 100 to 115° C.; 100 to 110° C.; 105 to 155° C.; 105 to 150° C.; 105 to 145° C.; 105 to 140° C.; 105 to 138° C.; 105 to 135° C.; 105to 130° C.; 105to 125° C.; 105to 120° C.; 105to 115° C.; 105to 110° C.; 110 to 155° C.; 110 to 150° C.; 110 to 145° C.; 110 to 140° C.; 110 to 138° C.; 110 to 135° C.; 110 to 130° C.; 110 to 125° C.; 110 to 120° C.; 110 to 115° C.; 115 to 155° C.; 115 to 150° C.; 115 to 145° C.; 115 to 140° C.; 115 to 138° C.; 115 to 135° C.; 110 to 130° C.; 115 to 125° C.; 115 to 120° C.; 120 to 155° C.; 120 to 150° C.; 120 to 145° C.; 120 to 140° C.; 120 to 138° C.; 120 to 135° C.; 120 to 130° C.; 125 to 155° C.; 125 to 150° C.; 125 to 145° C.; 125 to 140° C.; 125 to 138° C.; 125 to 135° C.; 130 to 155° C.; 130 to 150° C.; 130 to 145° C.; 130 to 140° C.; 130 to 138° C.; 130 to 135° C.; 135 to 155° C.; 135 to 150° C.; 135 to 145° C.; 135 to 140° C.; 140 to 155° C.; 140 to 150° C.; 140 to 145° C.; 145 to 155° C.; and/or 145 to 150° C.

In other aspects of the invention, the glycol component for the polyesters useful in the invention include but are not limited to at least one of the following combinations of ranges: 1 to 99 mole % 2,2,4,4-tetramethyl-1,3-cyclobutanediol and 1 to 99 mole % cyclohexanedimethanol; 1 to 95 mole % 2,2,4,4-tetramethyl-1,3-cyclobutanediol and 5 to 99 mole % cyclohexanedimethanol; 1 to 90 mole % 2,2,4,4-tetramethyl-1,3-cyclobutanediol and 10 to 99 mole % cyclohexanedimethanol; 1 to 85 mole % 2,2,4,4-tetramethyl-1,3-cyclobutanediol and 15 to 99 mole % cyclohexanedimethanol; 1 to 80 mole % 2,2,4,4-tetramethyl-1,3-cyclobutanediol and 20 to 99 mole % cyclohexanedimethanol, 1 to 75 mole % 2,2,4,4-tetramethyl-1,3-cyclobutanediol and 25 to 99 mole % cyclohexanedimethanol; 1 to 70 mole % 2,2,4,4-tetramethyl-1,3-cyclobutanediol and 30 to 99 mole % cyclohexanedimethanol; 1 to 65 mole % 2,2,4,4-tetramethyl-1,3-cyclobutanediol and 35 to 99 mole % cyclohexanedimethanol; 1 to 60 mole % 2,2,4,4-tetramethyl-1,3-cyclobutanediol and 40 to 99 mole % cyclohexanedimethanol; 1 to 55 mole % 2,2,4,4-tetramethyl-1,3-cyclobutanediol and 45 to 99 mole % cyclohexanedimethanol; 1 to 50 mole % 2,2,4,4-tetramethyl-1,3-cyclobutanediol and 50 to 99 mole % cyclohexanedimethanol; 1 to 45 mole % 2,2,4,4-tetramethyl-1,3-cyclobutanediol and 55 to 99 mole % cyclohexanedimethanol; 1 to 40 mole % 2,2,4,4-tetramethyl-1,3-cyclobutanediol and 60 to 99 mole % cyclohexanedimethanol; 1 to 35 mole % 2,2,4,4-tetramethyl-1,3-cyclobutanediol and 65 to 99 mole % cyclohexanedimethanol; 1 to 30 mole % 2,2,4,4-tetramethyl-1,3-cyclobutanediol and 70 to 99 mole % cyclohexanedimethanol; 1 to 25 mole % 2,2,4,4-tetramethyl-1,3-cyclobutanediol and 75 to 99 mole % cyclohexanedimethanol; 1 to 20 mole % 2,2,4,4-tetramethyl-1,3-cyclobutanediol and 80 to 99 mole % cyclohexanedimethanol; 1 to 15 mole % 2,2,4,4-tetramethyl-1,3-cyclobutanediol and 85 to 99 mole % cyclohexanedimethanol; 1 to 10 mole % 2,2,4,4-tetramethyl-1,3-cyclobutanediol and 90 to 99 mole % cyclohexanedimethanol; and 1 to 5 mole % 2,2,4,4-tetramethyl-1,3-cyclobutanediol and 95 to 99 mole % cyclohexanedimethanol.

In other aspects of the invention, the glycol component for the polyesters useful in the invention include but are not limited to at least one of the following combinations of ranges: 5 to 99 mole % 2,2,4,4-tetramethyl-1,3-cyclobutanediol and 1 to 95 mole % cyclohexanedimethanol; 5 to 95 mole % 2,2,4,4-tetramethyl-1,3-cyclobutanediol and 5 to 95 mole % cyclohexanedimethanol; 5 to 90 mole % 2,2,4,4-tetramethyl-1,3-cyclobutanediol and 10 to 95 mole % cyclohexanedimethanol; 5 to 85 mole % 2,2,4,4-tetramethyl-1,3-cyclobutanediol and 15 to 95 mole % cyclohexanedimethanol; 5 to 80 mole % 2,2,4,4-tetramethyl-1,3-cyclobutanediol and 20 to 95 mole % cyclohexanedimethanol, 5 to 75 mole % 2,2,4,4-tetramethyl-1,3-cyclobutanediol and 25 to 95 mole % cyclohexanedimethanol; 5 to 70 mole % 2,2,4,4-tetramethyl-1,3-cyclobutanediol and 30 to 95 mole % cyclohexanedimethanol; 5 to 65 mole % 2,2,4,4-tetramethyl-1,3-cyclobutanediol and 35 to 95 mole % cyclohexanedimethanol; 5 to 60 mole % 2,2,4,4-tetramethyl-1,3-cyclobutanediol and 40 to 95 mole % cyclohexanedimethanol; 5 to 55 mole % 2,2,4,4-tetramethyl-1,3-cyclobutanediol and 45 to 95 mole % cyclohexanedimethanol; and 5 to 50 mole % 2,2,4,4-tetramethyl-1,3-cyclobutanediol and 50 to 95 mole % cyclohexanedimethanol.

In other aspects of the invention, the glycol component for the polyesters useful in the invention include but are not limited to at least one of the following combinations of ranges: 5 to less than 50 mole % 2,2,4,4-tetramethyl-1,3-cyclobutanediol and greater than 50 to 95 mole % cyclohexanedimethanol; 5 to 45 mole % 2,2,4,4-tetramethyl-1,3-cyclobutanediol and 55 to 95 mole % cyclohexanedimethanol; 5 to 40 mole % 2,2,4,4-tetramethyl-1,3-cyclobutanediol and 60 to 95 mole % cyclohexanedimethanol; 5 to 35 mole % 2,2,4,4-tetramethyl-1,3-cyclobutanediol and 65 to 95 mole % cyclohexanedimethanol; 5 to less than 35 mole % 2,2,4,4-tetramethyl-1,3-cyclobutanediol and greater than 65 to 95 mole % cyclohexanedimethanol; 5 to 30 mole % 2,2,4,4-tetramethyl-1,3-cyclobutanediol and 70 to 95 mole % cyclohexanedimethanol; 5 to 25 mole % 2,2,4,4-tetramethyl-1,3-cyclobutanediol and 75 to 95 mole % cyclohexanedimethanol; 5 to 20 mole % 2,2,4,4-tetramethyl-1,3-cyclobutanediol and 80 to 95 mole % cyclohexanedimethanol; 5 to 15 mole % 2,2,4,4-tetramethyl-1,3-cyclobutanediol and 85 to 95 mole % cyclohexanedimethanol; 5 to 10 mole % 2,2,4,4-tetramethyl-1,3-cyclobutanediol and 90 to 95 mole % cyclohexanedimethanol; greater than 5 to less than 10 mole % 2,2,4,4-tetramethyl-1,3-cyclobutanediol and less than 90 to greater than 95 mole % cyclohexanedimethanol; 5.5 mole % to 9.5 mole % 2,2,4,4-tetramethyl-1,3-cyclobutanediol and 94.5 mole % to 90.5 mole % cyclohexanedimethanol; and 6 to 9 mole % 2,2,4,4-tetramethyl-1,3-cyclobutanediol and 94 to 91 mole % cyclohexanedimethanol.

In other aspects of the invention, the glycol component for the polyesters useful in the invention include but are not limited to at least one of the following combinations of ranges: 10 to 99 mole % 2,2,4,4-tetramethyl-1,3-cyclobutanediol and 1 to 90 mole % cyclohexanedimethanol; 10 to 95 mole % 2,2,4,4-tetramethyl-1,3-cyclobutanediol and 5 to 90 mole % cyclohexanedimethanol; 10 to 90 mole % 2,2,4,4-tetramethyl-1,3-cyclobutanediol and 10 to 90 mole % cyclohexanedimethanol; 10 to 85 mole % 2,2,4,4-tetramethyl-1,3-cyclobutanediol and 15 to 90 mole % cyclohexanedimethanol; 10 to 80 mole % 2,2,4,4-tetramethyl-1,3-cyclobutanediol and 20 to 90 mole % cyclohexanedimethanol; 10 to 75 mole % 2,2,4,4-tetramethyl-1,3-cyclobutanediol and 25 to 90 mole % cyclohexanedimethanol; 10 to 70 mole % 2,2,4,4-tetramethyl-1,3-cyclobutanediol and 30 to 90 mole % cyclohexanedimethanol; 10 to 65 mole % 2,2,4,4-tetramethyl-1,3-cyclobutanediol and 35 to 90 mole % cyclohexanedimethanol; 10 to 60 mole % 2,2,4,4-tetramethyl-1,3-cyclobutanediol and 40 to 90 mole % cyclohexanedimethanol; 10 to 55 mole % 2,2,4,4-tetramethyl-1,3-cyclobutanediol and 45 to 90 mole % cyclohexanedimethanol; 10 to 50 mole % 2,2,4,4-tetramethyl-1,3-cyclobutanediol and 50 to 90 mole % cyclohexanedimethanol; 10 to less than 50 mole % 2,2,4,4-tetramethyl-1,3-cyclobutanediol and greater than 50 to 90 mole % cyclohexanedimethanol; 10 to 45 mole % 2,2,4,4-tetramethyl-1,3-cyclobutanediol and 55 to 90 mole % cyclohexanedimethanol; 10 to 40 mole % 2,2,4,4-tetramethyl-1,3-cyclobutanediol and 60 to 90 mole % cyclohexanedimethanol; 10 to 35 mole % 2,2,4,4-tetramethyl-1,3-cyclobutanediol and 65 to 90 mole % cyclohexanedimethanol; 10 to less than 35 mole % 2,2,4,4-tetramethyl-1,3-cyclobutanediol and greater than 65 to 90% cyclohexanedimethanol; 10 to 30 mole % 2,2,4,4-tetramethyl-1,3-cyclobutanediol and 70 to 90 mole % cyclohexanedimethanol; 10 to 25 mole % 2,2,4,4-tetramethyl-1,3-cyclobutanediol and 75 to 90 mole % cyclohexanedimethanol; 10 to 20 mole % 2,2,4,4-tetramethyl-1,3-cyclobutanediol and 80 to 90 mole % cyclohexanedimethanol; and 10 to 15 mole % 2,2,4,4-tetramethyl-1,3-cyclobutanediol and 85 to 90 mole % cyclohexanedimethanol.

In other aspects of the invention, the glycol component for the polyesters useful in the invention include but are not limited to at least one of the following combinations of ranges: greater than 10 to 99 mole % 2,2,4,4-tetramethyl-1,3-cyclobutanediol and 1 to less than 90 mole % cyclohexanedimethanol; greater than 10 to 95 mole % 2,2,4,4-tetramethyl-1,3-cyclobutanediol and 5 to less than 90 mole % cyclohexanedimethanol; greater than 10 to 90 mole % 2,2,4,4-tetramethyl-1,3-cyclobutanediol and 10 to less than 90 mole % cyclohexanedimethanol; greater than 10 to 85 mole % 2,2,4,4-tetramethyl-1,3-cyclobutanediol and 15 to less than 90 mole % cyclohexanedimethanol; greater than 10 to 80 mole % 2,2,4,4-tetramethyl-1,3-cyclobutanediol and 20 to less than 90 mole % cyclohexanedimethanol; greater than 10 to 75 mole % 2,2,4,4-tetramethyl-1,3-cyclobutanediol and 25 to less than 90 mole % cyclohexanedimethanol; greater than 10 to 70 mole % 2,2,4,4-tetramethyl-1,3-cyclobutanediol and 30 to less than 90 mole % cyclohexanedimethanol; greater than 10 to 65 mole % 2,2,4,4-tetramethyl-1,3-cyclobutanediol and 35 to less than 90 mole % cyclohexanedimethanol; greater than 10 to 60 mole % 2,2,4,4-tetramethyl-1,3-cyclobutanediol and 40 to less than 90 mole % cyclohexanedimethanol; greater than 10 to 55 mole % 2,2,4,4-tetramethyl-1,3-cyclobutanediol and 45 to less than 90 mole % cyclohexanedimethanol; greater than 10 to 50 mole % 2,2,4,4-tetramethyl-1,3-cyclobutanediol and 50 to less than 90 mole % cyclohexanedimethanol; greater than 10 to less than 50 mole % 2,2,4,4-tetramethyl-1,3-cyclobutanediol and greater than 50 to less than 90 mole % cyclohexanedimethanol; greater than 10 to 45 mole % 2,2,4,4-tetramethyl-1,3-cyclobutanediol and 55 to less than 90 mole % cyclohexanedimethanol; greater than 10 to 40 mole % 2,2,4,4-tetramethyl-1,3-cyclobutanediol and 60 to less than 90 mole % cyclohexanedimethanol; greater than 10 to 35 mole % 2,2,4,4-tetramethyl-1,3-cyclobutanediol and 65 to less than 90 mole % cyclohexanedimethanol; 10 to less than 34 mole % 2,2,4,4-tetramethyl-1,3-cyclobutanediol and greater than 66 to 90% cyclohexanedimethanol; greater than 10 to 30 mole % 2,2,4,4-tetramethyl-1,3-cyclobutanediol and 70 to less than 90 mole % cyclohexanedimethanol; greater than 10 to 25 mole % 2,2,4,4-tetramethyl-1,3-cyclobutanediol and 75 to less than 90 mole % cyclohexanedimethanol; greater than 10 to 20 mole % 2,2,4,4-tetramethyl-1,3-cyclobutanediol and 80 to less than 90 mole % cyclohexanedimethanol; and greater than 10 to 15 mole % 2,2,4,4-tetramethyl-1,3-cyclobutanediol and 85 to less than 90 mole % cyclohexanedimethanol.

In other aspects of the invention, the glycol component for the polyesters useful in the invention include but are not limited to at least one of the following combinations of ranges: 11 to 99 mole % 2,2,4,4-tetramethyl-1,3-cyclobutanediol and 1 to 89 mole % cyclohexanedimethanol; 11 to 95 mole % 2,2,4,4-tetramethyl-1,3-cyclobutanediol and 5 to 89 mole % cyclohexanedimethanol; 11 to 90 mole % 2,2,4,4-tetramethyl-1,3-cyclobutanediol and 10 to 89 mole % cyclohexanedimethanol; 11 to 85 mole % 2,2,4,4-tetramethyl-1,3-cyclobutanediol and 15 to 89 mole % cyclohexanedimethanol; 11 to 80 mole % 2,2,4,4-tetramethyl-1,3-cyclobutanediol and 20 to 89 mole % cyclohexanedimethanol; 11 to 75 mole % 2,2,4,4-tetramethyl-1,3-cyclobutanediol and 25 to 89 mole % cyclohexanedimethanol; 11 to 70 mole % 2,2,4,4-tetramethyl-1,3-cyclobutanediol and 30 to 89 mole % cyclohexanedimethanol; 11 to 65 mole % 2,2,4,4-tetramethyl-1,3-cyclobutanediol and 35 to 89 mole % cyclohexanedimethanol; 11 to 60 mole % 2,2,4,4-tetramethyl-1,3-cyclobutanediol and 40 to 89 mole % cyclohexanedimethanol; 11 to 55 mole % 2,2,4,4-tetramethyl-1,3-cyclobutanediol and 45 to 89 mole % cyclohexanedimethanol; 11 to 50 mole % 2,2,4,4-tetramethyl-1,3-cyclobutanediol and 50 to 89 mole % cyclohexanedimethanol; 11 to less than 50 mole % 2,2,4,4-tetramethyl-1,3-cyclobutanediol and greater than 50 to 89 mole % cyclohexanedimethanol; 11 to 45 mole % 2,2,4,4-tetramethyl-1,3-cyclobutanediol and 55 to 89 mole % cyclohexanedimethanol; 11 to 40 mole % 2,2,4,4-tetramethyl-1,3-cyclobutanediol and 60 to 89 mole % cyclohexanedimethanol; 11 to 35 mole % 2,2,4,4-tetramethyl-1,3-cyclobutanediol and 65 to 89 mole % cyclohexanedimethanol; 11 to 30 mole % 2,2,4,4-tetramethyl-1,3-cyclobutanediol and 70 to 89 mole % cyclohexanedimethanol; 11 to 24 mole % 2,2,4,4-tetramethyl-1,3-cyclobutanediol and 76 to 89 mole % cyclohexanedimethanol; and i 1 to 25 mole % 2,2,4,4-tetramethyl-1,3-cyclobutanediol and 75 to 89 mole % cyclohexanedimethanol.

In other aspects of the invention, the glycol component for the polyesters useful in the invention include but are not limited to at least one of the following combinations of ranges: 15 to 99 mole % 2,2,4,4-tetramethyl-1,3-cyclobutanediol and 1 to 85 mole % cyclohexanedimethanol; 15 to 95 mole % 2,2,4,4-tetramethyl-1,3-cyclobutanediol and 5 to 85 mole % cyclohexanedimethanol; 15 to 90 mole % 2,2,4,4-tetramethyl-1,3-cyclobutanediol and 10 to 85 mole % cyclohexanedimethanol; 15 to 85 mole % 2,2,4,4-tetramethyl-1,3-cyclobutanediol and 15 to 85 mole % cyclohexanedimethanol; 15 to 80 mole % 2,2,4,4-tetramethyl-1,3-cyclobutanediol and 20 to 85 mole % cyclohexanedimethanol; 15 to 75 mole % 2,2,4,4-tetramethyl-1,3-cyclobutanediol and 25 to 85 mole % cyclohexanedimethanol; 15 to 70 mole % 2,2,4,4-tetramethyl-1,3-cyclobutanediol and 30 to 85 mole % cyclohexanedimethanol; 15 to 65 mole % 2,2,4,4-tetramethyl-1,3-cyclobutanediol and 35 to 85 mole % cyclohexanedimethanol; 15 to 60 mole % 2,2,4,4-tetramethyl-1,3-cyclobutanediol and 40 to 85 mole % cyclohexanedimethanol; 15 to 55 mole % 2,2,4,4-tetramethyl-1,3-cyclobutanediol and 45 to 85 mole % cyclohexanedimethanol; 15 to 50 mole % 2,2,4,4-tetramethyl-1,3-cyclobutanediol and 50 to 85 mole % cyclohexanedimethanol; 15 to less than 50 mole % 2,2,4,4-tetramethyl-1,3-cyclobutanediol and greater than 50 to 85 mole % cyclohexanedimethanol; 15 to 45 mole % 2,2,4,4-tetramethyl-1,3-cyclobutanediol and 55 to 85 mole % cyclohexanedimethanol; 15 to 40 mole % 2,2,4,4-tetramethyl-1,3-cyclobutanediol and 60 to 85 mole % cyclohexanedimethanol; 15 to 35 mole % 2,2,4,4-tetramethyl-1,3-cyclobutanediol and 65 to 85 mole % cyclohexanedimethanol; 15 to 30 mole % 2,2,4,4-tetramethyl-1,3-cyclobutanediol and 70 to 85 mole % cyclohexanedimethanol; 15 to 25 mole % 2,2,4,4-tetramethyl-1,3-cyclobutanediol and 75 to 85 mole % cyclohexanedimethanol; and 15 to 24 mole % 2,2,4,4-tetramethyl-1,3-cyclobutanediol and 76 to 85 mole % cyclohexanedimethanol.

In other aspects of the invention, the glycol component for the polyesters useful in the invention include but are not limited to at least one of the following combinations of ranges: 20 to 99 mole % 2,2,4,4-tetramethyl-1,3-cyclobutanediol and 1 to 80 mole % cyclohexanedimethanol; 20 to 95 mole % 2,2,4,4-tetramethyl-1,3-cyclobutanediol and 5 to 80 mole % cyclohexanedimethanol; 20 to 90 mole % 2,2,4,4-tetramethyl-1,3-cyclobutanediol and 10 to 80 mole % cyclohexanedimethanol; 20 to 85 mole % 2,2,4,4-tetramethyl-1,3-cyclobutanediol and 15 to 80 mole % cyclohexanedimethanol; 20 to 80 mole % 2,2,4,4-tetramethyl-1,3-cyclobutanediol and 20 to 80 mole % cyclohexanedimethanol; 20 to 75 mole % 2,2,4,4-tetramethyl-1,3-cyclobutanediol and 25 to 80 mole % cyclohexanedimethanol; 20 to 70 mole % 2,2,4,4-tetramethyl-1,3-cyclobutanediol and 30 to 80 mole % cyclohexanedimethanol; 20 to 65 mole % 2,2,4,4-tetramethyl-1,3-cyclobutanediol and 35 to 80 mole % cyclohexanedimethanol; 20 to 60 mole % 2,2,4,4-tetramethyl-1,3-cyclobutanediol and 40 to 80 mole % cyclohexanedimethanol; 20 to 55 mole % 2,2,4,4-tetramethyl-1,3-cyclobutanediol and 45 to 80 mole % cyclohexanedimethanol; 20 to 50 mole % 2,2,4,4-tetramethyl-1,3-cyclobutanediol and 50 to 80 mole % cyclohexanedimethanol; 20 to less than 50 mole % 2,2,4,4-tetramethyl-1,3-cyclobutanediol and greater than 50 to 80 mole % cyclohexanedimethanol; 20 to 45 mole % 2,2,4,4-tetramethyl-1,3-cyclobutanediol and 55 to 80 mole % cyclohexanedimethanol; 20 to 40 mole % 2,2,4,4-tetramethyl-1,3-cyclobutanediol and 60 to 80 mole % cyclohexanedimethanol; 20 to 35 mole % 2,2,4,4-tetramethyl-1,3-cyclobutanediol and 65 to 80 mole % cyclohexanedimethanol; 20 to 30 mole % 2,2,4,4-tetramethyl-1,3-cyclobutanediol and 70 to 80 mole % cyclohexanedimethanol; and 20 to 25 mole % 2,2,4,4-tetramethyl-1,3-cyclobutanediol and 75 to 80 mole % cyclohexanedimethanol.

In other aspects of the invention, the glycol component for the polyesters useful in the invention include but are not limited to at least one of the following combinations of ranges: 25 to 99 mole % 2,2,4,4-tetramethyl-1,3-cyclobutanediol and 1 to 75 mole % cyclohexanedimethanol; 25 to 95 mole % 2,2,4,4-tetramethyl-1,3-cyclobutanediol and 5 to 75 mole % cyclohexanedimethanol; 25 to 90 mole % 2,2,4,4-tetramethyl-1,3-cyclobutanediol and 10 to 75 mole % cyclohexanedimethanol; 25 to 85 mole % 2,2,4,4-tetramethyl-1,3-cyclobutanediol and 15 to 75 mole % cyclohexanedimethanol; 25 to 80 mole % 2,2,4,4-tetramethyl-1,3-cyclobutanediol and 20 to 75 mole % cyclohexanedimethanol; 25 to 75 mole % 2,2,4,4-tetramethyl-1,3-cyclobutanediol and 25 to 75 mole % cyclohexanedimethanol; 25 to 70 mole % 2,2,4,4-tetramethyl-1,3-cyclobutanediol and 30 to 75 mole % cyclohexanedimethanol; 25 to 65 mole % 2,2,4,4-tetramethyl-1,3-cyclobutanediol and 35 to 75 mole % cyclohexanedimethanol; 25 to 60 mole % 2,2,4,4-tetramethyl-1,3-cyclobutanediol and 40 to 75 mole % cyclohexanedimethanol; 25 to 55 mole % 2,2,4,4-tetramethyl-1,3-cyclobutanediol and 45 to 75 mole % cyclohexanedimethanol; 25 to 50 mole % 2,2,4,4-tetramethyl-1,3-cyclobutanediol and 50 to 75 mole % cyclohexanedimethanol; 25 to less than 50 mole % 2,2,4,4-tetramethyl-1,3-cyclobutanediol and greater than 50 to 75 mole % cyclohexanedimethanol; 25 to 45 mole % 2,2,4,4-tetramethyl-1,3-cyclobutanediol and 55 to 75 mole % cyclohexanedimethanol; 25 to 40 mole % 2,2,4,4-tetramethyl-1,3-cyclobutanediol and 60 to 75 mole % cyclohexanedimethanol; 25 to 35 mole % 2,2,4,4-tetramethyl-1,3-cyclobutanediol and 65 to 75 mole % cyclohexanedimethanol; and 25 to 30 mole % 2,2,4,4-tetramethyl-1,3-cyclobutanediol and 70 to 75 mole % cyclohexanedimethanol.

In other aspects of the invention, the glycol component for the polyesters useful in the invention include but are not limited to at least one of the following combinations of ranges: 30 to 99 mole % 2,2,4,4-tetramethyl-1,3-cyclobutanediol and 1 to 70 mole % cyclohexanedimethanol; 30 to 95 mole % 2,2,4,4-tetramethyl-1,3-cyclobutanediol and 5 to 70 mole % cyclohexanedimethanol; 30 to 90 mole % 2,2,4,4-tetramethyl-1,3-cyclobutanediol and 10 to 70 mole % cyclohexanedimethanol; 30 to 85 mole % 2,2,4,4-tetramethyl-1,3-cyclobutanediol and 15 to 70 mole % cyclohexanedimethanol; 30 to 80 mole % 2,2,4,4-tetramethyl-1,3-cyclobutanediol and 20 to 70 mole % cyclohexanedimethanol; 30 to 75 mole % 2,2,4,4-tetramethyl-1,3-cyclobutanediol and 25 to 70 mole % cyclohexanedimethanol; 30 to 70 mole % 2,2,4,4-tetramethyl-1,3-cyclobutanediol and 30 to 70 mole % cyclohexanedimethanol; 30 to 65 mole % 2,2,4,4-tetramethyl-1,3-cyclobutanediol and 35 to 70 mole % cyclohexanedimethanol; 30 to 60 mole % 2,2,4,4-tetramethyl-1,3-cyclobutanediol and 40 to 70 mole % cyclohexanedimethanol; 30 to 55 mole % 2,2,4,4-tetramethyl-1,3-cyclobutanediol and 45 to 70 mole % cyclohexanedimethanol; 30 to 50 mole % 2,2,4,4-tetramethyl-1,3-cyclobutanediol and 50 to 70 mole % cyclohexanedimethanol; 30 to less than 50 mole % 2,2,4,4-tetramethyl-1,3-cyclobutanediol and greater than 50 to 70 mole % cyclohexanedimethanol; 30 to 45 mole % 2,2,4,4-tetramethyl-1,3-cyclobutanediol and 55 to 70 mole % cyclohexanedimethanol; 30 to 40 mole % 2,2,4,4-tetramethyl-1,3-cyclobutanediol and 60 to 70 mole % cyclohexanedimethanol; 30 to 35 mole % 2,2,4,4-tetramethyl-1,3-cyclobutanediol and 65 to 70 mole % cyclohexanedimethanol.

In other aspects of the invention, the glycol component for the polyesters useful in the invention include but are not limited to at least one of the following combinations of ranges: 35 to 99 mole % 2,2,4,4-tetramethyl-1,3-cyclobutanediol and 1 to 65 mole % cyclohexanedimethanol; 35 to 95 mole % 2,2,4,4-tetramethyl-1,3-cyclobutanediol and 5 to 65 mole % cyclohexanedimethanol; 35 to 90 mole % 2,2,4,4-tetramethyl-1,3-cyclobutanediol and 10 to 65 mole % cyclohexanedimethanol; 35 to 85 mole % 2,2,4,4-tetramethyl-1,3-cyclobutanediol and 15 to 65 mole % cyclohexanedimethanol; 35 to 80 mole % 2,2,4,4-tetramethyl-1,3-cyclobutanediol and 20 to 65 mole % cyclohexanedimethanol; 35 to 75 mole % 2,2,4,4-tetramethyl-1,3-cyclobutanediol and 25 to 65 mole % cyclohexanedimethanol; 35 to 70 mole % 2,2,4,4-tetramethyl-1,3-cyclobutanediol and 30 to 65 mole % cyclohexanedimethanol; 35 to 65 mole % 2,2,4,4-tetramethyl-1,3-cyclobutanediol and 35 to 65 mole % cyclohexanedimethanol; 35 to 60 mole % 2,2,4,4-tetramethyl-1,3-cyclobutanediol and 40 to 65 mole % cyclohexanedimethanol; 35 to 55 mole % 2,2,4,4-tetramethyl-1,3-cyclobutanediol and 45 to 65 mole % cyclohexanedimethanol; 35 to 50 mole % 2,2,4,4-tetramethyl-1,3-cyclobutanediol and 50 to 65 mole % cyclohexanedimethanol; 35 to less than 50 mole % 2,2,4,4-tetramethyl-1,3-cyclobutanediol and greater than 50 to 65 mole % cyclohexanedimethanol; 35 to 45 mole % 2,2,4,4-tetramethyl-1,3-cyclobutanediol and 55 to 65 mole % cyclohexanedimethanol; 35 to 40 mole % 2,2,4,4-tetramethyl-1,3-cyclobutanediol and 60 to 65 mole % cyclohexanedimethanol.

In other aspects of the invention, the glycol component for the polyesters useful in the invention include but are not limited to at least one of the following combinations of ranges: 40 to 99 mole % 2,2,4,4-tetramethyl-1,3-cyclobutanediol and 1 to 60 mole % cyclohexanedimethanol; 40 to 95 mole % 2,2,4,4-tetramethyl-1,3-cyclobutanediol and 5 to 60 mole % cyclohexanedimethanol; 40 to 90 mole % 2,2,4,4-tetramethyl-1,3-cyclobutanediol and 10 to 60 mole % cyclohexanedimethanol; 40 to 85 mole % 2,2,4,4-tetramethyl-1,3-cyclobutanediol and 15 to 60 mole % cyclohexanedimethanol; 40 to 80 mole % 2,2,4,4-tetramethyl-1,3-cyclobutanediol and 20 to 60 mole % cyclohexanedimethanol; 40 to 75 mole % 2,2,4,4-tetramethyl-1,3-cyclobutanediol and 25 to 60 mole % cyclohexanedimethanol; 40 to 70 mole % 2,2,4,4-tetramethyl-1,3-cyclobutanediol and 30 to 60 mole % cyclohexanedimethanol; 40 to 65 mole % 2,2,4,4-tetramethyl-1,3-cyclobutanediol and 35 to 60 mole % cyclohexanedimethanol; 40 to 60 mole % 2,2,4,4-tetramethyl-1,3-cyclobutanediol and 40 to 60 mole % cyclohexanedimethanol; 40 to 55 mole % 2,2,4,4-tetramethyl-1,3-cyclobutanediol and 45 to 60 mole % cyclohexanedimethanol; 40 to less than 50 mole % 2,2,4,4-tetramethyl-1,3-cyclobutanediol and greater than 50 to 60 mole % cyclohexanedimethanol; 40 to 50 mole % 2,2,4,4-tetramethyl-1,3-cyclobutanediol and 50 to 60 mole % cyclohexanedimethanol; and 40 to 45 mole % 2,2,4,4-tetramethyl-1,3-cyclobutanediol and 55 to 60 mole % cyclohexanedimethanol.

In other aspects of the invention, the glycol component for the polyesters useful in the invention include but are not limited to at least one of the following combinations of ranges: 45 to 99 mole % 2,2,4,4-tetramethyl-1,3-cyclobutanediol and 1 to 55 mole % cyclohexanedimethanol; 45 to 95 mole % 2,2,4,4-tetramethyl-1,3-cyclobutanediol and 5 to 55 mole % cyclohexanedimethanol; 45 to 90 mole % 2,2,4,4-tetramethyl-1,3-cyclobutanediol and 10 to 55 mole % cyclohexanedimethanol; 45 to 85 mole % 2,2,4,4-tetramethyl-1,3-cyclobutanediol and 15 to 55 mole % cyclohexanedimethanol; 45 to 80 mole % 2,2,4,4-tetramethyl-1,3-cyclobutanediol and 20 to 55 mole % cyclohexanedimethanol; 45 to 75 mole % 2,2,4,4-tetramethyl-1,3-cyclobutanediol and 25 to 55 mole % cyclohexanedimethanol; 45 to 70 mole % 2,2,4,4-tetramethyl-1,3-cyclobutanediol and 30 to 55 mole % cyclohexanedimethanol; 45 to 65 mole % 2,2,4,4-tetramethyl-1,3-cyclobutanediol and 35 to 55 mole % cyclohexanedimethanol; 45 to 60 mole % 2,2,4,4-tetramethyl-1,3-cyclobutanediol and 40 to 55 mole % cyclohexanedimethanol; greater than 45 to 55 mole % 2,2,4,4-tetramethyl-1,3-cyclobutanediol and 45 to less than 55 mole % cyclohexanedimethanol; 45 to 55 mole % 2,2,4,4-tetramethyl-1,3-cyclobutanediol and 45 to 55 mole % cyclohexanedimethanol; and 45 to 50 mole % 2,2,4,4-tetramethyl-1,3-cyclobutanediol and 50 to 60 mole % cyclohexanedimethanol.

In other aspects of the invention, the glycol component for the polyesters useful in the invention include but are not limited to at least one of the following combinations of ranges: greater than 50 to 99 mole % 2,2,4,4-tetramethyl-1,3-cyclobutanediol and 1 to less than 50 mole % cyclohexanedimethanol; greater than 50 to 95 mole % 2,2,4,4-tetramethyl-1,3-cyclobutanediol and 5 to less than 50 mole % cyclohexanedimethanol; greater than 50 to 90 mole % 2,2,4,4-tetramethyl-1,3-cyclobutanediol and 10 to less than 50 mole % cyclohexanedimethanol; greater than 50 to 85 mole % 2,2,4,4-tetramethyl-1,3-cyclobutanediol and 15 to less than 50 mole % cyclohexanedimethanol; greater than 50 to 80 mole % 2,2,4,4-tetramethyl-1,3-cyclobutanediol and 20 to less than 50 mole % cyclohexanedimethanol; greater than 50 to 75 mole % 2,2,4,4-tetramethyl-1,3-cyclobutanediol and 25 to less than 50 mole % cyclohexanedimethanol; greater than 50 to 70 mole % 2,2,4,4-tetramethyl-1,3-cyclobutanediol and 30 to less than 50 mole % cyclohexanedimethanol; greater than 50 to 65 mole % 2,2,4,4-tetramethyl-1,3-cyclobutanediol and 35 to less than 50 mole % cyclohexanedimethanol; greater than 50 to 60 mole % 2,2,4,4-tetramethyl-1,3-cyclobutanediol and 40 to less than 50 mole % cyclohexanedimethanol.

In other aspects of the invention, the glycol component for the polyesters useful in the invention include but are not limited to at least one of the following combinations of ranges: greater than 51 to 99 mole % 2,2,4,4-tetramethyl-1,3-cyclobutanediol and 1 to less than 49 mole % cyclohexanedimethanol; greater than 51 to 95 mole % 2,2,4,4-tetramethyl-1,3-cyclobutanediol and 5 to less than 49 mole % cyclohexanedimethanol; greater than 51 to 90 mole % 2,2,4,4-tetramethyl-1,3-cyclobutanediol and 10 to less than 49 mole % cyclohexanedimethanol; greater than 51 to 85 mole % 2,2,4,4-tetramethyl-1,3-cyclobutanediol and 15 to less than 49 mole % cyclohexanedimethanol; greater than 51 to 80 mole % 2,2,4,4-tetramethyl-1,3-cyclobutanediol and 20 to less than 49 mole % cyclohexanedimethanol; greater than 51 to 75 mole % 2,2,4,4-tetramethyl-1,3-cyclobutanediol and 25 to less than 49 mole % cyclohexanedimethanol; greater than 51 to 70 mole % 2,2,4,4-tetramethyl-1,3-cyclobutanediol and 30 to less than 49 mole % cyclohexanedimethanol; greater than 51 to 65 mole % 2,2,4,4-tetramethyl-1,3-cyclobutanediol and 35 to less than 49 mole % cyclohexanedimethanol; greater than 51 to 60 mole % 2,2,4,4-tetramethyl-1,3-cyclobutanediol and 40 to less than 49 mole % cyclohexanedimethanol.

In other aspects of the invention, the glycol component for the polyesters useful in the invention include but are not limited to at least one of the following combinations of ranges: 55 to 99 mole % 2,2,4,4-tetramethyl-1,3-cyclobutanediol and 1 to 45 mole % cyclohexanedimethanol; 55 to 95 mole % 2,2,4,4-tetramethyl-1,3-cyclobutanediol and 5 to 45 mole % cyclohexanedimethanol; 55 to 90 mole % 2,2,4,4-tetramethyl-1,3-cyclobutanediol and 10 to 45 mole % cyclohexanedimethanol; 55 to 85 mole % 2,2,4,4-tetramethyl-1,3-cyclobutanediol and 15 to 45 mole % cyclohexanedimethanol; 55 to 80 mole % 2,2,4,4-tetramethyl-1,3-cyclobutanediol and 20 to 45 mole % cyclohexanedimethanol; 55 to 75 mole % 2,2,4,4-tetramethyl-1,3-cyclobutanediol and 25 to 45 mole % cyclohexanedimethanol; 55 to 70 mole % 2,2,4,4-tetramethyl-1,3-cyclobutanediol and 30 to 45 mole % cyclohexanedimethanol; 55 to 65 mole % 2,2,4,4-tetramethyl-1,3-cyclobutanediol and 35 to 45 mole % cyclohexanedimethanol; and 55 to 60 mole % 2,2,4,4-tetramethyl-1,3-cyclobutanediol and 40 to 45 mole % cyclohexanedimethanol.

In other aspects of the invention, the glycol component for the polyesters useful in the invention include but are not limited to at least one of the following combinations of ranges: 60 to 99 mole % 2,2,4,4-tetramethyl-1,3-cyclobutanediol and 1 to 40 mole % cyclohexanedimethanol; 60 to 95 mole % 2,2,4,4-tetramethyl-1,3-cyclobutanediol and 5 to 40 mole % cyclohexanedimethanol; 60 to 90 mole % 2,2,4,4-tetramethyl-1,3-cyclobutanediol and 10 to 40 mole % cyclohexanedimethanol; 60 to 85 mole % 2,2,4,4-tetramethyl-1,3-cyclobutanediol and 15 to 40 mole % cyclohexanedimethanol; 60 to 80 mole % 2,2,4,4-tetramethyl-1,3-cyclobutanediol and 20 to 40 mole % cyclohexanedimethanol; 60 to 75 mole % 2,2,4,4-tetramethyl-1,3-cyclobutanediol and 25 to 40 mole % cyclohexanedimethanol; and 60 to 70 mole % 2,2,4,4-tetramethyl-1,3-cyclobutanediol and 30 to 40 mole % cyclohexanedimethanol.

In other aspects of the invention, the glycol component for the polyesters useful in the invention include but are not limited to at least one of the following combinations of ranges: 65 to 99 mole % 2,2,4,4-tetramethyl-1,3-cyclobutanediol and 1 to 35 mole % cyclohexanedimethanol; 65 to 95 mole % 2,2,4,4-tetramethyl-1,3-cyclobutanediol and 5 to 35 mole % cyclohexanedimethanol; 65 to 90 mole % 2,2,4,4-tetramethyl-1,3-cyclobutanediol and 10 to 35 mole % cyclohexanedimethanol; 65 to 85 mole % 2,2,4,4-tetramethyl-1,3-cyclobutanediol and 15 to 35 mole % cyclohexanedimethanol; 65 to 80 mole % 2,2,4,4-tetramethyl-1,3-cyclobutanediol and 20 to 35 mole % cyclohexanedimethanol; 65 to 75 mole % 2,2,4,4-tetramethyl-1,3-cyclobutanediol and 25 to 35 mole % cyclohexanedimethanol; and 65 to 70 mole % 2,2,4,4-tetramethyl-1,3-cyclobutanediol and 30 to 35 mole % cyclohexanedimethanol.

In other aspects of the invention, the glycol component for the polyesters useful in the invention include but are not limited to at least one of the following combinations of ranges: 70 to 99 mole % 2,2,4,4-tetramethyl-1,3-cyclobutanediol and 1 to 30 mole % cyclohexanedimethanol; 70 to 95 mole % 2,2,4,4-tetramethyl-1,3-cyclobutanediol and 5 to 30 mole % cyclohexanedimethanol; 70 to 90 mole % 2,2,4,4-tetramethyl-1,3-cyclobutanediol and 10 to 30 mole % cyclohexanedimethanol; 70 to 85 mole % 2,2,4,4-tetramethyl-1,3-cyclobutanediol and 15 to 30 mole % cyclohexanedimethanol; 70 to 80 mole % 2,2,4,4-tetramethyl-1,3-cyclobutanediol and 20 to 30 mole % cyclohexanedimethanol; 70 to 75 mole % 2,2,4,4-tetramethyl-1,3-cyclobutanediol and 25 to 30 mole % cyclohexanedimethanol.

In other aspects of the invention, the glycol component for the polyesters useful in the invention include but are not limited to at least one of the following combinations of ranges: 75 to 99 mole % 2,2,4,4-tetramethyl-1,3-cyclobutanediol and 1 to 25 mole % cyclohexanedimethanol; 75 to 95 mole % 2,2,4,4-tetramethyl-1,3-cyclobutanediol and 5 to 25 mole % cyclohexanedimethanol; 75 to 90 mole % 2,2,4,4-tetramethyl-1,3-cyclobutanediol and 10 to 25 mole % cyclohexanedimethanol; and 75 to 85 mole % 2,2,4,4-tetramethyl-1,3-cyclobutanediol and 15 to 25 mole % cyclohexanedimethanol.

For embodiments of the invention, the polyesters useful in the invention may exhibit at least one of the following inherent viscositiy ranges as determined in 60/40 (wt/wt) phenol/tetrachloroethane at a concentration of 0.25 g/50 ml at 25° C.: 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g 0.75 to 0.85 dL/g; 0.74 to 0.80; 0.75 to 0.80; 0.72 to 1.2 dL/g; 0.72 to 1.1 dL/g; 0.72 to 1 dL/g; 0.72 to 0.98 dL/g; 0.72 to 0.95 dL/g; 0.72 to 0.90 dL/g; 0.72 to 0.85 dL/g; 0.72 to 0.80 dL/g; 0.75 to 1.2 dL/g; 0.75 to 1.1 dL/g; 0.75 to 1 dL/g; 0.75 to 0.98 dL/g; 0.75 to 0.95 dL/g; 0.75 to 0.90 dL/g.

It is contemplated that compositions useful in the invention can possess at least one of the inherent viscosity ranges described herein and at least one of the monomer ranges for the compositions described herein unless otherwise stated. It is also contemplated that compositions useful in the invention can possess at least one of the T_{g} ranges described herein and at least one of the monomer ranges for the compositions described herein unless otherwise stated. It is also contemplated that compositions useful in the invention can possess at least one of the inherent viscosity ranges described herein, at least one of the T_{g} ranges described herein, and at least one of the monomer ranges for the compositions described herein unless otherwise stated.

In addition to cyclohexanedicarboxylic acid, the dicarboxylic acid component of the polyesters useful in the invention can comprise up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, terephthalic acid, isophthalic acid, 4,4′-biphenyidicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid. In one embodiment, the modifying aromatic dicarboxylic acid is terephthalic acid.

As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

In certain embodiments, terephthalic acid or an ester thereof, such as, for example, dimethyl terephthalate or a mixture of terephthalic acid residues and an ester thereof can make up a portion or all of the aromatic dicarboxylic acid component, if any, used to form the polyesters useful in the invention. In certain embodiments, terephthalic acid residues can make up a portion or all of the aromatic dicarboxylic acid component, if any, used to form the polyesters useful in the invention. For purposes of this disclosure, the terms “terephthalic acid” and “dimethyl terephthalate” are used interchangeably herein. In one embodiment, dimethyl terephthalate is part or all of the aromatic dicarboxylic acid component, if any, used to make the polyesters useful in the present invention.

The carboxylic acid component of the polyesters useful in the invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is equal to 100 mole %. In one embodiment, adipic acid and/or glutaric acid are provided in the modifying aliphatic dicarboxylic acid component of the invention.

Esters of dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

For the desired polyester, the molar ratio of cis/trans 2,2,4,4-tetramethyl-1,3-cyclobutanediol can vary from the pure form of each and mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30 mole % trans; or 40 to 60 mole % cis and 60 to 40 mole % trans; or 50 to 70 mole % trans and 50 to 30 mole % cis; or 50 to 70 mole % cis and 50 to 30 mole % trans; or 60 to 70 mole % cis and 30 to 40 mole % trans; or greater than 70 mole % cis and less than 30 mole % trans; wherein the total mole percentages for cis- and trans-2,2,4,4-tetramethyl-1,3-cyclobutanediol is equal to 100 mole %. In an additional embodiment, the molar ratio of cis/trans 2,2,4,4-tetramethyl-1,3-cyclobutanediol can vary within the range of 50/50 to 0/100, for example, between 40/60 to 20/80. In an additional embodiment, the molar ratio of trans/cis 2,2,4,4-tetramethyl-1,3-cyclobutanediol can vary within the range of 50/50 to 0/100, for example, between 40/60 to 20/80.

The cyclohexanedimethanol may be cis, trans, or a mixture thereof, for example, a cis/trans ratio of 60:40 to 40:60 or a cis/trans ratio of 70:30 to 30:70. In another embodiment, the trans-cyclohexanedimethanol can be present in an amount of 60 to 80 mole % and the cis-cyclohexanedimethanol can be present in an amount of 20 to 40 mole % wherein the total percentages of cis-cyclohexanedimethanol and trans-cyclohexanedimethanol is equal to 100 mole %. In particular embodiments, the trans-cyclohexanedimethanol can be present in an amount of 60 mole % and the cis-cyclohexanedimethanol can be present in an amount of 40 mole %. In particular embodiments, the trans-cyclohexanedimethanol can be present in an amount of 70 mole % and the cis-cyclohexanedimethanol can be present in an amount of 30 mole %. Any of 1,1-, 1,2-, 1,3-, 1,4-isomers of cyclohexanedimethanol or mixtures thereof may be present in the glycol component of this invention. Cis and trans isomers do not exist for 1,1-cyclohexanedimethanol.

In one embodiment, the polyesters useful in the invention comprise 1,4-cyclohexanedimethanol. In another embodiment, the polyesters useful in the invention comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

In one embodiment, the glycol component of the polyester portion of the polyester compositions useful in the invention can contain 98 mole % or less of one or more modifying glycols which are not 2,2,4,4-tetramethyl-1,3-cyclobutanediol or cyclohexanedimethanol; in one embodiment, the glycol component of the polyester portion of the polyester compositions useful in the invention can contain 25 mole % or less of one or more modifying glycols which are not 2,2,4,4-tetramethyl-1,3-cyclobutanediol or cyclohexanedimethanol or ethylene glycol; in one embodiment, the glycol component of the polyester portion of the polyester compositions useful in the invention can contain 20 mole % or less of one or more modifying glycols which are not 2,2,4,4-tetramethyl-1,3-cyclobutanediol or cyclohexanedimethanol or ethylene glycol; in one embodiment, the polyesters useful in the invention may contain less than 15 mole % or of one or more modifying glycols. In another embodiment, the polyesters useful in the invention can contain 10 mole % or less of one or more modifying glycols. In another embodiment, the polyesters useful in the invention can contain 5 mole % or less of one or more modifying glycols. In another embodiment, the polyesters useful in the invention can contain 3 mole % or less of one or more modifying glycols. In another embodiment, the polyesters useful in the invention can contain 2 mole % or less of one or more modifying glycols. In another embodiment, the polyesters useful in the invention can contain 0 mole % modifying glycols.

Modifying glycols useful in the polyesters useful in the invention refer to diols other than 2,2,4,4-tetramethyl-1,3-cyclobutanediol, and cyclohexanedimethanol and can contain 2 to 16 carbon atoms. Examples of suitable modifying glycols include, but are not limited to, ethylene glycol, diethylene glycol, 1,2-propanediol, 1,3-propanediol, neopentyl glycol, 1,4-butanediol, 1,5-pentanediol, 1,6-hexanediol, polytetramethylene glycol, polyethylene glycol, and/or mixtures thereof. In another embodiment, the modifying glycols include, but are not limited to, at least one of 1,3-propanediol and 1,4-butanediol. In one embodiment, at least one modifying glycol is diethylene glycol. In one embodiment, the diethylene glycol is not added as a separate monomer but is formed during polymerization.

The polyesters useful in the polyester compositions of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, or from 0.1 to 0.5 mole percent, based on the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

The glass transition temperature (T_{g}) of the polyesters useful in the invention was determined using a TA DSC 2920 from Thermal Analyst Instrument at a scan rate of 20° C./min.

Because of the long crystallization half-times (e.g., greater than 5 minutes) at 170° C. exhibited by certain polyesters useful in the present invention, it can be possible to produce articles, including but not limited to, injection molded parts, injection blow molded articles, injection stretch blow molded articles, extruded film, extruded sheet, extrusion blow molded articles, extrusion stretch blow molded articles, and fibers. A thermoformable sheet is an example of an article of manufacture provided by this invention.

The polyesters of the invention can be amorphous or semicrystalline. In one aspect, certain polyesters useful in the invention can have relatively low crystallinity. Certain polyesters useful in the invention can thus have a substantially amorphous morphology, meaning that the polyesters comprise substantially unordered regions of polymer.

In one embodiment, certain polyesters useful in this invention can be visually clear. The term “visually clear” is defined herein as an appreciable absence of cloudiness, haziness, and/or muddiness, when inspected visually. In another embodiment, when the polyesters are blended with polycarbonate, including but not limited to, bisphenol A polycarbonates, the blends can be visually clear.

In one embodiment, the polyesters useful in the invention and/or the polyester compositions of the invention, [in one embodiment, in the presence of and/or in the absence of toner(s)], can have color values L*, a* and b* which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate. In certain embodiments, the b* values for the polyesters useful in the invention [in one embodiment, in the presence of and/or in the absence of toner(s)] can be from −12 to less than 12 and the L* values can be from 50 to 90. In other embodiments, the b* values for the polyesters useful in the invention [in one embodiment, in the presence of and/or in the absence of toner(s)] can be present in one of the following ranges: from −10 to 10; −10 to less than 10; −10 to 9; −10 to 8; −10 to 7; −10 to 6; −10 to 5; −10 to 4; −10 to 3; −10 to 2; from −5 to 9; −5 to 8; −5 to 7; −5to 6; −5to 5; −5to 4; −5to 3; −5to 2; 0 to 9; 0 to 8; 0 to 7; 0 to 6; 0 to 5; 0 to 4; 0 to 3; 0 to 2; 1 to 10; 1 to 9; 1 to 8; 1 to 7; 1 to 6; 1 to 5; 1 to 4; 1 to 3; and 1 to 2. In other embodiments, the L* value for the polyesters useful in the invention can be present in one of the following ranges: 50 to 60; 50 to 70; 50 to 80; 50 to 90; 60 to 70; 60 to 80; 60 to 90; 70 to 80; 79 to 90.

Notched Izod impact strength, as described in ASTM D256, is a common method of measuring toughness. Notched Izod impact strength is measured herein at 23° C. with a 10-mil notch in a 3.2 mm (⅛-inch) thick bar determined according to ASTM D256. In one embodiment, certain polyesters useful in the invention can exhibit a notched Izod impact strength of at least 250 J/m (5 ft-lb/in) at 23° C. with a 10-mil notch in a 3.2 mm (⅛-inch) thick bar determined according to ASTM D256. In another embodiment certain polyesters useful in the invention can exhibit a notched Izod impact strength of at least 500 J/m (10 ft-lb/in) at 23° C. with a 10-mil notch in a 3.2 mm (⅛-inch) thick bar determined according to ASTM D256.

In one embodiment, certain polyesters useful in the invention can exhibit any density, for example, a density of from 1.05 to 1.2 g/ml at 23° C. as determined using a gradient density column at 23° C., and/or for example, a density of from 1.09 to 1.15 g/ml at 23° C. as determined using a gradient density column at 23° C.

Certain polyester(s) and/or polyester compositions of the invention have improved environmental stress cracking resistance. Generally, environmental stress cracking resistance testing according to the present invention is described in R. L. Bergen, Jr., SPE J. 667-670 (1962) entitled “Stress cracking of rigid thermoplastics”. Certain polyester(s) and/or polyester compositions of the invention can have a lipid critical strain of at least 0.6% or at least 0.7% or at least 0.8% or at least 0.9% or of greater than 0.9%. Certain polyester(s) and/or polyester compositions of the invention can have an isopropanol critical strain of at least 0.9% or at least 1.0% or of greater than 1.0%. Certain polyester(s) and/or polyester compositions of the invention can have a lipid critical strain of at least 0.9% and an isopropanol critical strain of greater than 1.0%. Lipid critical strain and/or isopropanol critical strain are measured as demonstrated by the Examples of the present invention and can be measured as described in in R. L. Bergen, Jr., SPE J. 667-670 (1962) entitled “Stress cracking of rigid thermoplastics”.

In one embodiment, the phosphorus compound(s) useful in the invention can be an organic compound such as, for example, a phosphorus acid ester containing halogenated or non-halogenated organic substituents. The phosphorus compound(s) useful in the invention can comprise a wide range of phosphorus compounds well-known in the art such as, for example, phosphines, phosphites, phosphinites, phosphonites, phosphinates, phosphonates, phosphine oxides, and phosphates.

Examples of phosphorus compounds useful in the invention can include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine.

In one embodiment, phosphorus compounds useful in the invention can be any of the previously described phosphorus-based acids wherein one or more of the hydrogen atoms of the acid compound (bonded to either oxygen or phosphorus atoms) are replaced with alkyl, branched alkyl, substituted alkyl, alkyl ethers, substituted alkyl ethers, alkyl-aryl, alkyl-substituted aryl, aryl, substituted aryl, and mixtures thereof. In another embodiment, phosphorus compounds useful in the invention, include but are not limited to, the above described compounds wherein at least one of the hydrogen atoms bonded to an oxygen atom of the compound is replaced with a metallic ion or an ammonium ion.

The esters can contain alkyl, branched alkyl, substituted alkyl, alkyl ethers, aryl, and/or substituted aryl groups. The esters can also have at least one alkyl group and at least one aryl group. The number of ester groups present in the particular phosphorus compound can vary from zero up to the maximum allowable based on the number of hydroxyl groups present on the phosphorus compound used. For example, an alkyl phosphate ester can include one or more of the mono-, di-, and tri alkyl phosphate esters; an aryl phosphate ester includes one or more of the mono-, di-, and tri aryl phosphate esters; and an alkyl phosphate ester and/or an aryl phosphate ester also include, but are not limited to, mixed alkyl aryl phosphate esters having at least one alkyl and one aryl group.

In one embodiment, the phosphorus compounds useful in the invention include but are not limited to alkyl, aryl or mixed alkyl aryl esters or partial esters of phosphoric acid, phosphorus acid, phosphinic acid, phosphonic acid, or phosphonous acid. The alkyl or aryl groups can contain one or more substituents.

In one aspect, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and mixtures thereof. The phosphate esters include esters in which the phosphoric acid is fully esterified or only partially esterified.

In one embodiment, for example, the phosphorus compounds useful in the invention can include at least one phosphate ester.

In one aspect, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, reaction products thereof, and mixtures thereof. The phosphate esters include esters in which the phosphoric acid is fully esterified or only partially esterified.

In one embodiment, for example, the phosphorus compounds useful in the invention can include at least one phosphate ester.

In another embodiment, the phosphate esters useful in the invention can include but are not limited to alkyl phosphate esters, aryl phosphate esters, mixed alkyl aryl phosphate esters, and/or mixtures thereof.

In certain embodiments, the phosphate esters useful in the invention are those where the groups on the phosphate ester include are alkyl, alkoxy-alkyl, phenyl, or substituted phenyl groups. These phosphate esters are generally referred to herein as alkyl and/or aryl phosphate esters. Certain preferred embodiments include trialkyl phosphates, triaryl phosphates, alkyl diaryl phosphates, dialkyl aryl phosphates, and mixtures of such phosphates, wherein the alkyl groups are preferably those containing from 2 to 12 carbon atoms, and the aryl groups are preferably phenyl.

Representative alkyl and branched alkyl groups are preferably those containing from 1-12 carbon atoms, including, but not limited to, ethyl, propyl, isopropyl, butyl, hexyl, cyclohexyl, 2-ethylhexyl, octyl, decyl and dodecyl. Substituted alkyl groups include, but are not limited to, those containing at least one of carboxylic acid groups and esters thereof, hydroxyl groups, amino groups, keto groups, and the like.

Representative of alkyl-aryl and substituted alkyl-aryl groups are those wherein the alkyl portion contains from 1-12 carbon atoms, and the aryl group is phenyl or substituted phenyl wherein groups such as alkyl, branched alkyl, aryl, hydroxyl, and the like are substituted for hydrogen at any carbon position on the phenyl ring. Preferred aryl groups include phenyl or substituted phenyl wherein groups such as alkyl, branched alkyl, aryl, hydroxyl and the like are substituted for hydrogen at any position on the phenyl ring.

In one embodiment, the phosphate esters useful in the invention include but are not limited to dibutylphenyl phosphate, triphenyl phosphate, tricresyl phosphate, tributyl phosphate, tri-2-ethylhexyl phosphate, trioctyl phosphate, and/or mixtures thereof, including particularly mixtures of tributyl phosphate and tricresyl phosphate, and mixtures of isocetyl diphenyl phosphate and 2-ethylhexyl diphenyl phosphate.

In one embodiment, at least one phosphorus compound useful in the invention comprises at least one aryl phosphate ester.

In one embodiment, at least one phosphorus compound useful in the invention comprises at least one unsubstituted aryl phosphate ester.

In one aspect, at least one phosphorus compound useful in the invention comprises at least one aryl phosphate ester which is not substituted with benzyl groups.

In one aspect, any of the phosphorus compounds useful in the invention may comprise at least one alkyl phosphate ester.

In one embodiment, the phosphate esters useful in the invention as thermal stabilizers and/or color stabilizers include but are not limited to, at least one of the following: trialkyl phosphates, triaryl phosphates, alkyl diaryl phosphates, and mixed alkyl aryl phosphates.

In one embodiment, the phosphate esters useful in the invention as thermal stabilizers and/or color stabilizers include but are not limited to, at least one of the following: triaryl phosphates, alkyl diaryl phosphates, and mixed alkyl aryl phosphates.

In one embodiment, the phosphate esters useful as thermal stabilizers and/or color stabilizers in the invention can include but are not limited to, at least one of the following: triaryl phosphates and mixed alkyl aryl phosphates.

In one embodiment, at least one phosphorus compound useful in the invention can comprise, but is not limited to, triaryl phosphates, such as, for example, triphenyl phosphate. In one embodiment, at least one one thermal stabilizer comprises, but is not limited to Merpol A. In one embodiment, at least one thermal stabilizer useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

In one aspect, any of the phosphorus compounds useful in the invention may comprise at least one triaryl phosphate ester which is not substituted with benzyl groups.

In one embodiment, the polyester compositions and/or processes of the invention may comprise 2-ethylhexyl diphenyl phosphate.

In one embodiment, any of the processes described herein for making any of the polyester compositions and/or polyesters can comprise at least one mixed alkyl aryl phosphite, such as, for example, bis(2,4-dicumylphenyl)pentaerythritol diphosphite also known as Doverphos S-9228 (Dover Chemicals, CAS#154862-43-8).

In one embodiment, any of the processes described herein for making any of the polyester compositions and/or polyesters can comprise at least one one phosphine oxide.

In one embodiment, any of the processes described herein for making any of the polyester compositions and/or polyesters can comprise at least one salt of phosphoric acid such as, for example, KH₂PO₄ and Zn₃(PO₄)₂.

When phosphorus is added to the polyesters and/or polyester compositions and/or process of making the polyesters of the invention, it is added in the form of a phosphorus compound, for example, at least one phosphate ester(s). The amount of phosphorus compound(s), (for example, at least one phosphate ester), is added to the polyesters of the invention and/or polyester compositions of the invention and/or processes of the invention can be measured in the form of phosphorus atoms present in the final polyester, for example, by weight measured in ppm.

Amounts of phosphorus compound(s) added during polymerization and/or post manufacturing can include but are not limited to: 1 to 5000 ppm; 1 to 1000 ppm, 1 to 900 ppm, 1 to 800 ppm, 1 to 700 ppm. 1 to 600 ppm, 1 to 500 ppm, 1 to 400 ppm, 1 to 350 ppm, 1 to 300 ppm, 1 to 250 ppm, 1 to 200 ppm, 1 to 150 ppm, 1 to 100 ppm;10 to 5000 ppm; 10 to 1000 ppm, 10 to 900 ppm, 10 to 800 ppm, 10 to 700 ppm. 10 to 600 ppm, 10 to 500 ppm, 10 to 400 ppm, 10 to 350 ppm, 10 to 300 ppm, 10 to 250 ppm, 10 to 200 ppm, 10 to 150 ppm, 10 to 100 ppm; based on the total weight of the polyester composition.

In one embodiment, suitable catalysts for use in the processes of the invention to make the polyesters useful in the invention can include at least one titanium compound. The polyester compositions of the invention may also comprise at least one of the titanium compounds useful in the processes of the invention.

Catalysts other than tin and titanium useful in making the polyesters useful in the invention may include, but are not limited to, those based on gallium, zinc, antimony, cobalt, manganese, magnesium, germanium, lithium, aluminum compounds, and an aluminum compound with lithium hydroxide or sodium hydroxide. In one embodiment, the catalyst can be a combination of at least one tin compound and at least one titanium compound.

Catalyst amounts can range from 10 ppm to 20,000 ppm or 10 to 10,000 ppm, or 10 to 5000 ppm or 10 to 1000 ppm or 10 to 500 ppm, or 10 to 300 ppm or 10 to 250 ppm based on the catalyst metal and based on the weight of the final polymer. The process can be carried out in either a batch or continuous process. In one embodiment, the process is carried out in a continuous process.

In another embodiment, the polyesters of the invention can be prepared using at least one tin compound in addition to the titanium compound as catalyst(s).

Tin catalysts and titanium catalysts may be used singly or in combination.

For example, see U.S. Pat. No. 2,720,507, where the portion concerning tin catalysts is incorporated herein by reference. These catalysts are tin compounds containing at least one organic radical. These catalysts include compounds of both divalent or tetravalent tin which have the general formulas set forth below:

M₂(Sn(OR)₄) A.

MH(Sn(OR)₄) B.

M′(Sn(OR)₄) C.

M′(HSn(OR)₄)₂ D.

M₂(Sn(OR)₆) E.

MH(Sn(OR)₆) F.

M′(Sn(OR)₆) G.

M′(HSn(OR)₆)₂ H.

Sn(OR)₂ I.

Sn(OR)₄ J.

SnR′₂ K.

SnR′₄ L.

R′₂SnO M.

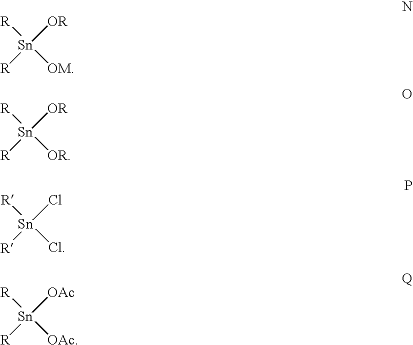

wherein M is an alkali metal, e.g. lithium, sodium, or potassium, M′ is an alkaline earth metal such as Mg, Ca or Sr, each R represents an alkyl radical containing from 1 to 8 carbon atoms, each R′ radical represents a substituent selected from those consisting of alkyl radicals containing from 1 to 8 carbon atoms (i. e. R radicals) and aryl radicals of the benzene series containing from 6 to 9 carbon atoms (e.g. phenyl, tolyl, benzyl, phenylethyl, etc., radicals), and Ac represents an acyl radical derived from an organic acid containing from 2 to 18 carbon atoms (e.g. acetyl, butyryl, lauroyl, benzoyl, stearoyl, etc.).

The novel bimetallic alkoxide catalysts can be made as described by Meerwein, Ann. 476, 113 (1929). As shown by Meerwein, these catalysts are not merely mixtures of the two metallic alkoxides. They are definite compounds having a salt-like structure. These are the compounds depicted above by the Formulas A through H. Those not specifically described by Meerwein can be prepared by procedures analogous to the working examples and methods set forth by Meerwein.

The other tin compounds can also be made by various methods such as those described in U.S. Pat. No. 5,239,020, in addition to the following literature: For the preparation of diaryl tin dihalides (Formula P) see Ber. 62, 996 (1929); J. Am. Chem. Soc. 49, 1369 (1927). For the preparation of dialkyl tin dihalides (Formula P) see J. Am. Chem. Soc. 47, 2568 (1925); C.A. 41, 90 (1947). For the preparation of diaryl tin oxides (Formula M) see J. Am. Chem. Soc. 48, 1054 (1926). For the preparation of tetraaryl tin compounds (Formula K) see C.A. 32, 5387 (1938). For the preparation of tin alkoxides (Formula J) see C.A. 24, 586 (1930). For the preparation of alkyl tin salts (Formula Q) see C.A. 31, 4290. For the preparation of alkyl tin compounds (Formula K and L) see C.A. 35, 2470 (1941): C.A. 33, 5357 (1939). For the preparation of mixed alkyl aryl tin (Formulas K and L) see C.A. 31, 4290 (1937): C.A. 38, 331 (1944). For the preparation of other tin compounds not covered by these citations see “Die Chemie der Metal-Organischen Verbindungen.” by Krause and V. Grosse, published in Berlin, 1937, by Gebroder-Borntrager.

The tin alkoxides (Formulas I and J) and the bimetallic alkoxides (Formulas A through H) contain R substituents which can represent both straight chain and branched chain alkyl radicals, e.g. diethoxide, tetramethoxide, tetrabutoxide, tetra-tert-butoxide, tetrahexoxide, etc.

The alkyl derivatives (Formulas K and L) contain one or more alkyl radicals attached to a tin atom through a direct C—Sn linkage, e.g. dibutyl tin, dihexyl tin, tetra-butyl tin, tetraethyl tin, tetramethyl tin, dioctyl tin, etc. Two of the tetraalkyl radicals can be replaced with an oxygen atom to form compounds having Formula M, e.g. dimethyl tin oxide, diethyl tin oxide, dibutyl tin oxide, diheptyl tin oxide, etc. In one embodiment, the tin catalyst comprises dimethyl tin oxide.

Complexes can be formed by reacting dialkyl tin oxides with alkali metal alkoxides in an alcohol solution to form compounds having Formula N, which compounds are especially useful catalysts, e.g. react dibutyl tin oxide with sodium ethoxide, etc. This formula is intended to represent the reaction products described. Tin compounds containing alkyl and alkoxy radicals are also useful catalysts (see Formula O), e.g. diethyl tin diethoxide, dibutyl tin dibutoxide, dihexyl tin dimethoxide, etc.

Salts derived from dialkyl tin oxides reacted with carboxylic acids or hydrochloric acid are also of particular value as catalysts; see Formulas P and Q. Examples of these catalytic condensing agents include dibutyl tin diacetate, diethyl tin dibutyrate, dibutyl tin dilauroate, dimethyl tin dibenzoate, dibutyl tin dichloride, diethyl tin dichloride, dioctyl tin dichloride, dihexyl tin distearate, etc.

The tin compounds having Formulas K, L and M can be prepared wherein one or more of the R′ radicals represents an aryl radical of the benzene series, e.g. phenyl, tolyl, benzyl, etc. Examples include diphenyl tin, tetraphenyl tin, diphenyl dibutyl tin, ditolyl diethyl tin, diphenyl tin oxide, dibenzyl tin, tetrabenzyl tin, di([B-phenylethyl) tin oxide, dibenzyl tin oxide, etc.

Examples of catalysts useful in the present invention include, but are not limited to, one of more of the following: butyltin tris-2-ethylhexanoate, dibutyltin diacetate, dibutyltin oxide, and dimethyl tin oxide.

In one embodiment, catalysts useful in the present invention include, but are not limited to, one or more of the following: butyltin tris-2-ethylhexanoate, dibutyltin diacetate, dibutyltin oxide, and dimethyl tin oxide.

Processes for preparing polyesters using tin-based catalysts are well known and described in the aforementioned U.S. Pat. No. 2,720,507.

The polyester portion of the polyester compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the glycol in the presence of the tin catalysts and/or titanium catalysts described herein at elevated temperatures increased gradually during the course of the condensation up to a temperature of about 225°-310° C., in an inert atmosphere, and conducting the condensation at low pressure during the latter part of the condensation, as described in further detail in U.S. Pat. No. 2,720,507 incorporated herein by reference.

In another aspect, this invention relates to a process for preparing copolyesters of the invention. In one embodiment, the process relates to preparing copolyesters comprising cyclohexanedicarboxylic acid, 2,2,4,4-tetramethyl-1,3-cyclobutanediol, and cyclohexanedimethanol. This process comprises the steps of:
(A) heating a mixture comprising the monomers useful in the polyesters of the invention in the presence of at least one tin catalyst at a temperature of 150 to 250° C. for a time sufficient to produce an initial polyester;
(B) polycondensing the product of Step (A) by heating it at a temperature of 230 to 320° C. for 1 to 12 hours; and
(C) removing any unreacted glycols.

Reaction times for the esterification Step (A) are dependent upon the selected temperatures, pressures, and feed mole ratios of glycol to dicarboxylic acid.

In one embodiment, step (A) can be carried out until 50% by weight or more of the 2,2,4,4-tetramethyl-1,3-cyclobutanediol has been reacted. Step (A) may be carried out under pressure, ranging from 0 psig to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, Step (B) and Step (C) can be conducted at the same time. These steps can be carried out by methods known in the art such as by placing the reaction mixture under a pressure ranging, from 0.002 psig to below atmospheric pressure, or by blowing hot nitrogen gas over the mixture.

The polyesters of the present invention are prepared by procedures known to persons skilled in the art. The reaction of the diol and dicarboxylic acid may be carried out using conventional polyester polymerization conditions or by melt phase processes, but those with sufficient crystallinity may be made by melt phase followed by solid phase polycondensation techniques. Stirring or appropriate conditions are used in both stages to ensure adequate heat transfer and surface renewal of the reaction mixture.

To ensure that the reaction of the diol component and dicarboxylic acid component by an ester interchange reaction is driven to completion, it is sometimes desirable to employ about 1.0 to about 1.5 moles of diol component to one mole dicarboxylic acid component. To ensure that the reaction of the diol component and dicarboxylic acid component by an ester interchange reaction is driven to completion, it is sometimes desirable to employ about 0.9 to about 1.5 moles of diol component to one mole dicarboxylic acid component. Persons of skill in the art will understand, however, that the ratio of diol component to dicarboxylic acid component can be generally determined by the design of the reactor in which the reaction process occurs.

In one embodiment, the invention comprises a process for making any of the polyesters useful in the invention comprising the following steps:
(I) heating a mixture at at least one temperature chosen from 150° C. to 250° C., under at least one pressure chosen from the range of 0 psig to 50 psig wherein said mixture comprises:
   (A) a dicarboxylic acid component comprising:
      i) 70 to 100 mole % of cyclohexanedicarboxylic acid residues or an ester thereof comprising:
         (a) 70 to 98 mole % trans-cyclohexanedicarboxylic acid residues or an ester thereof; and
         (b) 2 to 30 mole % cis-cyclohexanedicarboxylic acid residues or an ester thereof;
      ii) 0 to 30 mole % of aliphatic dicarboxylic acid residues, other than cyclohexanedicarboxylic acid residues, having up to 16 carbon atoms or esters thereof; and
      iii) 0 to 10 mole % of aromatic dicarboxylic acid residues having up to 20 carbon atoms; and
   (B) a glycol component comprising:
      i) 1 to 99 mole % of 2,2,4,4-tetramethyl-1,3-cyclobutanediol residues; and
      ii) 1 to 99 mole % of cyclohexanedimethanol residues;
   wherein the total mole % of said dicarboxylic acid component is equal to 100 mole %; and
   wherein the molar ratio of glycol component/dicarboxylic acid component added in Step (I) is 1.0-1.5/1.0; wherein the mixture in Step (I) is heated in the presence of: (i) at least one catalyst comprising at least one tin compound, and, optionally, at least one catalyst chosen from titanium, gallium, zinc, antimony, cobalt, manganese, magnesium, germanium, lithium, aluminum compounds and an aluminum compound with lithium hydroxide or sodium hydroxide; and (ii) optionally, at least one thermal stabilizer chosen from at least one phosphate ester as described herein, reaction products thereof, and mixtures thereof;
(II) heating the product of Step (I) at a temperature of 230° C. to 320° C. for 1 to 12 hours, under at least one pressure chosen from the range of the final pressure of Step (I) to 0.02 torr absolute, to form a final polyester;
   the total mole % of said glycol component is equal to 100 mole %;
   wherein the inherent viscosity of said polyester is from 0.35 to 1.2 dL/g as determined in 60/40 (wt/wt) phenol/tetrachloroethane at a concentration of 0.5 g/100 ml at 25° C.; and wherein said polyester has a T_{g} of from 60 to 155° C.

In one embodiment, the invention comprises a process for making any of the polyesters useful in the invention comprising the following steps:
(I) heating a mixture at at least one temperature chosen from 150° C. to 250° C., under at least one pressure chosen from the range of 0 psig to 50 psig wherein said mixture comprises:
   (A) a dicarboxylic acid component comprising:
      i) 70 to 100 mole % of cyclohexanedicarboxylic acid residues or an ester thereof comprising:
         (a) 70 to 98 mole % trans-cyclohexanedicarboxylic acid residues or an ester thereof; and
         (b) 2 to 30 mole % cis-cyclohexanedicarboxylic acid residues or an ester thereof;
      ii) 0 to 30 mole % of aliphatic dicarboxylic acid residues, other than cyclohexanedicarboxylic acid residues, having up to 16 carbon atoms or esters thereof; and
      iii) 0 to 10 mole % of aromatic dicarboxylic acid residues having up to 20 carbon atoms; and
   (B) a glycol component comprising:
      i) 1 to 99 mole % of 2,2,4,4-tetramethyl-1,3-cyclobutanediol residues; and
      ii) 1 to 99 mole % of cyclohexanedimethanol residues;
   wherein the total mole % of said dicarboxylic acid component is equal to 100 mole %; and
   wherein the molar ratio of glycol component/dicarboxylic acid component added in Step (I) is 0.9-1.5/1; wherein the mixture in Step (I) is heated in the presence of: (i) at least one catalyst comprising at least one tin compound, and, optionally, at least one catalyst chosen from titanium, gallium, zinc, antimony, cobalt, manganese, magnesium, germanium, lithium, aluminum compounds and an aluminum compound with lithium hydroxide or sodium hydroxide; and (ii) optionally, at least one thermal stabilizer chosen from at least one phosphate ester as described herein, reaction products thereof, and mixtures thereof;
(II) heating the product of Step (I) at a temperature of 230° C. to 320° C. for 1 to 12 hours, under at least one pressure chosen from the range of the final pressure of Step (I) to 0.02 torr absolute, to form a final polyester;
   the total mole % of said glycol component is equal to 100 mole %;
   wherein the inherent viscosity of said polyester is from 0.35 to 1.2 dL/g as determined in 60/40 (wt/wt) phenol/tetrachloroethane at a concentration of 0.5 g/100 ml at 25° C.; and wherein said polyester has a Tg of from 60 to 155° C.

In one embodiment, the pressure and times used in Step (II) can be staged as follows: 1 to 60 minutes at 300 to 100 torr; 1 to 60 minutes at 99 to 20 torr; 1 to 60 minutes at 19 to 3 torr; up to 12 hours at 0.02 to 3 torr.

In another embodiment, the pressures in Step (II) can be ramped down from 300 to 3 torr over 3 minutes to 180 minutes followed by up to 12 hours at 0.02 to 3 torr.

It is believed that any of the processes of making the polyesters useful in the invention may be used to make any of the polyesters useful in the invention.

Reaction times for the esterification Step (I) of any of the processes of the invention are dependent upon the selected temperatures, pressures, and feed mole ratios of glycol to dicarboxylic acid.

In any of the process embodiments for making the polyesters useful in the invention, the heating time of Step (II) may be from 1 to 6 hours or 1 to 5 hours.

In one aspect, the polyesters, polyester compositions and/or processes of the invention useful in the invention can comprise phosphorus atoms.

In one aspect, the polyesters, polyester compositions and/or processes of the invention useful in the invention can comprise tin atoms.

In one aspect, the polyesters and/or polyester compositions and/or processes useful in the invention can comprise titanium atoms and tin atoms.

In one embodiment, any of the polyester(s), polyester compositions and/or processes of the invention may comprise at least one phosphorus compound.

In one embodiment, any of the polyester(s), polyester compositions and/or processes of the invention may comprise at least one tin compound.

In one embodiment, any of the polyester(s), polyester compositions and/or processes of the invention may comprise at least one titanium compound.

In one embodiment, any of the polyester(s), polyester compositions and/or processes of the invention may comprise at least one titanium compound and at least one phosphorus compound.

In one embodiment, any of the polyester(s), polyester compositions and/or processes of making the polyesters useful in the invention may comprise at least one tin compound and at least one titanium compound.

In one embodiment, any of the polyester(s), polyester compositions and/or processes of making the polyesters useful in the invention may comprise at least one tin compound, at least one titanium compound, and at least one phosphorus compound.

In one embodiment, the amount of tin atoms in the polyesters useful in the invention can be from 0 to 600 ppm tin atoms based on the weight of the final polyester.

In one embodiment, the amount of tin atoms in the polyesters useful in the invention can be from 50 to 600 ppm tin atoms based on the weight of the final polyester.

In one embodiment, the amount of tin atoms in the polyesters useful in the invention can be from 50 to 400 ppm tin atoms based on the weight of the final polyester.

In one embodiment, the amount of titanium atoms in the polyesters useful in the invention can be from 0 to 100 ppm titanium atoms based on the weight of the final polyester.

The invention further relates to the polyester compositions made by the process(es) described above.

The invention further relates to a polymer blend. The blend comprises:
(a) from 5 to 95 weight % of at least one of the polyesters described above; and
(b) from 5 to 95 weight % of at least one of the polymeric components.

Suitable examples of the polymeric components include, but are not limited to, nylon; polyesters different than those described herein; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers. The blends can be prepared by conventional processing techniques known in the art, such as melt blending or solution blending. In one embodiment, polycarbonate is not present in the polyester composition. If polycarbonate is used in a blend in the polyester compositions of the invention, the blends can be visually clear. However, polyester compositions useful in the invention also contemplate the exclusion of polycarbonate as well as the inclusion of polycarbonate.

Polycarbonates useful in the invention may be prepared according to known procedures, for example, by reacting the dihydroxyaromatic compound with a carbonate precursor such as phosgene, a haloformate or a carbonate ester, a molecular weight regulator, an acid acceptor and a catalyst. Methods for preparing polycarbonates are known in the art and are described, for example, in U.S. Pat. No. 4,452,933, where the disclosure regarding the preparation of polycarbonates is hereby incorporated by reference herein.

Examples of suitable carbonate precursors include, but are not limited to, carbonyl bromide, carbonyl chloride, and mixtures thereof; diphenyl carbonate; a di(halophenyl)carbonate, e.g., di(trichlorophenyl)carbonate, di(tribromophenyl)carbonate, and the like; di(alkylphenyl)carbonate, e.g., di(tolyl)carbonate; di(naphthyl)carbonate; di(chloronaphthyl)carbonate, and mixtures thereof; and bis-haloformates of dihydric phenols.

Examples of suitable molecular weight regulators include, but are not limited to, phenol, cyclohexanol, methanol, alkylated phenols, such as octylphenol, para-tertiary-butyl-phenol, and the like. In one embodiment, the molecular weight regulator is phenol or an alkylated phenol.

The acid acceptor may be either an organic or an inorganic acid acceptor. A suitable organic acid acceptor can be a tertiary amine and includes, but is not limited to, such materials as pyridine, triethylamine, dimethylaniline, tributylamine, and the like. The inorganic acid acceptor can be either a hydroxide, a carbonate, a bicarbonate, or a phosphate of an alkali or alkaline earth metal.

The catalysts used in making the polycarbonates useful in the invention that can be used include, but are not limited to, those that typically aid the polymerization of the monomer with phosgene. Suitable catalysts include, but are not limited to, tertiary amines such as triethylamine, tripropylamine, N,N-dimethylaniline, quaternary ammonium compounds such as, for example, tetraethylammonium bromide, cetyl triethyl ammonium bromide, tetra-n-heptylammonium iodide, tetra-n-propyl ammonium bromide, tetramethyl ammonium chloride, tetra-methyl ammonium hydroxide, tetra-n-butyl ammonium iodide, benzyltrimethyl ammonium chloride and quaternary phosphonium compounds such as, for example, n-butyltriphenyl phosphonium bromide and methyltriphenyl phosphonium bromide.

The polycarbonates useful in the polyester blends of the invention also may be copolyestercarbonates such as those described in U.S. Pat. Nos. 3,169,121; 3,207,814; 4,194,038; 4,156,069; 4,430,484, 4,465,820, and 4,981,898, where the disclosure regarding copolyestercarbonates from each of the U.S. patents is incorporated by reference herein.

Copolyestercarbonates useful in this invention can be available commercially and/or may be prepared by known methods in the art. For example, they can be typically obtained by the reaction of at least one dihydroxyaromatic compound with a mixture of phosgene and at least one dicarboxylic acid chloride, especially isophthaloyl chloride, terephthaloyl chloride, or both.

In addition, the polyester compositions and the polymer blends of the invention may also contain common additives such as colorants, toner(s), dyes, mold release agents, flame retardants, plasticizers, nucleating agents, stabilizers, and antioxidants, including but not limited to, UV stabilizers, thermal stabilizers other than the phosphorus compounds describe herein, and/or reaction products thereof, fillers, and impact modifiers. In one embodiment, the polyester compositions and the polymer blends can contain from 0.01 to 25% by weight of one or more of these additives. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

In addition, certain agents which colorize the polymer can be added to the melt. In one embodiment, a bluing toner is added to the melt in order to reduce the b* of the resulting polyester polymer melt phase product. Such bluing agents include blue inorganic and organic toner(s). In addition, red toner(s) can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added depends, of course, on the amount of inherent yellow color in the base polyester and the efficacy of the toner. Generally, in one embodiment, a concentration of up to about 15 ppm of combined organic toner components and a minimum concentration of about 0.5 ppm can be used. The total amount of bluing additive typically ranges from 0.5 to 10 ppm.

The toner(s) can be added to the esterification zone or to the polycondensation zone. Preferably, the toner(s) are added to the esterification zone or to the early stages of the polycondensation zone, such as to a prepolymerization reactor

The aliphatic polyester composition of the invention also can comprise at least one hindered amine light stabilizer, abbreviated herein as “HALS”. Many of the HALS of the present invention are known compounds and some are commercially available. The HALS can include their salts, N-oxides and N-hydroxides. In general, the HALS can be described as having an amino nitrogen contained in a carbon-nitrogen-carbon chain which forms part of a non-aromatic heterocyclic ring where each of the two carbon atoms of the chain is bonded to two lower alkyl groups which may be the same or different, each lower alkyl group containing from 1 to 22 carbon atoms, or to an alicyclic group containing from 3 to 8 carbon atoms, which sterically hinder the amine.

For example, in one embodiment of the invention, the HALS can comprise 2,2,6,6-tetraalkylpiperidines, their acid addition salts or complexes with metal compounds. Examples of hindered amine light stabilizers which can be used in the instant invention are represented by formulas (1-4):

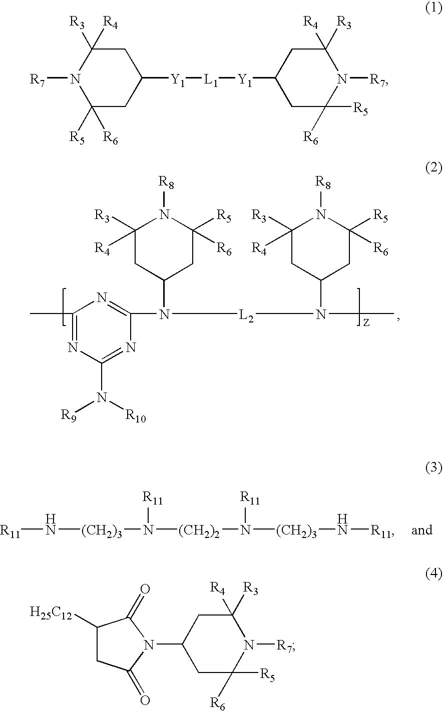

wherein
R₃, R₄, R₅ and R₆ are C₁-C₂₂ alkyl;
R₇ and R₈ are independently selected from hydrogen, C₁-C₂₂ alkyl, and C₁-C₂₂ alkoxy;
Y₁ is —O—;
L₁ is the divalent linking group —C(O)-L₂-C(O)—;
L₂ is C₁-C₂₂ alkylene;
R₉ and R₁₀ are independently selected from hydrogen, C₁-C₂₂ alkyl, C₃-C₈ cycloalkyl, and substituted C₃-C₈ cycloalkyl, or R₉ and R₁₀ collectively may represent a divalent group forming a morpholine and/or a piperidine ring;
Z is a positive integer of up to 20;
R₁₁ is selected from hydrogen, C₁-C₂₂ alkyl, substituted C₁-C₂₂ alkyl, and radical
A, wherein radical A has the following structure:

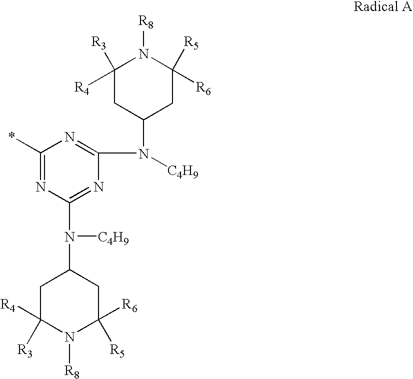

wherein * designates the position of attachment.

The term “C₁-C₂₂ alkyl” denotes a saturated hydrocarbon radical which contains one to twenty-two carbons and which may be straight or branched-chain. Such C₁-C₂₂ alkyl groups can be, for example, methyl, ethyl, propyl, butyl, pentyl, hexyl, heptyl, octyl, isopropyl, isobutyl, tertbutyl, neopentyl, 2-ethylheptyl, 2-ethylhexyl, and the like. The term “substituted C₁-C₂₂ alkyl” refers to C₁-C₂₂ alkyl radicals as described above which may be substituted with one or more substituents selected from hydroxy, halogen, cyano, aryl, heteroaryl, C₃-C₈-cycloalkyl, substituted C₃-C₈cycloalkyl, C₁-C₆alkoxy, C₂-C₆ alkanoyloxy and the like.

The term “C₃-C₈ cycloalkyl” is used to denote a cycloaliphatic hydrocarbon radical containing three to eight carbon atoms. The term “substituted C₃-C₈ cycloalkyl” is used to describe a C₃-C₈ cycloalkyl radical as detailed above containing at least one group selected from C₁-C₆ alkyl, C₁-C₆ alkoxy, hydroxy, halogen, and the like.

The term “aryl” is used to denote an aromatic radical containing 6, 10 or 14 carbon atoms in the conjugated aromatic ring structure and these radicals substituted with one or more groups selected from C₁-C₆ alkyl; C₁-C₆ alkoxy; phenyl, and phenyl substituted with C₁-C₆ alkyl; C₁-C₆ alkoxy; halogen and the like; C₃-C₈ cycloalkyl; halogen; hydroxy, cyano, trifluoromethyl and the like. Typical aryl groups include phenyl, naphthyl, phenylnaphthyl, anthryl (anthracenyl) and the like. The term “heteroaryl” is used to describe conjugated cyclic radicals containing at least one hetero atom selected from sulfur, oxygen, nitrogen or a combination of these in combination with from two to about ten carbon atoms and these heteroaryl radicals substituted with the groups mentioned above as possible substituents on the aryl radical. Typical heteroaryl radicals include: 2- and 3-furyl, 2- and 3-thienyl, 2- and 3-pyrrolyl, 2-, 3-, and 4-pyridyl, benzothiophen-2-yl; benzothiazol-2-yl, benzoxazol-2-yl, benzimidazol-2-yl, 1,3,4-oxadiazol-2-yl, 1,3,4-thiadiazol-2-yl, 1,2,4-thiadiazol-5-yl, isothiazol-5-yl, imidazol-2-yl, quinolyl and the like.

The terms “C₁-C₆ alkoxy” is used to represent the groups —O—C₁-C₆ alkyl, wherein “C₁-C₆ alkyl” denotes a saturated hydrocarbon that contains 1-6 carbon atoms, which may be straight or branched-chain, and which may be further substituted with one or more groups selected from halogen, methoxy, ethoxy, phenyl, hydroxy, acetyloxy and propionyloxy. The term “halogen” is used to represent fluorine, chlorine, bromine, and iodine; however, chlorine and bromine are preferred.

In one embodiment, the polyester composition of the invention will comprise about 0.05 to about 2 weight percent of at least one HALS or, more typically, about 0.1 to about 1 weight percent. Additional examples of HALS are compounds having formula (1), wherein R₃, R₄, R₅, and R₆ are methyl; R₇ is methyl, C₈H₁₇O—, or hydrogen; and L₂ is C₈ alkylene.

In another embodiment, the HALS may be represented by formula (1) above wherein R₃, R₄, R₅, and R₆ are methyl, R₇ is hydrogen, and L₂ is C₈ alkylene. In another example, R₃, R₄, R₅, and R₆ are methyl, R₇ is an octyloxy radical, C₈H₁₇O—, and L₂ is C₈ alkylene. In yet another example, R₃, R₄, R₅, R₆ and R₇ are methyl, and L₂ is C₈ alkylene. Additional examples of HALS are compounds can be represented by formula (2), wherein R₃, R₄, R₅, and R₆ are methyl groups; R₈ is a methyl group or hydrogen; (R₉)N(R₁₀) collectively represents a morpholino group; and L₂ is C₆ alkylene or, in another example, R₃, R₄, R₅, and R₆ are methyl groups; R₈ and R₉ are hydrogen; R₁₀ is 2,4,4-trimethyl-2-pentyl; and L₂ is C₆ alkylene. In yet another embodiment, the HALS can comprise at least one compound having formula (3), in which R₁₁ is radical A; and R₃, R₄, R₅, R₆, and R₈ each are methyl. In still another example, the HALS can comprise a compound having formula (4), in which R₃, R₄, R₅, and R₆ each are methyl and R₇ is hydrogen or methyl.

These compounds are known in the art and some are commercially available such as, for example under the trade designations CYASORB™ UV-3529 (Cytec Industries, CAS#193098-40-7, represented by formula (2) wherein R₃, R₄, R₅, R₆, and R₈ are methyl, (R₉)N(R₁₀) collectively represents a morpholino group, and L₂ is C₆ alkylene), CYASORB™ UV-3346 (Cytec Industries, CAS#90751-07-8), represented by formula (2) wherein R₃, R₄, R₅, R₆ are methyl and R₈ is hydrogen, (R₉)N(R₁₀) collectively represents a morpholino group, and L₂ is C₆ alkylene), TINUVIN™ 770 (Ciba Specialty Chemicals, CAS#52829-07-9, represented by formula (1) wherein R₃, R₄, R₅, and R₆ are methyl, R₇ is hydrogen, and L₂ is C₈ alkylene), TINUVIN™ 123 (Ciba Specialty Chemicals, CAS#129757-67-1, represented by formula (1) wherein R₃, R₄, R₅, and R₆ are methyl, R₇ is —OC₈H₁₇, and L₂ is C₈ alkylene), CHIMASSORB™ 119 (Ciba Specialty Chemicals, CAS#106990-43-6, represented by formula (3), wherein R₃, R₄, R₅, R₆, and R₈ are methyl, and R₁₁ is radical A), LOWILITE 76 (Great Lakes Chemical Corp., CAS#41556-26-7, represented by formula (1) wherein R₃, R₄, R₅, R₆, and R₇ are methyl and L₂ is C₈ alkylene), and CYASORB™ UV-3581 (Cytec Industries, CAS#193098-40-7, represented by formula (4) wherein R₃, R₄, R₅, and R₆ are methyl and R₇ is hydrogen). Additional preferred hindered amine light stabilizer may be found in the Plastic Additives Handbook, 5th Edition (Hanser Gardner Publications, Inc., Cincinnati, Ohio, USA, 2001).

Ultraviolet light absorbers (UVAs) can also be included in the polyester compositions of the invention. In one embodiment, the term “ultraviolet light absorber” is defined as one compound or a mixture of compounds that absorb light in the range of 290-400 nm with a minimal absorbance between 400 and 700 nm, and that improves the weatherability of the polymer compositions. In accordance with the present invention, the aliphatic polyesters of the present invention can have blended therein at least one UVA selected from triazines, cyanoacrylates, benzotriazoles, naphthalenes, and benzoxazinones and mixtures thereof. Such materials are described in greater detail in U.S. Pat. Nos. 6,352,783, 5,480,926 and 5,783,307, and United States Publication 2006/0111481 published on May 25, 2006.

In general, the UVAs useful for blending can be represented by the formula:

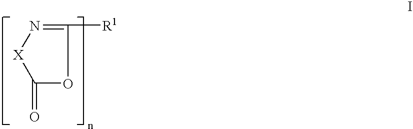

wherein X represents a divalent aromatic residue in which the two bonds from X are at the 1- and 2-positions; n is 1, 2 or 3; and R¹ represents a hydrocarbon residue having a valence of n which may further contain a hetero atom, or R¹ may be a direct bond when n is 2, in the unreacted state.

In general formula (I), X is a divalent aromatic residue in which two bonds from X are at the 1- and 2-positions; n is 2, and R¹ is a hydrocarbon residue having a valence of n which may further contain a hetero atom, or R¹ may be a direct bond.

Preferred examples of X include 1,2-phenylene, 1,2-naphthylene, 2,3-naphthylene, and groups represented by formulas (a) and (b), wherein formula (a) is:

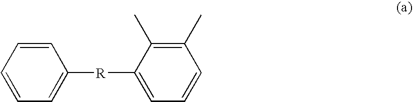

and formula b is

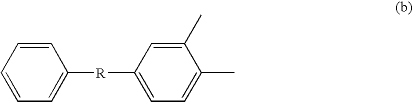

wherein R for formulas (a) and (b) is —O—, —CO—, —S—, —SO₂—, —CH₂—, —(CH₂)₂ or —C(CH₃)₂—.

In one embodiment, 1,2-phenylene is preferred.

The aromatic residue for X exemplified above may be substituted by substituents, for example, alkyl groups having 1 to 10 carbon atoms, such as methyl, ethyl, propyl, hexyl and decyl; aryl groups 6 to 12 carbon atoms such as phenyl and naphthyl; cycloalkyl groups having 5 to 12 carbon atoms such as cyclopentyl and cyclohexyl; aralkyl groups having 8 to 20 carbon atoms such as phenethyl; alkoxy groups having 1 to 10 carbon atoms such as methoxy, ethoxy and decyloxy; nitro; halogens such as chlorine and bromine; and acyl groups having 2 to 10 carbon atoms such as acetyl, propionyl, benzoyl and decanoyl.

R¹ is a hydrocarbon residue having a valence of n=2 or it may be a direct bond.

The divalent hydrocarbon residue (n=2) firstly includes, for example, unsubstituted aliphatic residues having 2 to 10 carbon atoms, unsubstituted aromatic residues having 6 to 12 carbon atoms, and unsubstituted alicyclic residues having 5 to 12 carbon atoms. Examples of the unsubstituted aliphatic residues having 2 to 10 carbon atoms are ethylene, trimethylene, tetramethylene and decamethylene. Examples of the unsubstituted aromatic residues having 6 to 12 carbon atoms are phenylene, naphthylene and p,p′-biphenylene. Examples of the unsubstituted alicyclic residues having 5 to 12 carbon atoms include cyclopentene and cyclohexylene.

Secondly, examples of the divalent hydrocarbon residue include groups represented by the following formula (c)

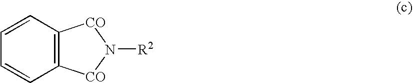

wherein R² is any one of the groups of formulae (d)-(h) defined below:

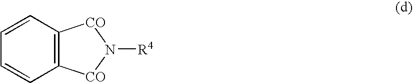

wherein R⁴ represents an alkylene of 2 to 10 carbon atoms, phenylene or naphthylene;

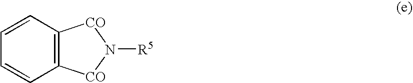

wherein R⁵ represents an alkyl having 1 to 10 carbon atoms, a phenyl or a naphthyl;

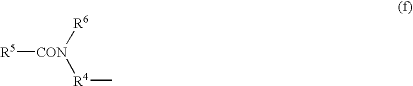

wherein R⁴ and R⁵ are as defined above, and R⁶ is hydrogen atom or any one of the groups defined for R⁵ and a group represented by formula (g) below

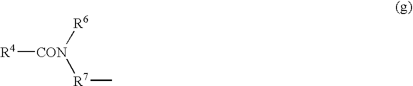

wherein R⁴ and R⁶ are as defined above, and R⁷ is hydrogen or any one of the groups defined for R⁵ and substituted aliphatic or aromatic residues of formula (h) below

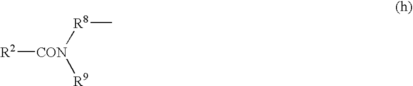

wherein R² is as defined above, R⁸ is any one of the groups defined for R⁴, and R⁹ is any one of the groups defined for R⁶.

When n is 2, R¹ is preferably a direct bond or any one of the unsubstituted or substituted aromatic hydrocarbon residues in the first to third groups. Those unsubstituted or substituted aromatic hydrocarbon residues in the first or third group in which the two bonds extend from positions farthest from each other, above all p-phenylene, p,p′-biphenylene, and 2,6-naphthylene, are especially preferred.

Representative compounds of Formula (I) where n is 2 are:

2,2′-bis(3,1-benzoxazin-4-one),

2,2′-ethylenebis(3,1-benzoxazin-4-one),

2,2′-tetramethylenebis(3,1-benzoxazin-4-one),

2,2′-hexamethylenebis(3,1-benzoxazin-4-one),

2,2′-decamethylenebis(3,1-benzoxazin-4-one),

2,2′-p-phenylenebis(3,1-benzoxazin-4-one),

2,2′-m-phenylenebis(3,1-benzoxazin-4-one),

2,2′-(4,4′-diphenylene)bis(3,1-benzoxazin-4-one),

2,2′-(2,6- or 1,5-naphthalene)bis(3,1-benzoxazin-4-one),

2,2′-(2-methyl-p-phenylene)bis(3,1-benzoxazin-4-one),

2,2′-(2-nitro-p-phenylene)bis(3,1-benzoxazin-4-one),

2,2′-(2-chloro-p-phenylene)bis(3,1-benzoxazin-4-one),

2,2′-(1,4-cyclohexylene)bis(3,1-benzoxazin-4-one),

N-p-(3,1-benzoxazin-4-on-2-yl)phenyl, 4-(3,1-benzoxazin-4-on-2-yl)phthalimide, and

N-p-(3,1-benzoxazin-4-on-2-yl)benzoyl, 4-(3,1-benzoxazin-4-on-2-yl)aniline.

Especially preferred compounds are represented by the formula:

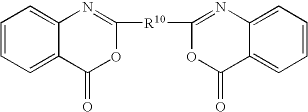

wherein R¹⁰ represents a divalent aromatic hydrocarbon residue. Particularly preferred compounds of formula (I) include 2,2′-p-[phenylene-bis(3,1-benzoxazin-4-one), 2,2′-(4,4′-diphenylene)-bis(3,1-benzoxazin-4-one), and 2,2′-(2,6-naphthalene)bis(3,1-benzoxazin-4-one) are especially preferred. The compound, 2,2′-P-(phenylene)-bis(3,1-benzoxazin-4-one), is even more preferred.

Within the scope of this invention are commercially available UVAs such as, for example: Cyasorb UV-2337 (Cytec Industries, CAS#25973-55-1), Cyasorb UV-5411 (Cytec Industries, CAS#3147-75-9), Cyasorb UV-5365 (Cytec Industries, CAS#2440-22-4), Cyasorb UV-1164 (Cytec Industries, CAS#2725-22-6), Cyasorb UV-3638 (Cytec Industries, CAS#18600-59-4), Tinuvin 213 (Ciba Specialty Chemicals, CAS#104810-47-1), Tinuvin 234 (Ciba Specialty Chemicals, CAS#70321-86-7), Tinuvin 320 (Ciba Specialty Chemicals, CAS#3846-71-7), Tinuvin 326 (Ciba Specialty Chemicals, CAS#3896-11-5), Tinuvin 327 (Ciba Specialty Chemicals, CAS#3864-99-1), Tinuvin 328 (Ciba Specialty Chemicals, CAS#25973-55-1), Tinuvin 329 (Ciba Specialty Chemicals, CAS#3147-75-9), Tinuvin 350 (Ciba Specialty Chemicals, CAS#36437-37-3), Tinuvin 360 (Ciba Specialty Chemicals, CAS#103597-45-1), Tinuvin 571 (Ciba Specialty Chemicals, CAS#23328-53-2) and Tinuvin 1577 (Ciba Specialty Chemicals, CAS#147315-50-2). In one embodiment, the UVAs are chosen from benzotriazoles, triazines and benzoxazin-4-ones such as Cyasorb UV-1164 (Cytec Industries, CAS#2725-22-6), Cyasorb UV-3638 (Cytec Industries, CAS#18600-59-4), Tinuvin 1577 (Ciba Specialty Chemicals, CAS#147315-50-2), Tinuvin 234 (Ciba Specialty Chemicals, CAS#70321-86-7) and Tinuvin 328 (Ciba Specialty Chemicals, CAS#25973-55-1). In another embodiment, the UVAs are chosen from Cyasorb UV-1164 (Cytec Industries, CAS#2725-22-6), Cyasorb UV-3638 (Cytec Industries, CAS#18600-59-4) and Tinuvin 1577 (Ciba Specialty Chemicals, CAS#147315-50-2. A combination of two or more of any of the UVAs may be used within the scope of this invention.

The benzotriazole compounds can be represented by the structure of formula II below:

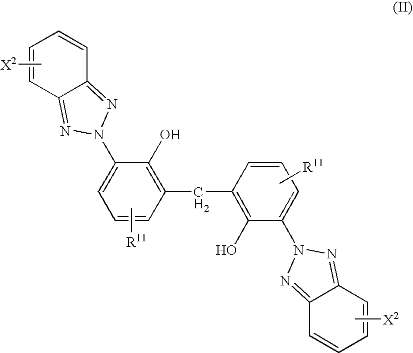

wherein X² is an alkyl or aryl substituent or a halogen atom such as chlorine and R¹¹ is independently selected from alkyl or aryl groups having 1 to 20 carbon atoms. The R¹¹ moiety may be located on the ring but is usually located para- to the hydroxyl grouping for greatest synthetic ease.

A representative structure from the class of triazine compounds is formula III below:

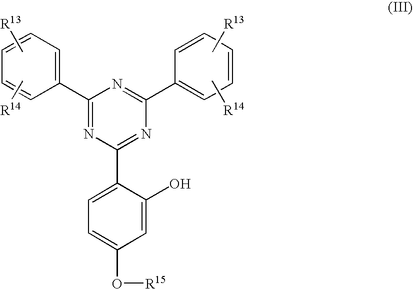

wherein R¹³, R¹⁴, and R¹⁵ are an alkyl or aryl group. Their position of substitution on the rings may be as desired but is generally ortho- and para- to the bond to the triazine ring for best synthetic ease. One or both of the two groups R¹³ or R¹⁴ may be hydrogen.

Tris-aryl-S-triazine UV absorbers have been found to provide low color and haze in the composition of the invention. Thus, in another embodiment of the invention, the aliphatic polyester composition also comprises at least one tris-aryl-S-triazine UV-absorber represented by formula (5):

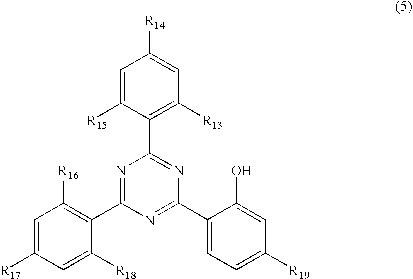

wherein
R₁₃, R₁₄, R₁₅, R₁₆, R₁₇, and R₁₈ are independently selected from hydrogen, C₁-C₂₂ alkyl, substituted C₁-C₂₂ alkyl, C₃-C₈ cycloalkyl, and substituted C₃-C₈ cycloalkyl; and
R₁₉ is selected from hydrogen, C₁-C₂₂ alkyl, substituted C₁-C₂₂ alkyl, C₃-C₈ cycloalkyl, substituted C₃-C₈ cycloalkyl and —OR₂₀,
wherein
   R₂₀ is selected from hydrogen, C₁-C₂₂ alkyl, substituted C₁-C₂₂ alkyl, C₃-C₈ cycloalkyl, substituted C₃-C₈ cycloalkyl, aryl, and heteroaryl.

Further examples of UVAs are compounds represented by formula (5) above in which R₁₃, R₁₄, R₁₅, R₁₆, R₁₇, and R₁₈ are hydrogen and R₁₉ is —OC₆H₁₃; and in which R₁₅ and R₁₆ are hydrogen; R₁₃, R₁₄, R₁₇, and R₁₈ are methyl; and R₁₉ is —OC₈H₁₇. These UVAs are known to persons skilled in the art and some are commercially available such as, for example, under the trade designations CYASORB™ UV-1164 (Cytec Industries, CAS#2725-22-6, formula (5) wherein R₁₅ and R₁₆, are hydrogen; R₁₃, R₁₄, R₁₇, and R₁₈ are methyl and R₁₉ is —OC₈H₁₇) and TINUVIN™ 1577 (Ciba Specialty Chemicals, CAS#147315-50-2, formula (5) wherein R₁₃, R₁₄, R₁₅, R₁₆, R₁₇, and R₁₈ are hydrogen and R₁₉ is —OC₆H₁₃).

The compositions of the present invention can contain one or more compounds chosen from phenolic antioxidants, hindered phenols, phosphite stabilizers, phosphonite stabilizers and other stabilizers known to one skilled in the art.

The terms “phenolic antioxidants” and “hindered phenol” are primary antioxidants that are known to those skilled in the art and may be represented by the structures listed on pages 98-108 in the Plastic Additives Handbook 5^{th} Edition (Hanser Gardner Publications, Inc., Cincinnati, Ohio, USA, 2001), incorporated herein by reference in its entirety. Some common phenolic antioxidants are as follows: Irganox 1010 (Ciba Specialty Chemicals, CAS#6683-19-8), Irganox 1330 (Ciba Specialty Chemicals, CAS#1709-70-2) and Irganox 3114 (Ciba Specialty Chemicals, CAS#27676-62-6).

The terms “phosphite stabilizers” and “phosphonite stabilizers” refer to secondary antioxidants that are known to those skilled in the art and may be represented by the structures listed on pages 109-112 in the Plastic Additives Handbook 5^{th} Edition (Hanser Gardner Publications, Inc., Cincinnati, Ohio, USA, 2001), incorporated herein by reference in its entirety. Some common phosphite stabilizers are as follows: Ultranox 626 (GE Specialty Chemicals, CAS#26741-53-7), Irgafos 168 (Ciba Specialty Chemicals, CAS#31570-04-4), Weston 619 (GE Specialty Chemicals, CAS#3806-34-6) and Doverphos S-9228 (Dover Chemicals, CAS#154862-43-8).

For example, in one embodiment of the invention, alkyl phosphites (for example Weston 619) may be combined with an ultraviolet light absorber. For example, in one embodiment of the invention, aryl phosphites (for example, Irgafos 168) can be combined with a hindered amine light stabilizer and optionally, an ultraviolet light absorber. For example, in one embodiment, phenolic antioxidants (for example, Irganox 1010) can be added during melt processing. Phenolic antioxidants are particularly useful when a polyglycol ether [for example, poly(tetramethylene glycol)] is present.

The amount of UV absorbing compound in the blend can be from about 0.1 weight % to about 10 weight %, preferably from about 0.5 weight % to about 5 weight % and more preferably from about 0.5 weight % to about 4 weight %, wherein the weight % are based on the total weight of the blend.

The UV absorbing compound may be incorporated into the copolyester and at the desired concentrations by suitable blending and/or mixing technology such as by preparation of a concentrate of the UV absorbing compound in a base copolymer followed by pellet blending of the concentrate with further copolyester pellets containing no UV absorber, such that the final extruded product will be the copolyester with the desired overall level of UV absorber. The UV absorbing compound may be placed as the layer onto the plastic sheeting or film to be stabilized with the protective stabilized layer facing the light exposure shielding the sheeting from the effects of UV exposure. It is obvious that the protective layer can be on both sides of the sheet or film either for purposes of attenuating the effect of reflected radiation in a particular application environment or to render installation of the product foolproof. Suitable means for application of this protective layer include, but are not limited to, coextrusion, extrusion coating, extrusion lamination, calendaring, hot press lamination, solvent coating, and the like.

The copolyesters blends of the present invention are suitable for use in both the protective layer (cap layer) and the substrate layer of film or sheeting to which the protective layer is applied. In one embodiment, the substrate layer can be composed of a polymer composition different than the protective layer. The structure of a coextruded product can be a film, a solid sheet or can be a profiled article. Many other configurations of such structures are possible, such as, having two or more layers of the sheeting connected by ribbing. The essential element of such structures is that they provide a great deal of rigidity of the final structure compared to the weight of the polymer employed therein. In these cases, the UV absorber containing layer is placed on either one side or both flat sides just the same as if it were a solid sheet.

The protective layer of film or sheeting need not be of the same copolyester composition as the substrate which does not contain the UV absorbing compound. The thickness of the protective layer on the underlying film or sheeting can vary according to the desired technological ends of the coating. As a general rule, the thickness of the protective layer is chosen depending upon the UV absorber concentration in order to screen at least 99% of the incoming UV light in solar radiation and render the structure weathering resistant. The thickness can be further reduced by higher concentration of the UV absorber in the protective layer.

This invention further relates to a thermoplastic article comprising:
a first layer comprising a polymeric material; and
a second layer (which can be a protective layer) comprising at least one of the polyesters of the invention;
optionally, at least one antioxidant as described herein, and
optionally, at least one ultraviolet light absorbing compound.

This invention further relates to a thermoplastic article comprising:
a first layer comprising a polymeric material; and
a second layer (which can be a protective layer) comprising at least one of the polyesters of the invention; and
at least one antioxidant as described herein; and
optionally, at least one ultraviolet light absorbing compound.

This invention further relates to a thermoplastic article comprising:
a first layer comprising a polymeric material; and
a second layer (which can be a protective layer) comprising at least one of the polyesters of the invention; and
optionally, at least one antioxidant as described herein, and
at least one ultraviolet light absorbing compound.

This invention further relates to a thermoplastic article comprising:
a first layer (base layer) comprising a polymeric material; and
a second layer (which can be a protective layer) comprising at least one of the polyesters of the invention; and
at least one antioxidant as described herein, and
at least one ultraviolet light absorbing compound.

This invention further relates to a thermoplastic article comprising:
a first layer comprising a polymeric material; and
a second layer (which can be a protective layer) comprising at least one of the polyesters of the invention;
optionally, at least one hindered amine light stabilizer as described herein, and
optionally, at least one ultraviolet light absorbing compound.

This invention further relates to a thermoplastic article comprising:
a first layer comprising a polymeric material; and
a second layer (which can be a protective layer) comprising at least one of the polyesters of the invention; and
at least one hindered amine light stabilizer as described herein; and
optionally, at least one ultraviolet light absorbing compound.

This invention further relates to a thermoplastic article comprising:
a first layer comprising a polymeric material; and
a second layer (which can be a protective layer) comprising at least one of the polyesters of the invention; and
optionally, at least one hindered amine light stabilizer as described herein, and
at least one ultraviolet light absorbing compound.

This invention further relates to a thermoplastic article comprising:
a first layer (base layer) comprising a polymeric material; and
a second layer (which can be a protective layer) comprising at least one of the polyesters of the invention; and
at least one hindered amine light stabilizer as described herein, and
at least one ultraviolet light absorbing compound.

Some of the materials useful in the base layer of certain thermoplastic articles of the invention can include but are not limited to polyesters useful in the invention, polyethylene terephthlate (PET); polyethylene terephthlate modified with glycols other than ethylene glycol, for example, PETG; polybutylene terephthalate (PBT), polycarbonate (PC), polycarbonate blends (for example, PC/ABS, PC/PVC, PC/PBT, PC/PETG and PC/PET), ABS and ABS blends, and acrylics. “ABS” is the abbreviation for acrylonitrile butadiene styrene copolymers. “PVC” is the abbreviation for polyvinyl chloride polymers.

Other materials useful in the base layer of certain thermoplastic articles of the invention can include polyester compositions comprising terephthalic acid, 2,2,4,4-tetramethyl-1,3-cyclobutanediol and 1,4-cyclohexanedimethanol such as, for example, those described in United States Patent Application Publication No. 2006-0287493; Pub. dated Dec. 21, 2006 and United States Patent Application Publication No. 2006-0293495, dated Dec. 28, 2006, incorporated by reference in their entireties.

Reinforcing materials may be useful in the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

The invention further relates to the film(s) and/or sheet(s) comprising the polyester compositions and/or polymer blends of the invention. The methods of forming the polyesters and/or blends into film(s) and/or sheet(s) and/or multi-sheets are well known in the art. Examples of film(s) and/or sheet(s) of the invention including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting.

Examples of potential articles made from film and/or sheet useful in the invention include, but are not limited, to uniaxially stretched film, biaxially stretched film, thermoformed sheet; multi-layer sheets, graphic arts film; building and construction articles, (for example, outdoor signs, skylights); auto panels, optical media, coating(s), coated articles, painted articles, laminates, laminated articles, and/or multiwall films or sheets.

The present invention also relates to shaped articles wholly or partially produced from the polymer containing the ultraviolet light absorbing compound. Representative applications are for example; signs for businesses, both stationary mounted and also portable ones, luggage carriers for the tops of the vehicles, sign boards, marquees on stores, solar roof panels, skylights, highway sound barriers, greenhouse panels, both in the sidewalls and the roofing thereof, separation walls in aquariums, aquariums themselves, recreational vehicle windows and vents, snowmobile, jet ski, golf cart, motorcycle and other such recreation vehicle windshields, bug screens or air deflection screens on cars and trucks or other such vehicles, transparent or translucent awnings, formed letters to be applied to the sides of buildings, letters to be used on signs, particularly those where the letters are changed at some frequency to change what the sign says, airport runway and taxiway marker signs, multiwall sheeting for use in signs, greenhouses, glazing applications and fluorescent or other light covers, etc., facia for soft drink and juice dispensing machines, etc. In these applications the product can be used either as a clear plastic part or it could be colored via producer added colors to give a clear, colored sheet or it could be printed on the back surface, in particular for sign and marquee applications to give the desired effects of highlighting letters, for example. This list is not intended to be all inclusive but merely representative of the vast number of applications available for a material having suitable properties.

“Graphic art film,” as used herein, is a film having a thermally-curable ink (e.g., heat-curable ink or air-curable ink) or radiation-curable ink (e.g., ultra-violet-curable ink) printed thereon or therein. “Curable” refers to capable of undergoing polymerization and/or crosslinking. In addition to the ink, the graphic art film may optionally also include varnishes, coatings, laminates, and adhesives.

Exemplary thermally or air-cured inks involve pigment(s) dispersed in one or more standard carrier resins. The pigment can be 4B Toner (PR57), 2B Toner (PR48), Lake Red C (PR53), lithol red (PR49), iron oxide (PR101), Permanent Red R (PR4), Permanent Red 2G (PO5), pyrazolone orange (PO13), diaryl yellows (PY12, 13, 14), monoazo yellows (PY3,5,98), phthalocyanine green (PG7), phthalocyanine Blue, β form (PB15), ultramarine (PB62), permanent violet (PV23), titanium dioxide (PW6), carbon black (furnace/channel) (PB7), PMTA pink, green, blue, violet (PR81, PG1, PB1, PV3,), copper ferrocyanide dye complexes (PR169, PG45, PB62, PV27), or the like. (Parenthetical identifications in the foregoing refer to the generic color index prepared by the Society of Dyers and Colourists.) Such pigments and combinations thereof can be used to obtain various colors including, but not limited to, white, black, blue, violet, red, green, yellow, cyan, magenta, or orange.

Other exemplary inks, including radiation-cured inks are disclosed in U.S. Pat. No. 5,382,292, where the disclosure of such inks are incorporated herein by reference.

Examples of typical carrier resins used in standard inks include those which have nitrocellulose, amide, urethane, epoxide, acrylate, and/or ester functionalities. Standard carrier resins include one or more of nitrocellulose, polyamide, polyurethane, ethyl cellulose, cellulose acetate propionate, (meth)acrylates, poly(vinyl butyral), poly(vinyl acetate), poly(vinyl chloride), and the like. Such resins can be blended, with widely used blends including nitrocellulose/polyamide and nitrocellulose/polyurethane.

Ink resin(s) normally can be solvated or dispersed in one or more solvents. Typical solvents employed include, but are not limited to, water, alcohols (e.g., ethanol, 1-propanol, isopropanol, etc.), acetates (e.g., n-propyl acetate), aliphatic hydrocarbons, aromatic hydrocarbons (e.g., toluene), and ketones. Such solvents typically can be incorporated in amounts sufficient to provide inks having viscosities, as measured on a #2 Zahn cup as known in the art, of at least 15 seconds, such as at least 20 seconds, at least 25 seconds, or from 25 to 35 seconds.

In one embodiment, the polyester have sufficient T_{g} values to allow thermoformability, and to allow ease of printing.

In one embodiment, the graphic art film has at least one property chosen from thermoformability, toughness, clarity, chemical resistance, T_{g}, and flexibility.

Graphic art films can be used in a variety of applications, such as, for example, in-mold decorated articles, embossed articles, hard-coated articles. The graphic art film can be smooth or textured.

Exemplary graphic art films include, but are not limited to, nameplates; membrane switch overlays (e.g., for an appliance); point of purchase displays; flat or in-mold decorative panels on washing machines; flat touch panels on refrigerators (e.g., capacitive touch pad arrays); flat panel on ovens; decorative interior trim for automobiles (e.g., a polyester laminate); instrument clusters for automobiles; cell phone covers; heating and ventilation control displays; automotive console panels; automotive gear shift panels; control displays or warning signals for automotive instrument panels; facings, dials or displays on household appliances; facings, dials or displays on washing machines; facings, dials or displays on dishwashers; keypads for electronic devices; keypads for mobile phones, personal digital assistants (PDAs, or hand-held computers) or remote controls; displays for electronic devices; displays for hand-held electronic devices such as phones and PDAs; panels and housings for mobile or standard phones; logos on electronic devices; and logos for hand-held phones.

Multiwall film or sheet refers to sheet extruded as a profile consisting of multiple layers that are connected to each other by means of vertical ribs. Examples of multiwall film or sheet include but are not limited to outdoor shelters (for example, greenhouses and commercial canopies).

Examples of extruded articles comprising the polyester compositions useful in this invention include, but are not limited to, thermoformed sheet, film for graphic arts applications, outdoor signs, skylights, multiwall film, plastic film for plastic glass laminates, and liquid crystal display (LCD) films, including but not limited to, diffuser sheets, compensation films, and protective films for LCDs.

In one embodiment, the present invention comprises a thermoplastic article, typically in the form of sheet material, having a decorative material embedded therein which comprise any of the compositions described herein.

“Outdoor sign,” as used herein, refers to a surface formed from the polyester described herein, or containing symbols (e.g., numbers, letters, words, pictures, etc.), patterns, or designs coated with the polyester or polyester film described herein. In one embodiment, the outdoor sign comprises a polyester containing printed symbols, patterns, or designs. In one embodiment, the sign is capable of withstanding typical weather conditions, such as rain, snow, ice, sleet, high humidity, heat, wind, sunlight, or combinations thereof, for a sufficient period of time, e.g., ranging from one day to several years or more.

Exemplary outdoor signs include, but are not limited to, billboards, neon signs, electroluminescent signs, electric signs, fluorescent signs, and light emitting diode (LED) displays. Other exemplary signs include, but are not limited to, painted signs, vinyl decorated signs, thermoformed signs, and hardcoated signs.

In one embodiment, the outdoor sign has at least one property chosen from thermoformability, toughness, clarity, chemical resistance, and T_{g}.

A “vending machine display panel,” as used herein, refers to a front or side panel on a vending machine that allows a customer to view the items for sale, or advertisement regarding such items. In one embodiment, the vending machine display panel can be a visually clear panel of a vending machine through which a consumer can view the items on sale. In other embodiments, the vending machine display panel can have sufficient rigidity to contain the contents within the machine and/or to discourage vandalism and/or theft.

In one embodiment, the vending machine display panel can have dimensions well known in the art, such as planar display panels in snack, beverage, popcorn, or sticker/ticket vending machines, and capsule display panels as in, e.g., gumball machines or bulk candy machines.

In one embodiment, the vending machine display panel can optionally contain advertising media or product identification indicia. Such information can be applied by methods well known in the art, e.g., silk screening.

In one embodiment, the vending machine display panel can be resistant to temperatures ranging from −100 to 120° C. In another embodiment, the vending machine display panel can be UV resistant by the addition of, e.g., at least one UV additive, as disclosed herein.

In one embodiment, the vending machine display panel has at least one property chosen from thermoformability, toughness, clarity, chemical resistance, and T_{g}.

“Point of purchase display,” as used herein, refers to a wholly or partially enclosed casing having at least one visually clear panel for displaying an item. Point of purchase displays are often used in retail stores to for the purpose of catching the eye of the customer. Exemplary point of purchase displays include enclosed wall mounts, countertops, enclosed poster stands, display cases (e.g., trophy display cases), sign frames, and cases for computer disks such as CDs and DVDs. The point of purchase display can include shelves, and additional containers, such as holders for magazines or pamphlets. One of ordinary skill in the art can readily envision the shape and dimensions for the point of purchase display depending on the item to be displayed. For example, the display can be as small as a case for jewelry, or a larger enclosed cabinet for displaying multiple trophies.

In one embodiment, the point of purchase display has at least one property chosen from toughness, clarity, chemical resistance, T_{g}, and hydrolytic stability.

“Appliance parts,” as used herein, refers to a rigid piece used in conjunction with an appliance. In one embodiment, the appliance part is partly or wholly separable from the appliance. In another embodiment, the appliance part is one that is typically made from a polymer. In one embodiment, the appliance part is visually clear.

Exemplary appliance parts include those requiring toughness and durabilty, such as cups and bowls used with food processers, mixers, blenders, and choppers; parts that can withstand refrigerator and freezer temperatures (e.g., refrigerator temperatures ranging from greater than 0° C. (e.g., 2° C.) to 5° C., or freezer temperatures, e.g., at temperatures less than 0° C., such as temperatures ranging from −20 to 0° C., e.g., −18° C.), such as refrigerator and freezer trays, bins, and shelves; parts having sufficient hydrolytic stability at temperatures up to 90° C., such as washing machine doors, steam cleaner canisters, tea kettles, and coffee pots; and vacuum cleaner canisters and dirt cups.

In one embodiment, these appliance parts have at least one property chosen from toughness, clarity, chemical resistance, T_{g}, hydrolytic stability, and dishwasher stability. The appliance part can also be chosen from steam cleaner canisters, which, in one embodiment, can have at least one property chosen from toughness, clarity, chemical resistance, T_{g}, and hydrolytic stability.

In one embodiment, the polyesters useful in the appliance part has a T_{g} of 105 to 140° C. and the appliance part is chosen from vacuum cleaner canisters and dirt cups. In another embodiment, the polyesters useful in the appliance part has a T_{g} of 120 to 150° C. and the appliance part is chosen from steam cleaner canisters, tea kettles and coffee pots.

“Skylight,” as used herein, refers to a light permeable panel secured to a roof surface such that the panel forms a portion of the ceiling. In one embodiment, the panel is rigid, e.g., has dimensions sufficient to achieve stability and durability, and such dimensions can readiliy be determined by one skilled in the art. In one embodiment, the skylight panel has a thickness greater than 3/16 inches, such as a thickness of at least ½ inches.

In one embodiment, the skylight panel is visually clear. In one embodiment, the skylight panel can transmit at least 35% visible light, at least 50%, at least 75%, at least 80%, at least 90%, or even at least 95% visible light. In another embodiment, the skylight panel comprises at least one UV additive that allows the skylight panel to block up to 80%, 90%, or up to 95% UV light.

In one embodiment, the skylight has at least one property chosen from thermoformability, toughness, clarity, chemical resistance, and T_{g}.

“Outdoor shelters,” as used herein, refer to a roofed and/or walled structure capable of affording at least some protection from the elements, e.g., sunlight, rain, snow, wind, cold, etc., having at least one rigid panel. In one embodiment, the outdoor shelter has at least a roof and/or one or more walls. In one embodiment, the outdoor shelter has dimensions sufficient to achieve stability and durability, and such dimensions can readiliy be determined by one skilled in the art. In one embodiment, the outdoor shelter panel has a thickness greater than 3/16 inches.

In one embodiment, the outdoor shelter panel is visually clear. In one embodiment, the outdoor shelter panel can transmit at least 35% visible light, at least 50%, at least 75%, at least 80%, at least 90%, or even at least 95% visible light. In another embodiment, the outdoor shelter panel comprises at least one UV additive that allows the outdoor shelter to block up to 80%, 90%, or up to 95% UV light.

Exemplary outdoor shelters include security glazings, transportation shelters (e.g., bus shelters), telephone kiosks, and smoking shelters. In one embodiment, where the shelter is a transportation shelter, telephone kiosk, or smoking shelter, the shelter has at least one property chosen from thermoformability, toughness, clarity, chemical resistance, and T_{g}. In one embodiment, where the shelter is a security glazing, the shelter has at least one property chosen from toughness, clarity, chemical resistance, and T_{g}.

A “canopy,” as used herein, refers to a roofed structure capable of affording at least some protection from the elements, e.g., sunlight, rain, snow, wind, cold, etc. In one embodiment, the roofed structure comprises, either in whole or in part, at least one rigid panel, e.g., has dimensions sufficient to achieve stability and durability, and such dimensions can readiliy be determined by one skilled in the art. In one embodiment, the canopy panel has a thickness greater than 3/16 inches, such as a thickness of at least ½ inches.

In one embodiment, the canopy panel is visually clear. In one embodiment, the canopy panel can transmit at least 35% visible light, at least 50%, at least 75%, at least 80%, at least 90%, or even at least 95% visible light. In another embodiment, the canopy panel comprises at least one UV additive that allows the canopy to block up to 80%, 90%, or up to 95% UV light.

Exemplary canopies include covered walkways, roof lights, sun rooms, airplane canopies, and awnings. In one embodiment, the canopy has at least one property chosen from toughness, clarity, chemical resistance, T_{g}, and flexibility.

A “sound barrier,” as used herein, refers to a rigid structure capable of reducing the amount of sound transmission from one point on a side of the structure to another point on the other side when compared to sound transmission between two points of the same distance without the sound barrier. The effectiveness in reducing sound transmission can be assessed by methods known in the art. In one embodiment, the amount of sound transmission that is reduced ranges from 25% to 90%.

In another embodiment, the sound barrier can be rated as a sound transmission class value, as described in, for example, ASTM E90, “Standard Test Method for Laboratory Measurement of Airborne Sound Transmission Loss of Building Partitions and Elements,” and ASTM E413, “Classification of Rating Sound Insulation.” An STC 55 barrier can reduce the sound of a jet engine, ˜130 dBA, to 60 dBA, which is the sound level within a typical office. A sound proof room can have a sound level ranging from 0-20 dBA. One of ordinary skill in the art can construct and arrange the sound barrier to achieve a desired STC rating. In one embodiment, the sound barrier has an STC rating of at least 20, such as a rating ranging from 20 to 60.

In one embodiment, the sound barrier comprises a plurality of panels connected and arranged to achieve the desired barrier outline. The sound barriers can be used along streets and highways to dampen automotive noises. Alternatively, the sound barriers can be used in the home or office, either as a discrete panel or panels, or inserted within the architecture of the walls, floors, ceilings, doors, and/or windows.

In one embodiment, the sound barrier is visually clear. In one embodiment, the sound barrier can transmit at least 35% visible light, at least 50%, at least 75%, at least 80%, at least 90%, or even at least 95% visible light. In another embodiment, the sound barrier comprises at least one UV additive that allows the sound barrier to block up to 80%, 90%, or up to 95% UV light.

In one embodiment, the sound barrier has at least one property chosen from toughness, clarity, chemical resistance, and T_{g}.

A “greenhouse,” as used herein, refers to an enclosed structure used for the cultivation and/or protection of plants. In one embodiment, the greenhouse is capable of maintaining a humidity and/or gas (oxygen, carbon dioxide, nitrogen, etc.) content desirable for cultivating plants while being capable of affording at least some protection from the elements, e.g., sunlight, rain, snow, wind, cold, etc. In one embodiment, the roof of the greenhouse comprises, either in whole or in part, at least one rigid panel, e.g., has dimensions sufficient to achieve stability and durability, and such dimensions can readiliy be determined by one skilled in the art. In one embodiment, the greenhouse panel has a thickness greater than 3/16 inches, such as a thickness of at least ½ inches.

In one embodiment, the greenhouse panel is visually clear. In another embodiment, substantially all of the roof and walls of the greenhouse are visually clear. In one embodiment, the greenhouse panel can transmit at least 35% visible light, at least 50%, at least 75%, at least 80%, at least 90%, or even at least 95% visible light. In another embodiment, the greenhouse panel comprises at least one UV additive that allows the greenhouse panel to block up to 80%, 90%, or up to 95% UV light.

In one embodiment, the greenhouse panel has at least one property chosen from toughness, clarity, chemical resistance, and T_{g}.

An “optical medium,” as used herein, refers to an information storage medium in which information is recorded by irradiation with a laser beam, e.g., light in the visible wavelength region, such as, for example, light having a wavelength ranging from 600 to 700 nm. By the irradiation of the laser beam, the irradiated area of the recording layer can be locally heated to change its physical or chemical characteristics, and pits are formed in the irradiated area of the recording layer. Since the optical characteristics of the formed pits are different from those of the area having been not irradiated, the digital information can be optically recorded. The recorded information can be read by reproducing procedure generally comprising the steps of irradiating the recording layer with the laser beam having the same wavelength as that employed in the recording procedure, and detecting the light-reflection difference between the pits and their periphery.

In one embodiment, the optical medium comprises a transparent disc having a spiral pregroove, a recording dye layer placed in the pregroove on which information is recorded by irradiation with a laser beam, and a light-reflecting layer. The optical medium is optionally recordable by the consumer. In one embodiment, the optical medium is chosen from compact discs (CDs) and digital video discs (DVDs). The optical medium can be sold with prerecorded information, or as a recordable disc.

In one embodiment, at least one of the following comprises the polyester of the invention: the substrate, at least one protective layer of the optical medium, and the recording layer of the optical medium.

In one embodiment, the optical medium has at least one property chosen from toughness, clarity, chemical resistance, T_{g}, and hydrolytic stability.

A “glass laminate,” as used herein, refers to at least one coating on a glass, where at least one of the coatings comprises the polyester. The coating can be a film or a sheet. The glass can be clear, tinted, or reflective. In one embodiment, the laminate is permanently bonded to the glass, e.g., applying the laminate under heating and pressure to form a single, solid laminated glass product. One or both faces of the glass can be laminated. In certain embodiments, the glass laminate contains more than one coating comprising the polyester compositions of the present invention. In other embodiments, the glass laminate comprises multiple glass substrates, and more than one coating comprising the polyester compositions of the present invention.

Exemplary glass laminates include windows (e.g., windows for high rise buildings, building entrances), safety glass, windshields for transportation applications (e.g., automotive, buses, jets, armored vehicles), bullet proof or resistant glass, security glass (e.g., for banks), hurricane proof or resistant glass, airplane canopies, mirrors, solar glass panels, flat panel displays, and blast resistant windows. The glass laminate can be visually clear, be frosted, etched, or patterned.

In one embodiment the glass laminate can be resistant to temperatures ranging from −100 to 120° C. In another embodiment, the glass laminate can be UV resistant by the addition of, e.g., at least one UV additive, as disclosed herein.

Methods for laminating the films and/or sheets of the present invention to the glass are well known to one of ordinary skill in the art. Lamination without the use of an adhesive layer may be performed by vacuum lamination. To obtain an effective bond between the glass layer and the laminate, in one embodiment, the glass has a low surface roughness.

Alternatively, a double-sided adhesive tape, an adhesive layer, or a gelatin layer, obtained by applying, for example, a hotmelt, a pressure- or thermo-sensitive adhesive, or a UV or electron-beam curable adhesive, can be used to bond the laminate of the present invention to the glass. The adhesive layer may be applied to the glass sheet, to the laminate, or to both, and may be protected by a stripping layer, which can be removed just before lamination.

In one embodiment, the glass laminate has at least one property chosen from toughness, clarity, chemical resistance, hydrolytic stability, and T_{g}.

For the purposes of this invention, the term “wt” means “weight”.

The following examples further illustrate how the polyesters of the invention can be made and evaluated, and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following examples illustrate in general how a polyester is prepared and the effect of compositions and processes of the present invention on various polyester properties such as toughness, glass transition temperature, inherent viscosity, etc. Additionally some comparative examples are also presented.

### Measurement Methods

The inherent viscosity of the polyesters was determined in 60/40 (wt/wt) phenol/tetrachloroethane at a concentration of 0.25 g/50 ml at 25° C.

Unless stated otherwise, the glass transition temperature (Tg) was determined using a TA DSC 2920 instrument from Thermal Analyst Instruments at a scan rate of 20° C./min according to ASTM D3418.

The glycol content and the cis/trans ratios of monomer residues of the compositions were determined by proton nuclear magnetic resonance (NMR) spectroscopy. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40(wt/wt) phenol/tetrachloroethane with deuterated chloroform added for lock. Peak assignments for 2,2,4,4-tetramethyl-1,3-cyclobutanediol resonances were made by comparison to model mono- and di-1,4-cyclohexanedicarboxylate esters of 2,2,4,4-tetramethyl-1,3-cyclobutanediol. These model compounds closely approximate the resonance positions found in the polymers and oligomers.

The polymers were dried at a temperature ranging from 80 to 100° C. in a vacuum oven for 24 hours and injection molded on a Boy 22S molding machine to give ⅛×½×5-inch and ¼×½×5-inch flexure bars. These bars were cut to a length of 2.5 inch and notched down the ½ inch width with a 10-mil notch in accordance with ASTM D256. The average Izod impact strength at 23° C. was determined from measurements on 5 specimens.

In addition, 5 specimens were tested at various temperatures using 5° C. increments in order to determine the brittle-to-ductile transition temperature. The brittle-to-ductile transition temperature is defined as the temperature at which 50% of the specimens fail in a brittle manner as denoted by ASTM D256.

Color values reported herein were determined using a Hunter Lab Ultrascan Spectra Colorimeter manufactured by Hunter Associates Lab Inc., Reston, Va. The color determinations were averages of values measured on either pellets of the polyesters or plaques or other items injection molded or extruded from them. They were determined by the L*a*b* color system of the CIE (International Commission on Illumination) (translated), wherein L* represents the lightness coordinate, a* represents the red/green coordinate, and b* represents the yellow/blue coordinate.

Unless otherwise specified, the cis/trans ratio of the 1,4-cyclohexanedimethanol used in the following examples was approximately 30/70, and could range from 35/65 to 25/75. Unless otherwise specified, the cis/trans ratio of the 2,2,4,4-tetramethyl-1,3-cyclobutanediol used in the following examples was approximately 50/50 and could range from 40/60 to 60/40.

The following abbreviations apply throughout the working examples and figures:

| | |
|---|---|
| CHDA | 1,4-Cyclohexanedicarboxylic acid |
| DMCD | Dimethyl 1,4-cyclohexanedicarboxylate |
| TMCD | 2,2,4,4-Tetramethyl-1,3-cyclobutanediol |
| CHDM | 1,4-Cyclohexanedimethanol |
| EG | Ethylene glycol |
| TPA | Terephthalic acid |
| IV | Inherent viscosity |
| Tg | glass transition temperature |
| T_{bd} | brittle-to-ductile transition temperature |

### Example 1

This example illustrates the laboratory-scale preparation of a copolyester of CHDA with TMCD and CHDM where the mol % TMCD in the final polymer was about 68% and the mol % of CHDM in the final polymer was about 32%.

DMCD (about 98 mole % trans, 80.0 g, 0.40 mol), TMCD (46.4 g, 0.31 mol), CHDM (17.3 g, 0.12 mol) and butyltin tris(2-ethylhexanoate) (1.84 mL of an approximately 0.22 M solution in butanol) were charged to a 500 mL single-neck round flask. The flask was fitted with a mechanical stirrer and distillation head and was purged with nitrogen. The flask was immersed in pre-heated Belmont metal bath (240° C.) and the reaction mixture was stirred for 183 min at atmospheric pressure during which time some of the methanol distilled off. The pressure was reduced to 100 torr while the bath temperature was raised to 255° C. over 5 min. The pressure was further reduced to 5 torr over another 5 min, and again reduced to 0.2 torr over another 5 min. The reaction mixture was stirred at about 0.2-0.5 torr and 255° C. for 300 min, after which time heating was discontinued and the vacuum was relieved to a nitrogen atmosphere. The IV of the resulting copolyester was 0.79 dL/g and the Tg was 110° C.

### Example 2

This example illustrates the pilot-scale batch preparation of a copolyester of CHDA with TMCD and CHDM where the mol % TMCD in the final polymer was about 68% and the mol % of CHDM in the final polymer was about 32%.

Under a nitrogen gas purge, DMCD (about 98 mole % trans, 21.43 lb), TMCD (12.42 lb), CHDM (4.63 lb) and butyltin tris(2-ethylhexanoate) (27.8 g) were charged to a 18-gallon stainless steel pressure vessel which was fitted with a condensing column, a vacuum system, and a HELICONE-type agitator. The contents of the reactor were heated under a nitrogen atmosphere. When the internal temperature reached 50° C., the agitator was set to 25 RPM and the reaction mixture temperature was increased to 150° C. at which time the vessel was pressurized to 25 psig with nitrogen. The reaction mixture was heated to 240° C. and held for 3 hours at 240° C. and 25 psig. The pressure was then decreased to 0 psig at a rate of 3 psig/min. The pressure was further reduced to 100 torr at a rate of 13 mm/min and held at 100 torr for 30 min. The pressure was again reduced to 20 torr and held for 30 min. The pressure was reduced to 3 torr and held for 30 min more. Full vacuum was applied (generally less than 3 torr) and the temperature of the reaction mixture was simultaneously increased to 255° C. After a 5 hour hold-time at 255° C. and full vacuum, the pressure of the pressure was relieved to 1 atmosphere using nitrogen gas. The molten polymer was then extruded from the pressure vessel into cold water. The resulting copolyester had an IV of 0.71 dL/g.

### Example 3

This example illustrates the pilot-scale batch preparation of a copolyester of CHDA with TMCD and CHDM where the mol % TMCD in the final polymer was about 28% and the mol % of CHDM in the final polymer was about 72%.

Under a nitrogen gas purge, DMCD (about 98 mole % trans, 21.43 lb), TMCD (5.32 lb), CHDM (10.8 lb) and butyltin tris(2-ethylhexanoate) (27.8 g) were charged to a 18-gallon stainless steel pressure vessel which was fitted with a condensing column, a vacuum system, and a HELICONE-type agitator. The contents of the reactor were heated under a nitrogen atmosphere. When the internal temperature reached 50° C., the agitator was set to 25 RPM and the reaction mixture temperature was increased to 150° C. at which time the vessel was pressurized to 25 psig with nitrogen. The reaction mixture was heated to 240° C. and held for 3 hours at 240° C. and 25 psig. The pressure was then decreased to 0 psig at a rate of 3 psig/min. The pressure was further reduced to full vacuum (generally less than 4 torr) at a rate of 13 mm/min and the temperature of the reaction mixture was simultaneously increased to 255° C. After a 5 hour hold-time at 255° C. and full vacuum, the pressure was relieved to 1 atmosphere using nitrogen gas. The molten polymer was then extruded from the pressure vessel into cold water. The resulting copolyester had an IV of 0.90 dL/g.

### Example 4

This example illustrates the laboratory-scale preparation of oligomers of CHDA with TMCD and CHDM at elevated pressure where the mol % TMCD in the final oligomer was about 70% and the mol % of CHDM in the final oligomer was about 30%.

DMCD (about 98 mole % trans, 801.10 g, 4.01 mol), TMCD (464.54 g, 3.22 mol) and CHDM (173.90 g, 1.21 mol) were charged as a warm slurry in methanol (80.59 g) to a 3-L pressure vessel that was fitted with a partial condenser. Butyltin tris(2-ethylhexanoate) (17.2 mL of an approximately 0.22 M solution in butanol) was added and the reactor was pressurized to 25 psig with nitrogen and heated to 240° C. with the column temperature was set to 180° C. and some of the methanol was distilled off. After reaching 240° C., the reaction mixture was stirred for 3 h, then the hot oligomers were discharged under a nitrogen atmosphere and cooled to room temperature. The oligomers were chilled with liquid nitrogen and pulverized for use in subsequent experimentation.

### Examples 5-8

These examples illustrate the effect of intermediate vacuum stages on the IV of laboratory prepared copolyesters of CHDA with TMCD and CHDM where the mol % TMCD in the final polymer was about 70% and the mol % of CHDM in the final polymer was about 30%.

Oligomers (100 g, produced in Example 4) were placed in the apparatus as described in Example 1 and were further reacted as shown in Table I.

TABLE I
Effect on final polymer IV of intermediate vacuum stages
(prepolymer stages) in addition to transesterification¹
stages and final vacuum² stages. There was a 5 min
ramp between each intermediate vacuum stage.

| Example | Time (min) @ | Time (min) @ | Time (min) @ | |
|---|---|---|---|---|
| Number | 100 torr | 20 torr | 5 torr | IV (dL/g) |
| Example 5 | 0 | 0 | 0 | 0.735 |
| Example 6 | 15 | 15 | 15 | 0.739 |
| Example 7 | 30 | 30 | 30 | 0.768 |
| Example 8 | 45 | 45 | 45 | 0.798 |

¹Transesterification was as described in Example 4.
²Final vacuum was 5 h @ 255° C. and ca. 0.5 torr, similar to that described in Example I.

### Examples 9 and 10

These examples illustrate the effect of intermediate vacuum stages (pre-polymer stages) on the IV of pilot-scale prepared copolyesters of CHDA with TMCD and CHDM where the mol % TMCD in the final polymer was about 68% and the mol % of CHDM in the final polymer was about 32%.

Under a nitrogen gas purge, DMCD (about 98 mole % trans, 21.43 lb), TMCD (12.42 lb), CHDM (4.63 lb) and an appropriate tin compound (to give about 400 ppm tin in the final polymer) were charged to a 18-gallon stainless steel pressure vessel which was fitted with a condensing column, a vacuum system, and a HELICONE-type agitator as described in Examples 2 and 3. The mixture was reacted as described in Table II.

TABLE II
Effect on final polymer IV of intermediate vacuum stages
(prepolymer stages) in addition to transesterification stages
and final vacuum stages in a pilot-scale process.

| Example | Time (min) | Time (min) | Time (min) | |
|---|---|---|---|---|
| Number | @ 100 torr | @ 20 torr | @ 3 torr | IV (dL/g) |
| Example 9¹ | 0 | 0 | 0 | 0.53 |
| Example 10² | 30 | 30 | 30 | 0.75 |

¹Process was as described in Example 3. The tin compound was butyltin tris(2-ethylhexanoate).
²Process was as described in Example 2. The tin compound was dibutyltin oxide.

### Examples 11-13

These examples illustrate the pilot-scale batch preparation of copolyesters of this invention of CHDA with TMCD and CHDM of various compositions.

Under a nitrogen gas purge, DMCD (about 98 mole % trans, 21.43 lb), TMCD and CHDM (as shown in Table III) and butyltin tris(2-ethylhexanoate) (27.8 g) were charged to a 18-gallon stainless steel pressure vessel which was fitted with a condensing column, a vacuum system, and a HELICONE-type agitator and reacted as described in Example 3. The results are given in Table III.

TABLE III
Copolyesters produced on pilot-scale.

| Example | TMCD | CHDM | TMCD | CHDM | |
|---|---|---|---|---|---|
| Number | charge (lb) | charge (lb) | mol %* | mol %* | IV (dL/g) |
| Example 11 | 10.64 | 6.17 | 59 | 41 | 0.749 |
| Example 12 | 8.88 | 7.72 | 49 | 51 | 0.810 |
| Example 13 | 7.10 | 9.26 | 38 | 62 | 0.846 |

*Mol % s are in final copolyester and are measured by NMR

### Examples 14-16

These examples illustrate the improved chemical resistance of selected copolyesters of this invention when exposed to lipids and isopropanol compared to aromatic polyesters with similar Tgs.

The laboratory prepared samples were ground to 3 mm size particles and dried overnight at 60° C. The dried polymer samples were pressed to a 20 mil thickness between two pieces of Kapton® polyimide at 275° C. The resulting films were cut into strips 1″×3″. The film strips were placed on a custom elliptical critical strain rig and held on using rubber bands. A cotton filter paper patch approximately 0.5″×3″ was placed on the strip. The patch was saturated with the chemical agent being examined and the exposure proceeded for 24 h. After the 24 h period, the cotton patch was removed and the extent of crazing and cracking was visually evaluated to determine the critical strain level and the severity of the craze/crack formation. The results are given in Table IV, showing that polymers with higher % critical stain values demonstrate superior performance to those with lower values.

TABLE IV
Stress cracking of copolyesters upon exposure to lipids and
isopropanol.

| | Mol % monomer residue in | | | | | | | |
|---|---|---|---|---|---|---|---|---|
| Example | copolyester | | | | | | Lipid % | ⁱPrOH % |
| Number | CHDA | TPA | TMCD | CHDM | EG | Tg (° C.) | strain | strain |
| Example 14 | 100 | 0 | 28 | 72 | 0 | 79 | 0.93 | 1.10 |
| Example 15 | 0 | 100 | 0 | 62 | 38 | 85 | 0.45 | 0.57 |
| Example 16 | 0 | 100 | 0 | 31 | 69 | 82 | 0.49 | 0.50 |

### Example 17

This example illustrates the ambient pressure laboratory-scale preparation of oligomers of CHDA with TMCD and CHDM where the mol % TMCD in the final oligomer was about 70% and the mol % of CHDM in the final oligomer was about 30%.

DMCD (about 98 mole % trans, 1201.44 g, 6.0 mol), TMCD (692.26 g, 4.8 mol) and CHDM (259.6 g, 1.8 mol) and dibutyltin oxide (1.41 g) were charged to 3 L kettle equipped with a mechanical stirrer and condenser. The contents were heated as described following under nitrogen with stirring for about 7 h, total, as the methanol distilled off. The temperature of the reaction mixture was ramped from ambient temperature to 210° C. over 1 h and held at 210° C. for another h; the temperature was then set to 215° C. After 75 min, the temperature was set to 220° C. After 10 min more, the temperature was set to 230° C. After 50 min more, the temperature was set to 240° C. After 45 min, the temperature was set to 255° C. After 30 min, the temperature was set to 260° C. After 30 min more, the temperature was set to 270° C. After 1 h more, the hot oligomers were discharged under a nitrogen atmosphere and cooled to room temperature. The oligomers were chilled with liquid nitrogen and pulverized for use in subsequent experimentation. The IV of the oligomers was 0.184 dL/g and the Tg was 53° C.

### Examples 18-33

These examples illustrate that the cis/trans ratio of the CHDA moiety in the final copolyester is influenced by process conditions. More specifically, the % trans-CHDA in the final polymer is reduced relative to the starting material.

Oligomers (100 g, produced in Example 17) were placed in the apparatus as described in Example 1 and were further reacted as shown in Table V.

TABLE V
Effect of process conditions on cis-trans ratio of CHDA (100% total
CHDA moiety in final polyester.

| | Extra¹ | | Poly- | | | | |
|---|---|---|---|---|---|---|---|
| | Transes- | | condensation² | | | | |
| | terification | | Conditions | | | | |
| | Conditions | | (full vacuum) | | mol % | | |
| Example | | temp | | temp | trans | Tg | IV |
| Number | time (h) | (° C.) | time (h) | (° C.) | CHDA | (° C.) | (dL/g) |
| Example | 0 | — | 2 | 270 | 78 | 103 | 0.496 |
| 18 | | | | | | | |
| Example | 0 | — | 3 | 270 | 78 | 93 | 0.470 |
| 19 | | | | | | | |
| Example | 0 | — | 3 | 250 | 80 | 99 | 0.500 |
| 20 | | | | | | | |
| Example | 0 | — | 2 | 250 | 80 | 99 | 0.481 |
| 21 | | | | | | | |
| Example | 2 | 220 | 3 | 260 | 78 | 105 | 0.626 |
| 22 | | | | | | | |
| Example | 2 | 220 | 2 | 260 | 78 | 100 | 0.594 |
| 23 | | | | | | | |
| Example | 3 | 220 | 3 | 260 | 77 | 99 | 0.617 |
| 24 | | | | | | | |
| Example | 3 | 220 | 4 | 260 | 75 | 91 | 0.589 |
| 25 | | | | | | | |

¹Extra transesterification conditions means in addition to the reaction profile, i.e. heat history that was described in Example 17; the extra ester exchange profile was also at ambient pressure and conducted similarly to that described in Example I.
²Full vacuum was ca. 0.5 torr, similar to that described in Example I.

Copolyesters of CHDA with varying amounts of TMCD and CHDM were prepared on the pilot-scale (approximately 50 mol scale) from about 98 mole % trans-DMCD in similar fashions as that described in Example 3. The results of several experiments are given in Table VI.

TABLE VI
Effect of process conditions on cis-trans ratio of CHDA (100% total
CHDA) moiety in final polyester of some pilot-scale reactions.

| | Transes- | | Poly- | | | | |
|---|---|---|---|---|---|---|---|
| | terification¹ | | condensation² | | | | |
| | Conditions | | Conditions | | mol % | | |
| Example | | temp | | temp | trans | mol % | mol % |
| Number | time (h) | (° C.) | time (h) | (° C.) | CHDA | CHDM | TMCD |
| Example | 10 | 220 | 6.1 | 245 | 86 | 33 | 67 |
| 26 | | | | | | | |
| Example | 3 | 240 | 2.75 | 255 | 85 | 31 | 69 |
| 27 | | | | | | | |
| Example | 3 | 240 | 5 | 255 | 85 | 72 | 28 |
| 28 | | | | | | | |
| Example | 3 | 240 | 5 | 255 | 85 | 51 | 49 |
| 29 | | | | | | | |
| Example | 3 | 240 | 5 | 255 | 84 | 62 | 38 |
| 30 | | | | | | | |
| Example | 3 | 240 | 5 | 255 | 84 | 61 | 39 |
| 31 | | | | | | | |
| Example | 3 | 240 | 5 | 255 | 85 | 59 | 41 |
| 32 | | | | | | | |
| Example | 3 | 240 | 5 | 255 | 84 | 32 | 68 |
| 33³ | | | | | | | |

¹The transesterification was conducted at 20–25 psig.
²The polycondensation was carried out at full vacuum as described in Examples 2 and 3.
³For this example, intermediate vacuum stages (pre-polymer stages) were included as described in Example 2.

### Examples 34-41

These examples further illustrate effects of process conditions, use of phosphorus compounds, and use of various metal compounds on selected polymer properties.

DMCD (about 98 mole % trans, 80.1 g, 0.40 mol), TMCD (46.5 g, 0.32 mol), CHDM (17.4 g, 0.12 mol), butyltin tris(2-ethylhexanoate) (enough of an approximately 0.2 M solution in butanol to provide the tin content noted in Table VII), optionally titanium tetraisopropoxide (enough of an approximately 0.2 M solution in butanol to provide the concentration noted in Table VII), and, optionally (condition A, noted in Table VII), triphenyl phosphate (enough of an approximately 0.32 M solution in butanol to provide the concentration noted in Table VII) were charged to a 500 mL single-neck round flask. The flask was fitted with a mechanical stirrer and distillation head and was purged with nitrogen. The flask was immersed in pre-heated Belmont metal bath (240° C.) and the reaction mixture was stirred for about 180 min at atmospheric pressure during which time some of the methanol distilled off; at this stage, optionally (condition B, noted in Table VII), triphenyl phosphate (enough of an approximately 0.32 M solution in butanol to provide the concentration noted in Table VII) was added. The pressure was reduced to 100 torr while the bath temperature was raised to the temperature shown in Table VII over 5 min. The pressure was further reduced to 5 torr over another 5 min, and again reduced to 0.2 torr over another 5 min. The reaction mixture was stirred at about 0.2-0.5 torr for the time and temperature give in Table VII, after which time heating was discontinued and the vacuum was relieved to a nitrogen atmosphere. Results of several experiments are given in Table VII.

TABLE VII
Color and IV of polymers produced at various conditions.

| | | | | | Vacuum | | | |
|---|---|---|---|---|---|---|---|---|
| Example | Sn | P | | Ti | stage | | | IV/ |
| Number | (ppm) | (ppm) | Condition | (ppm) | T (° C.) | t (min) | b* | (dL/g) |
| Example 34 | 460 | 46 | B | — | 255 | 300 | 1.14 | 0.581 |
| Example 35 | 460 | 49 | B | — | 255 | 300 | 0.90 | 0.583 |
| Example 36 | 453 | 57 | A | — | 270 | 300 | 1.29 | 0.506 |
| Example 37 | 453 | 57 | A | — | 270 | 300 | 0.81 | 0.439 |
| Example 38 | 453 | 57 | B | — | 270 | 240 | 2.59 | 0.610 |
| Example 39 | 226 | 57 | B | 20 | 255 | 280 | 1.83 | 0.592 |
| Example 40 | 453 | 30 | B | — | 255 | 280 | 0.79 | 0.602 |
| Example 41 | 453 | — | — | — | 255 | 300 | 6.61 | 0.626 |

Condition A is defined as addition of phosphorus compounds prior to ester exchange;
Condition B is defined as addition of phosphorus compounds after ester exchange

### Examples 42-51

These examples illustrate effects of process conditions and use of various metal compounds on polymer IV.

DMCD (about 98 mole % trans, 80.1 g, 0.40 mol), TMCD (46.5 g, 0.32 mol), CHDM (17.4 g, 0.12 mol), optionally, butyltin tris(2-ethylhexanoate) (enough of an approximately 0.2 M solution in butanol to provide the tin content noted in Table VIII), optionally titanium tetraisopropoxide (0.57 mL of approximately 0.2 M solution in butanol), optionally zinc diactetate (enough of an approximately 0.1 M solution in butanol to provide the concentration noted in Table VIII) were charged to a 500 mL single-neck round flask. The flask was fitted with a mechanical stirrer and distillation head and was purged with nitrogen. The flask was immersed in pre-heated Belmont metal bath (240° C.) and the reaction mixture was stirred for about 180 min at atmospheric pressure during which time some of the methanol distilled off. The pressure was reduced to 500 torr while the bath temperature was set to 255° C. The pressure was further reduced to 0.2 torr over 90 min. The reaction mixture was stirred at about 0.2-0.5 torr for about 300 min, after which time heating was discontinued and the vacuum was relieved to a nitrogen atmosphere. Results of several experiments are given in Table VIII.

TABLE VIII
Final polyester using prescribed conditions.

| Example | Sn | Zn | Ti | IV |
|---|---|---|---|---|
| Number | (ppm) | (ppm) | (ppm) | (dL/g) |
| Example 42 | 50 | — | 50 | 0.511 |
| Example 43 | 100 | — | 50 | 0.617 |
| Example 44 | 150 | — | 50 | 0.559 |
| Example 45 | 200 | — | 50 | 0.683 |
| Example 46 | 250 | — | 50 | 0.697 |
| Example 47 | 300 | — | 50 | 0.651 |
| Example 48 | — | 50 | 50 | low |
| Example 49 | — | 100 | 50 | low |
| Example 50 | — | 200 | 50 | 0.131 |
| Example 51 | — | 400 | 50 | 0.209 |

### Examples 53-55

The toughness of the copolyester compositions were evaluated. Pellets of each material were collected, dried for 4 hours in a desiccant air dryer at a temperature 20° C. lower than their respective glass transition temperature, and injection molded into 0.125 inch thick flex bars. These bars were then notched with a 10 mil notch at the depth specified in ASTM D256. Inherent viscosities were obtained on the injection molded bars. Bars were tested approximately one week after molding.

Notched Izod impact tests were conducted with the Ceast Resil 25 Impact Machine using a 15 J hammer. This equipment was modified so that the clamping fixture was contained in an environmental chamber that could control temperature. For a given material and test temperature, 5 specimens were tested. The test temperatures for each-material were different as the various compositions exhibited different brittle-to-ductile transition temperatures. The average, lowest, and highest value of the Izod impact energy were recorded at each temperature for each material. Results for several compositions are given below.

EXAMPLE 53
Material A: Copolyester comprised of 100 mole % DMCD
and 100% CHDM. (IV after molding: 0.940 dL/g)

| Temperature (° C.) | Average (J/m) | Low (J/m) | High (J/m) |
|---|---|---|---|
| −25 | 239 | 210 | 281 |
| −20 | 279 | 223 | 321 |
| −15 | 1118 | 280 | 2461 |
| −10 | 1921 | 305 | 2625 |
| −5 | 1963 | 280 | 2395 |
| 0 | 2033 | 1933 | 2278 |

The transition from brittle behavior to ductile behavior occurs around −15° C.

EXAMPLE 54
Material B: Copolyester comprised of 100 mole % DMCD, 70 mole %
CHDM, and 30 mole % TMCD (IV after molding: 0.833 dL/g)

| Temperature (° C.) | Average (J/m) | Low (J/m) | High (J/m) |
|---|---|---|---|
| −5 | 270 | 218 | 286 |
| 0 | 869 | 258 | 1806 |
| 5 | 1824 | 1782 | 1903 |
| 10 | 1968 | 1881 | 2062 |

The transition from brittle behavior to ductile behavior occurs around 5° C.

EXAMPLE 55
Material C: Copolyester comprised of 100 mole % DMCD, 50 mole %
CHDM, and 50 mole % TMCD (IV after molding: 0.786 dL/g)

| Temperature (° C.) | Average (J/m) | Low (J/m) | High (J/m) |
|---|---|---|---|
| −10 | 206 | 198 | 218 |
| −5 | 251 | 205 | 299 |
| 0 | 1204 | 230 | 1560 |
| 5 | 1497 | 1371 | 1657 |

The transition from brittle behavior to ductile behavior occurs around 0° C.

These materials had lower brittle to ductile transition temperatures than typical aromatic copolyesters commercially available, such as PETG, which have transition temperatures around 30° C.

The invention has been described in detail with reference to the embodiments disclosed herein, but it will be understood that variations and modifications can be effected within the spirit and scope of the invention.

What is claimed is:

1. A polyester composition comprising at least one polyester which comprises:
(A) a dicarboxylic acid component comprising:
i) 70 to 100 mole % of cyclohexanedicarboxylic acid residues or an ester thereof comprising:
(a) 70 to 98 mole % trans-cyclohexanedicarboxylic acid residues or an ester thereof; and
(b) 2 to 30 mole % cis-cyclohexanedicarboxylic acid residues or an ester thereof;
ii) 0 to 30 mole % of aliphatic dicarboxylic acid residues, other than cyclohexanedicarboxylic acid residues, having up to 16 carbon atoms or esters thereof, other than cyclohexanedicarboxylic acid residues,; and
iii) 0 to 10 mole % of aromatic dicarboxylic acid residues having up to 20 carbon atoms; and
(B) a glycol component comprising:
i) 1 to 99 mole % of 2,2,4,4-tetramethyl-1,3-cyclobutanediol residues; and
ii) 1 to 99 mole % of cyclohexanedimethanol residues;
wherein the total mole % of said dicarboxylic acid component is equal to 100 mole %;
the total mole % of said glycol component is equal to 100 mole %;
wherein the inherent viscosity of said polyester is from 0.35 to 1.2 dL/g as determined in 60/40 (wt/wt) phenol/tetrachloroethane at a concentration of 0.5 g/100 ml at 25° C.; and wherein said polyester has a Tg of from 60 to 155° C.

2. The polyester composition of claim 1, wherein the inherent viscosity of said polyester is from 0.5 to 1.2 dL/g.

3. The polyester composition of claim 1, wherein the inherent viscosity of said polyester is from 0.35 to 1.0 dL/g.

4. The polyester composition of claim 1, wherein the inherent viscosity of said polyester is from 0.35 to 0.75 dL/g.

5. The polyester composition of claim 1, wherein the inherent viscosity of said polyester is from 0.40 to 0.90 dL/g.

6. The polyester composition of claim 1, wherein the inherent viscosity of said polyester is from greater than 0.42 to 0.80 dL/g.

7. The polyester composition of claim 1, wherein the inherent viscosity of said polyester is from 0.5 to 0.8 dL/g.

8. The polyester composition of claim 1, wherein the inherent viscosity of said polyester is from 0.6 to 0.8 dL/g.

9. The polyester composition of claim 1, wherein the inherent viscosity of said polyester is from 0.60 to 0.72 dL/g.

10. The polyester composition of claim 1, wherein the inherent viscosity of said polyester is from 0.65 to 0.75 dL/g.

11. The polyester composition of claim 1, wherein the inherent viscosity of said polyester is from 0.68 to 0.85 dL/g.

12. The polyester composition of claim 1, wherein the inherent viscosity of said polyester is from greater than 0.70 up to 0.85 dL/g.

13. The polyester composition of claim 1, wherein the inherent viscosity of said polyester is from 0.72 to 0.85 dL/g.

14. The polyester composition of claim 1, wherein the inherent viscosity of said polyester is from 0.75 to 0.85 dL/g.

15. The polyester composition of claim 1, wherein the inherent viscosity of said polyester is from 0.74 to 0.8 dL/g.

16. The polyester composition of claim 1, wherein said polyester has a Tg of 66 to 120° C.

17. The polyester composition of claim 1, wherein said polyester has a Tg of 80 to 120° C.

18. The polyester composition of claim 1, wherein said polyester has a Tg of 90 to 110° C.

19. The polyester composition of claim 1, wherein the glycol component of said polyester comprises 1 to 80 mole % 2,2,4,4-tetramethyl-1,3-cyclobutanediol and 20 to 99 mole % 1,4-cyclohexanedimethanol.

20. The polyester composition of claim 1, wherein the glycol component of said polyester comprises 50 to 90 mole % 2,2,4,4-tetramethyl-1,3-cyclobutanediol and 10 mole % to 50 mole % 1,4-cyclohexanedimethanol.

21. The polyester composition of claim 1, wherein the glycol component of said polyester comprises 60 to 80 mole % 2,2,4,4-tetramethyl-1,3-cyclobutanediol and 20 to 40 mole % 1,4-cyclohexanedimethanol.

22. The polyester composition of claim 1, wherein the glycol component of said polyester comprises 65 to 75 mole % 2,2,4,4-tetramethyl-1,3-cyclobutanediol and 25 to 35 mole % 1,4-cyclohexanedimethanol.

23. The polyester composition of claim 1, wherein the glycol component of said polyester comprises 40 to 85 mole % 2,2,4,4-tetramethyl-1,3-cyclobutanediol and 15 to 60 mole % 1,4-cyclohexanedimethanol.

24. The polyester composition of claim 1, wherein the glycol component of said polyester comprises 40 to 80 mole % 2,2,4,4-tetramethyl-1,3-cyclobutanediol and 20 to 60 mole % 1,4-cyclohexanedimethanol.

25. The polyester composition of claim 1, wherein the glycol component of said polyester comprises 45 to 80 mole % 2,2,4,4-tetramethyl-1,3-cyclobutanediol and 20 to 55 mole % 1,4-cyclohexanedimethanol.

26. The polyester composition of claim 1, wherein the glycol component of said polyester comprises 50 to 80 mole % 2,2,4,4-tetramethyl-1,3-cyclobutanediol and 20 to 50 mole % 1,4-cyclohexanedimethanol.

27. The polyester composition of claim 1, wherein the dicarboxylic acid component comprises 0.01 to 10 mole % of aromatic dicarboxylic acid residues.

28. The polyester composition of claim 1, wherein the dicarboxylic acid component comprises 0.05 to 10 mole % of aromatic dicarboxylic acid residues.

29. The polyester composition of claim 1, wherein the dicarboxylic acid component comprises 0.1 to 10 mole % of aromatic dicarboxylic acid residues.

30. The polyester composition of claim 1, wherein the dicarboxylic acid component comprises 0.01 to 5 mole % of aromatic dicarboxylic acid residues.

31. The polyester composition of claim 1, wherein the dicarboxylic acid component comprises 0.1 to 5 mole % of aromatic dicarboxylic acid residues.

32. The polyester composition of claim 1, wherein the dicarboxylic acid component comprises 1 to 5 mole % of aromatic dicarboxylic acid residues.

33. The polyester composition of claim 1, wherein the dicarboxylic acid component comprises aromatic dicarboxylic acids chosen from terephthalic acid residues, isophthalic acid residues, naphthalenedicarboxylic acid residues, or esters thereof or mixtures thereof.

34. The polyester composition of claim 1, wherein the dicarboxylic acid component comprises aliphatic dicarboxylic acids chosen from at least one of malonic acid residues, succinic acid residues, glutaric acid residues, adipic acid residues, suberic acid residues, azelaic acid residues, sebacic acid residues or esters thereof or mixtures thereof.

35. The polyester composition of claim 1, wherein the dicarboxylic acid component comprises aliphatic dicarboxylic acids chosen from at least one of adipic acid residues, succinic acid residues, or esters thereof or mixtures thereof.

36. The polyester composition claim 1 wherein said polyester comprises ethylene glycol, 1,3-propanediol residues, 1,4-butanediol residues, or mixtures thereof.

37. The polyester composition claim 1 wherein said polyester comprises ethylene glycol.

38. The polyester composition of claim 1, wherein said cyclohexanedicarboxylic acid residues are a mixture comprising 80 to 98 mole % of trans-cyclohexanedicarboxylic acid and 2 to 20 mole % of cis-cyclohexanedicarboxylic acid.

39. The polyester composition of claim 1, wherein said cyclohexanedicarboxylic acid residues are a mixture comprising 90 to 98 mole % of trans-cyclohexanedicarboxylic acid and 2 to 10 mole % of cis-cyclohexanedicarboxylic acid.

40. The polyester composition of claim 1, wherein said cyclohexanedicarboxylic acid residues are a mixture comprising 92 to 98 mole % of trans-cyclohexanedicarboxylic acid and 2 to 8 mole % of cis-cyclohexanedicarboxylic acid.

41. The polyester composition of claim 1, wherein said cyclohexanedicarboxylic acid residues is a mixture comprising 95 to 98 mole % of trans-cyclohexanedicarboxylic acid and 2 to 5 mole % of cis-cyclohexanedicarboxylic acid.

42. The polyester composition of claim 1, wherein said cyclohexanedicarboxylic acid residues are a mixture comprising 78 to 87 mole % of trans-cyclohexanedicarboxylic acid and 13 to 22 mole % of cis-cyclohexanedicarboxylic acid.

43. The polyester composition of any of claims 38-42 wherein said cyclohexanedicarboxylic acid residues are derived from 1,4-cyclohexanedicarboxylic acid or esters thereof.

44. The polyester composition of claim 1, wherein said polyester composition comprises at least one polymer chosen from at least one of the following: nylons; polyesters other than those of claim 1; polyamides; polystyrene; polystyrene copolymers; styrene acrylonitrile copolymers; acrylonitrile butadiene styrene copolymers; poly(methylmethacrylate); acrylic copolymers; poly(ether-imides); polyphenylene oxides); or poly(phenylene oxide)/polystyrene blends; polyphenylene sulfides; polyphenylene sulfide/sulfones; poly(ester-carbonates); polycarbonates; polysulfones; polysulfone ethers; and poly(ether-ketones) of aromatic dihydroxy compounds; or mixtures thereof.

45. The polyester composition of claim 1, wherein said polyester composition comprises at least one polycarbonate.

46. The polyester composition of claim 1, wherein said polyester comprises residues of at least one branching agent for said polyester.

47. The polyester composition of claim 1, wherein said polyester comprises at least one branching agent residue in an amount of 0.01 to 5 weight % based on the total weight of the polyester.

48. The polyester composition of claim 1, wherein said polyester has a crystallization half-time of greater than 5 minutes at 170° C.

49. The polyester composition of claim 1, wherein said polyester composition has a density of 1.05 to 1.2 g/ml at 23° C.

50. The polyester composition of claim 1, wherein said polyester composition comprises at least one phosphorus compound.

51. The polyester composition of claim 1, wherein said polyester composition comprises at least one tin compound.

52. The polyester composition of claim 1, wherein said polyester compositions comprises at least one titanium compound and one tin compound.

53. The polyester composition of claim 1, wherein said polyester has a notched Izod impact strength of at least 5 ft-lbs/in at 23° C. according to ASTM D256 with a 10-mil notch in a ⅛-inch thick bar.

54. An article of manufacture comprising the polyester composition of claim 1, comprising a film or sheet.

55. An article of manufacture comprising the polyester composition of claim 1, comprising multi-sheets.

56. The polyester composition of claim 54 wherein said film or sheet is incorporated into at least one of the following: building and construction materials, auto panels, and optical media.

57. A polyester composition comprising at least one polyester which comprises:
(A) a dicarboxylic acid component comprising:
i) 70 to 100 mole % of cyclohexanedicarboxylic acid residues or an ester thereof comprising:
(a) 80 to 98 mole % trans-cyclohexanedicarboxylic acid residues or an ester thereof and
(b) 2 to 20 mole % cis-cyclohexanedicarboxylic acid residues or an ester thereof;
ii) 0 to 30 mole % of aliphatic dicarboxylic acid residues, other than cyclohexanedicarboxylic acid residues, having up to 16 carbon atoms or esters thereof, other than cyclohexanedicarboxylic acid residues, or esters thereof; and
iii) 0 to 10 mole % of aromatic dicarboxylic acid residues having up to 20 carbon atoms; and
(B) a glycol component comprising:
i) 50 to 90 mole % of 2,2,4,4-tetramethyl-1,3-cyclobutanediol residues; and
ii) 10 to 50 mole % of 1,4-cyclohexanedimethanol residues, 1,3-cyclohexanedimethanol residues, 1,2-cyclohexanedimethanol residues or esters thereof or mixtures thereof,
wherein the total mole % of said dicarboxylic acid component is equal to 100 mole %;
the total mole % of said glycol component is equal to 100 mole %;
wherein the inherent viscosity of said polyester is from 0.5 to 1.2 dL/g as determined in 60/40 (wt/wt) phenol/tetrachloroethane at a concentration of 0.5 g/100 ml at 25° C.; and wherein said polyester has a Tg of from 80 to 120° C.

58. A polyester composition comprising at least one polyester which comprises:
(A) a dicarboxylic acid component comprising:
i) 70 to 100 mole % of cyclohexanedicarboxylic acid residues or an ester thereof comprising:
(a) 80 to 98 mole % trans-cyclohexanedicarboxylic acid residues or an ester thereof and
(b) 2 to 20 mole % cis-cyclohexanedicarboxylic acid residues or an ester thereof;
ii) 0 to 30 mole % of aliphatic dicarboxylic acid residues, other than cyclohexanedicarboxylic acid residues, having up to 16 carbon atoms or esters thereof, other than cyclohexanedicarboxylic acid residues, or esters thereof; and
iii) 0 to 10 mole % of aromatic dicarboxylic acid residues having up to 20 carbon atoms; and
(B) a glycol component comprising:
i) 50 to 90 mole % of 2,2,4,4-tetramethyl-1,3-cyclobutanediol residues; and
ii) 10 to 50 mole % of 1,4-cyclohexanedimethanol residues, 1,3-cyclohexanedimethanol residues, 1,2-cyclohexanedimethanol residues or esters thereof or mixtures thereof,
wherein the total mole % of said dicarboxylic acid component is equal to 100 mole %;
the total mole % of said glycol component is equal to 100 mole %;
wherein the inherent viscosity of said polyester is from 0.5 to 1.2 dL/g as determined in 60/40 (wt/wt) phenol/tetrachloroethane at a concentration of 0.5 g/100 ml at 25° C.; and wherein said polyester has a Tg of from 90 to 110° C.

59. A polyester composition comprising at least one polyester which comprises:
(A) a dicarboxylic acid component comprising:
i) 70 to 100 mole % of cyclohexanedicarboxylic acid residues or an ester thereof comprising:
(a) 80 to 98 mole % trans-cyclohexanedicarboxylic acid residues or an ester thereof and
(b) 2 to 20 mole % cis-cyclohexanedicarboxylic acid residues or an ester thereof;
ii) 0 to 30 mole % of aliphatic dicarboxylic acid residues, other than cyclohexanedicarboxylic acid residues, having up to 16 carbon atoms or esters thereof, other than cyclohexanedicarboxylic acid residues, or esters thereof; and
iii) 0 to 10 mole % of aromatic dicarboxylic acid residues having up to 20 carbon atoms; and
(B) a glycol component comprising:
i) 65 to 75 mole % of 2,2,4,4-tetramethyl-1,3-cyclobutanediol residues; and
ii) 10 to 50 mole % of 1,4-cyclohexanedimethanol residues, 1,3-cyclohexanedimethanol residues, 1,2-cyclohexanedimethanol residues or esters thereof or mixtures thereof,
wherein the total mole % of said dicarboxylic acid component is equal to 100 mole %;
the total mole % of said glycol component is equal to 100 mole %;
wherein the inherent viscosity of said polyester is from 0.5 to 1.2 dL/g as determined in 60/40 (wt/wt) phenol/tetrachloroethane at a concentration of 0.5 g/100 ml at 25° C.; and wherein said polyester has a Tg of from 80 to 120° C.

60. A polyester composition comprising at least one polyester which comprises:
(A) a dicarboxylic acid component comprising:
i) 70 to 100 mole % of cyclohexanedicarboxylic acid residues or an ester thereof comprising:
(a) 80 to 98 mole % trans-cyclohexanedicarboxylic acid residues or an ester thereof and
(b) 2 to 20 mole % cis-cyclohexanedicarboxylic acid residues or an ester thereof;
ii) 0 to 30 mole % of aliphatic dicarboxylic acid residues, other than cyclohexanedicarboxylic acid residues, having up to 16 carbon atoms or esters thereof, other than cyclohexanedicarboxylic acid residues, or esters thereof; and
iii) 0 to 10 mole % of aromatic dicarboxylic acid residues having up to 20 carbon atoms; and
(B) a glycol component comprising:
i) 65 to 75 mole % of 2,2,4,4-tetramethyl-1,3-cyclobutanediol residues; and
ii) 25 to 35 mole % of 1,4-cyclohexanedimethanol residues, 1,3-cyclohexanedimethanol residues, 1,2-cyclohexanedimethanol residues or esters thereof or mixtures thereof,
wherein the total mole % of said dicarboxylic acid component is equal to 100 mole %;
the total mole % of said glycol component is equal to 100 mole %;
wherein the inherent viscosity of said polyester is from 0.7 to 1.0 dL/g as determined in 60/40 (wt/wt) phenol/tetrachloroethane at a concentration of 0.5 g/100 ml at 25° C.; and wherein said polyester has a Tg of from 80 to 120° C.

61. A thermoplastic article comprising:
a first layer comprising a polymeric material; and
a protective layer comprising at least one of the polyesters of any of claims 1, 57, 58 and 59;
optionally, at least one antioxidant as described herein, and
optionally, at least one ultraviolet light absorbing compound.

62. The thermoplastic article of claim 61 wherein said antioxidant is a phenolic antioxidant.

63. A thermoplastic article comprising:
a first layer comprising a polymeric material; and
a protective layer comprising at least one of the polyesters of any of claims 1, 57, 59 and 61;
optionally, at least one hindered amine light stabilizer as described herein, and
optionally, at least one ultraviolet light absorbing compound.
